(19) United States
(12) Patent Application Publication
(10) Pub. No.: US 2017/0168782 A1
(43) Pub. Date: Jun. 15, 2017

(54) SYSTEM AND METHOD FOR CREATING A UNIVERSALLY COMPATIBLE APPLICATION DEVELOPMENT SYSTEM

(71) Applicant: Ian Boyd, Marathon, FL (US)

(72) Inventor: Ian Boyd, Marathon, FL (US)

(21) Appl. No.: 14/574,218

(22) Filed: Dec. 17, 2014

Related U.S. Application Data
(63) Continuation-in-part of application No. 13/904,025, filed on May 29, 2013, now abandoned.
Application No. 13/904,025 is a continuation-in-part of application No. 14/150,601, filed on Jan. 8, 2014, now abandoned.
Application No. 14/150,601 is a continuation of application No. 13/829,196, filed on Mar. 14, 2013, now abandoned.
Application No. 13/829,196 is a continuation-in-part of application No. 13/829,838, filed on Mar. 14, 2013, now abandoned.
Application No. 13/829,838 is a continuation-in-part of application No. 13/830,210, filed on Mar. 14, 2013, now abandoned.
Application No. 13/830,210 is a continuation-in-part of application No. 13/830,513, filed on Mar. 14, 2013, now abandoned.
Application No. 13/830,513 is a continuation-in-part of application No. 13/902,957, filed on May 27, 2013, now abandoned.
(60) Provisional application No. 61/924,720, filed on Jan. 8, 2014.
(60) Provisional application No. 61/705,686, filed on Sep. 26, 2012.
(60) Provisional application No. 61/716,508, filed on Oct. 20, 2012.
(60) Provisional application No. 61/750,022, filed on Jan. 8, 2013.
(60) Provisional application No. 61/763,749, filed on Feb. 12, 2013.
(60) Provisional application No. 61/652,306, filed on May 28, 2012.

(51) Int. Cl. G06F 9/44

(52) U.S. Cl. CPC G06F 8/34

(57) ABSTRACT

A software application development system and method for producing, delivering and displaying scalable, adaptable, interchangeable software applications that provide universal consistency, operability and compatibility on any hardware and/or operating system of any digital device. The system and method providing through a distinctive Hierarchical Access Navigation and Menu System seamless integration of a plurality of software applications, external applications, web pages, and URL's without exiting a defined core application environment. The system uses Architectural Blueprints and Composite Hyper Displays to determine the composition and geometry of User Access (UA), the User Interface (UI), the User Experience (UX) and the User Content (UC).

This application claims the benefit of pending U.S. Provisional Patent Application No. 61/924,720 filed Jan. 8, 2014.

The application is further is a continuation-in-part of U.S. patent application Ser. No. 13/904,025 filed May 29, 2013 that claims the benefit of U.S. Provisional Application No. 61/705,686 filed Sep. 26, 2012, and to U.S. Provisional Application No. 61/716,508 filed Oct. 20, 2012, and to U.S. Provisional Application No. 61/750,022 filed Jan. 8, 2013, and to U.S. Provisional Application No. 61/763,749 filed Feb. 12, 2013.

The application is further a continuation-in-part of U.S. application Ser. No. 14/150,601 filed Jan. 8, 2014, which is a continuation of U.S. application Ser. No. 13/829,196 filed Mar. 14, 2013, now abandoned.

The application is further a continuation-in-part to U.S. application Ser. No. 13/829,838 filed Mar. 14, 2013; and, a continuation-in-part to U.S. application Ser. No. 13/830,210 filed Mar. 14, 2013; and, a continuation-in-part to U.S. application Ser. No. 13/830,513 filed Mar. 14, 2013; and, a continuation-in-part to U.S. application Ser. No. 13/902,957 filed May 27, 2013 which claims the benefit of U.S. Provisional Application No. 61/652,306 filed May 28, 2012.

All of the above patent applications are hereby incorporated herein by reference in their entireties.

### COPYRIGHT NOTICE

A portion of the disclosure of this patent document contains material which is subject to copyright protection. The copyright owner has no objection to the facsimile reproduction by any one of the patent disclosure, as it appears in the U.S. Patent and Trademark Office patent files or records, but otherwise reserves all copyright rights whatsoever.

### FIELD OF THE INVENTION

The present invention relates to a software application development system and method for producing, delivering and displaying universally adaptable, scalable applications that are activated and accessible through a distinctive Hierarchical Access Navigation and Menu System.

### BACKGROUND OF THE INVENTION

In the current state of software development, the code for display of an application or website on a single digital device may be incompatible or result in unintelligible display of content and poor operability when accessed on other digital devices. Particularly, since the advent of small footprint mobile devices, the following website and application problems are familiar to those skilled in the art: (A) Consistency & Compatibility across any digital device, (B) Displaying multiple navigation options with distinct “touchability” in a small footprint, (C) Providing a variety of impulse Access Options vs specific typed in requests with limited space availability, (D) a hierarchical access navigation and menu system consistent across many applications, (E) seamless access to “Constant Need” applications without switching environments, (F) digital compactness, bandwidth and transfer time issues with limited hardware resources on mobile devices, (G) Monetization issues related to maximizing cash spend and ad spend, (H) assuring easy and speedy selection and access to apps (used herein to refer to software applications on mobile digital devices) most needed by users confronted by limitless available apps but without a way to determine user preference or more preferably a user rating system to display the most useful and popular apps, and (I) limited functionality or operation when an internet connection is unavailable. The software application development system of the present invention addresses and solves each of these problems.

### SUMMARY OF THE INVENTION

The following is a summary of features of the various embodiments of the present invention provided to address the deficiencies of the related art.

(A)—Consistency & Compatibility is addressed by a generic Universal Master Architectural Blueprint, Core Picto-Blueprint Application and Core Modular System Library, and one or more Universal Application Blueprints, Dependent Picto-Blueprint Applications referred to in other patent applications by the same inventor as STAR-RAID-POINT ( ) Applications. The Dependent Applications also having their Application Modular System Libraries which all feature Composite Hyper Displays whose content and code is compatible, consistently functional, and consistently displayable on all mobile devices irrespective of specifications and by all other computer processing display devices. The Core and Dependent Applications have in common the ability to use a common and universally adapted display mechanism such as a “web-Browser” and where necessary, the Applications are hybrid-linked in nature, to accommodate small amounts of separate native code to address specific hardware requirements.

(B) Small Footprint Display issues are resolved where the Architectural Blueprint prevents composite hyper displays where content including text is unclear and/or buttons are not distinctly accessible as a result of crossover touch problems. The production of Trans-Snips as components and elements of the Composite Hyper Displays pre-assures scalable, viewability on any digital device and particular on small size format screens of cellular telephones or other mobile devices.

(C) Variety Access vs Specific Request Access is addressed using the seamless interchangeable Access Navigation System provided by the Architectural Blueprint that provides for unused or seldom used applications or content to be removed and replaced ending clutter, and tailoring the Universal Access to what a majority of users want to see, providing a useful, convenient, consistent, “impulse media” oriented User Experience (UX), without changing the expected User Interface (UI). The Core Application and Dependent Application within the Access Navigation System are downloaded using data packets that may be stored as a resident server on a mobile device so that sets of software applications are installed together and accessible with minimal download time.

(D) The Universal Access Navigation & Menu System further allows catering to and the development of different related applications of variable hierarchical search menus in a unique picto montage style presenting related content that allows consistently more options than the ‘typed in’ hunt and peck item list that frequently presents unrelated search results as commonly used by most search engine optimization strategies. Co-incidentally, the Access Navigation System can switch to hunt and peck request access with one button, thereby allowing impulse viewing, searching or shopping.

(E) Seamless Constant Need Apps are addressed by a permanently available Side Panel feature of the present invention that provides unique accessibility to build in “Must Have” software applications or apps such as to shop, send, search, socialize, call, message, bet, spend, rate, access and store personal data, and perform other operations such as personal storage. A Main Panel display provides for all applications to display consistently and be operable on any size screen format and/or operating system of a digital device.

(F) Digital Compactness is addressed by a software development system that uses the Architectural Blueprints and process production tools to further replace large amounts of written software code with interchangeable small format composite hyper display modules, the generation of which does not need coding expertise and which provides infinitely variable condensed code, content and enhancements to display dynamic audio and visual presentations. Additionally, using Architectural Blueprints all content and operational controls are created from Composite Hyper Display technologies and file formats that present Trans-Snips providing essentially code within code thereby reducing bandwidth requirements, download speeds, display times and providing a reduction in overall code needed to develop a wide range of software applications, websites, shopping carts, transactional management systems and dynamic Multi-Dimensional Presentations.

(G) Monetization issues are resolved in that the Architectural Blueprints also always provide seamless optional access to monetization either in the form of virtual cash that may be referred to herein as PictoCash and/or client financed advertising that may be referred to herein as PictoAds. The PictoAds, PictoGames, and other Applications may provide monetization triggering to have a user immediately access virtual cash to make and securely validate purchases without exiting the Core Application.

(H) User Rated Access is uniquely assured such that the composition and content of the “Must Have” and other software applications may be determined through an internal rating system referred to herein as a PictoMeter where public preference dictates what is offered using a unique Hierarchical Menu structure that may be displayed as the Side panel within the Access Navigation System. Unlike the endless icons normally arranged within a desktop or smartphone display to access each application individually, the Hierarchical Menu provides for immediate, partial or complete interchangeability of the Core Application, all or any one Dependent Application, all or any content in the form of images, sound, video, audio and/or video effect which may be application content and/or advertising. The change in content, look and feel, and/or any feature of the Hierarchical Menu may be determined using an internal rating system based on use, access and feedback from users based on for example a user majority such as an 80%-20% rule that sets what software applications, features, advertisements, and displays are presented within the Universal UI of the Core Application, or of any Dependent Application whiling maintaining features to perform the Must Haves to shop, send, search, call, message and perform other tasks.

(I) Internet Accessibility issues are addressed by having an identical application either on a website or resident on the digital device with a delayed internet feature where all content and features of the Applications are operable, and any request or requirement for internet access is performed immediately when the internet access becomes available. Access to websites, mobile apps, and/or cellular telephone features are also provided through a network or wireless internet connection with website or application viewable within the Core.

NAVIGATION, CLARITY & OPERABILITY. The concept of impulse buy is not new. However, you can't buy what you can't see. The art of hierarchically structuring layouts for user needs is not new. Macy's may have eight floors. Each floor may have eight departments. Each department may have eight isles with multiple attractively presented goods. Most search engines including Google do not work this way. You peck and type a specific request. Multiple times, this is not what is required or preferred. In a restaurant, you want to see a menu that is attractive and structured. In fact, the chef will seldom cater for a specific request not on the menu. The small mobile footprint is not conducive to multi-view impulse selection and layout. Similarly an advertiser places no value on an ad that cannot be seen. The Architectural Blue Print Hierarchical Access Navigation System addresses this problem by maximizing options clearly and operably across all digital devices, at the same time offering total flexibility with its interchangeable design.

UNIVERSALLY COMPATIBLE CONSISTENT ACCESS NAVIGATION. Whether shopping, searching, looking at a map or choosing an app the presentation of multiple choices is a problem with devices which have a small footprint. The quantity, visibility, clarity and independent definition for each touch selection become an issue that may vary across different digital devices. As an example, supermarkets attractively present an extensive variety of goods and then depend on the shopper easily navigating to what he wants. In mobile devices, an improved navigation system compatible and consistent across all devices would greatly benefit users, sellers and advertisers by offering and opening up impulse view and impulse spend in contrast to the existing hunt and peck, specific request which doesn't lend itself to impulse buying or window shopping viewing. Ideally a variable multiple tiered approach with a consistent, logical, quick and easy access and view methodology is desirable, and particularly needs to be compatible across all digital devices

MUST HAVE ACCESS. With the exception of the workplace, and specifically in mobile applications, users primarily access digital devices to search, shop, socialize, and send text messages, emails, images, and other information. Most of all of these digital devices are also capable of making and receiving telephone calls, emails, and/or texting. Additionally, in the mobile smartphone world, these digital devices are also used almost for a third of the time for information, games, or self-gratification in other forms. The software application development system of the present invention provides for the creation of Core and Dependent Applications that seamlessly integrate and present all these most common needs and other Must Haves such as providing secure access to make purchases, present content related advertisements, and catering the UI to preferences of a user majority using the unique PictoMeter rating system.

MONETIZATION. Seamless access to a pay mechanism and or to promotions and discounts with advertising is a requirement of an impulse driven system that offers a variety of choice as to where a user can spend their time and/or their money. These features are seamlessly integrated and presented within the Core and Dependent Applications created using the software application development system of the present invention.

NET AVAILABILITY, SPEED, MEMORY OVERHEAD & TRANSFER. The concept of “Dependent Applications within a Resident Server” is not new. Arguably, it is nothing more than an additional folder and file structure that is resident on a digital device as opposed to available through a network or internet connection on an external remote server. However, the definition and addition of scalable technology, small file size format and the use of descriptors to this resident server folder structure are new to the art. A resident server provides ease and speed of access by reducing access time to continuously connect to and download from (sometimes numerous times) a remote server that dependent upon the quality and speed of the wired or wireless connection not only takes a tedious amount of time but also may be slow and intermittent in transmit speeds resulting in delays in viewing and accessing a web site or application. Access to the resident server using the Core Application or other Dependent Applications is immediate, (in fractions of seconds) with content displayable without delays aided by using a unique small file format and scalable, replaceable Composite Hyper Displays of the PictoOverlay Technology providing a Universal UA unlike other digital device software technologies.

PRIOR ART CONVENTIONAL NAVIGATION. Software application programs such as word processing, spreadsheets and other applications of the prior art commonly use tab and drop down menus offering lists of items for selection by the users to access new content or perform operations within the application, such as selecting open to open other documents within the application. This approach in conventional use is not viewable or practical within the small screen format of a mobile device where a user must zoom and scroll to view and access operations within a drop down menu. To have applications be accessible within the small mobile footprint, the application must be redesigned to be flexible, consistent, compatible, similarly operable and interchangeable and more importantly be foremost in clarity and touch distinction, while maximizing options. The Access navigation System of the present invention resolves these issues of touchability and accessibility through easily operable control buttons and command interfaces and extreme clarity of any text, image content, or operating function.

SPECIFIC REQUEST SEARCH vs HIERARCHICALLY MAPPED MULTIPLE VARIETY The concept of hierarchical topic access is not new and applies to numerous subjects and applications where navigation is defined as in books, newspapers, stores and within other structures as topics and categories to assist a user in finding what they are looking for. However, search engines commonly provide only lists of content based most often only on the wording not the actual content of the search. The software application development system of the present invention provides both content related search results and caters to a ‘type and peck’ specific request preferred method used by conventional search engines on the small mobile footprint format by implementing a unique mapping system whose alphabetic index directs the user either to their choice if it is available within the modular system libraries or if it not available presents a conventional search engine URL within the Main Panel display inside the Application and access to any web page is available without existing the Core Application.

CURRENT ART IMPLEMENTATION. In the current state of software development an application or website may be limited to presentation on a single device, using either Responsive Technology and/or RESS Technology to resize the application or be redundantly coded in order to be displayed on other devices of different operating systems and screen size formats. These current approaches to translate an application to a number of different devices suffer from limitations in three specific areas, 1) Content Device Compatibility and Consistency; 2) Slow Download and Access Speed for Multiple Applications and Multiple Content versions; 3) Lack of Small File Format, Functionality and Minimization of Code and Content with limited ability to change the resident code of the device. In using RESS to resize an application or website the content may not be easily scalable where minimization may cause image distortions, cause textual content to become illegible or result in difficulty in the selection of functional controls where a control button may be too small to easily select with the user's fat, stubby finger. Therefore in most cases, in order to view a website, or access controls or menu items on a small mobile device display, the user must scroll to search for the content of interest and then zoom in to make the content legible and control buttons functional. The software application development system of the present invention provides for the creation of universal display consistency, operability and compatibility that may be implemented on any hardware, operating system and screen size of any digital device

INTERNET ISSUES. As commonly experienced by a user in scrolling and zooming through a website, there are substantial delays as new content is downloaded and displayed with a somewhat annoying hourglass or refreshing arrow flashing for several seconds until the content is visible and accessible. Even with the fastest internet connections, depending on the methods used to resize and translate an application or website, the ease of access on a cellular phone or smartphone may be somewhat limited and frustrating for a user. Also importantly, in order to add new content and/or functionality or modify the content and/or functionality within an application or page of a website requires additional coding and restructuring of the website layout to properly size and view the new content which may require the downloading of a completely new version of an application or temporary downtime as a website is updated. Overwriting an older application with a new version as well presents significant issues for a software developer to create code to convert data and templates from an older version to new file structures in a newer version without loss of data or formatting. The software developer as well must consider and redundantly code these conversions for data and templates stored in various digital device formats. Software applications of the current art therefore without additional coding and resizing are not adaptable, compatible, or modular and do not provide a format that may be universally displayed on any digital device.

The Application development system described herein addresses and resolves each of these issues and limitations through a unique approach to maximize the display and functionality of the small footprint of a mobile device and have compatible, scalable display and functionality on all digital devices. By providing a universally compatible consistent PictoOverlay User Access (UA), User Interface (UI), and User Experience (UX), supported by resident server technology, and the completely innovative interchangeable Architectural Blueprint development platform, the creation of mobile apps, software applications, social media applications and websites become simple, dynamic, fun and educational. Interactive and competitive games, news, multi-media presentations, product information, advertising, secure purchasing, social interaction and other content can be developed using the same Application development system.

The various embodiments of the present disclosure provide innovative application development production tools including an interface and file structure that is unlike the development of presently known software applications. Its purpose is to maximize the flexibility and efficiency in the small footprint of the mobile display environment, and to be upwardly compatible and scalable to larger devices. Further, it uses Modular Quadrant Zoom Technology (MQZT). This technology contrasts with conventional thinking of reducing what has been available in larger format display devices to display appropriately in the mobile environment. Applications developed using the production tools within the Architectural Blueprint interface of the STAR-RAID-POINT software application development system provides the capability to vary any and all content and any and all functions within an application. Using the Scalable Transparent Adjustable Resident-Recodable Accretive Interchangeable Design (S.T.A.R.-R.A.I.D.) and PictoOverlay Interface Enhanced Trans-Snip (P.O.I.N.T.) Technology development system, an entire display within the User Interface (UI), the functional controls and operations they perform within the User Interface, and/or any dynamically presented image content may all be changed without the rewriting of code.

The various embodiments of the present disclosure comprise a software application development system for universal display consistency, operability and compatibility as implemented on any digital device, comprising: a computer system; at least one master architectural blueprint; component architectural blueprints specified and generated by the at least one master architectural blueprint, the component architectural blueprints defining the structure, design layout, content blueprint, hyper display location blueprint, and navigation function blueprint and descriptors required to create a plurality of software applications universally displayable, consistent and compatible with any size hardware or operating system of a digital device; and a population system defined by the architectural blueprints. Within the software application development system, an access navigation system is defined by at least one master architectural blueprint to provide seamless access to all other of the plurality of software applications, external applications, web pages, and URL's without exiting a defined core application environment. The population system has components and elements of a plurality of composite hyper displays defined and controlled by the architectural blueprints using descriptors to implement and functionally display the components and elements of a plurality of trans-snips and associated enhancements as the operational and functional content of the plurality of software applications.

In one embodiment, the software applications have a main panel having quadrants; at least one side panel having navigation controls; wherein based on the display characteristics of a digital device the main panel, and the side panel are scaled to form a wide screen, full screen display in a landscape orientation on the digital device; and the plurality of software applications, external applications, web pages, and URL's displayable within the main panel without exiting a defined core application environment.

In another embodiment, the architectural blueprints define functional quadrants or display quadrants, the display quadrants and scalable display components thereof being scalable and zoom able for maximized display within the main panel display; and the navigation controls of the side panel access at least one of the plurality of software applications, external applications, web pages, and URL's and the plurality of software applications are functional and displayable within the quadrants of the main panel without exiting a defined core application environment.

The software application development system allows for the display of the plurality of software applications to be vertically maximized on the digital device within the screen display of the main panel using a standard aspect ratio currently 4:3 based on 1024 by 768 pixels and the remainder of the display of the plurality of software applications on any high definition wide screen device is allocated to the side panel providing for the entirety of the main panel and the side panel conforming to a standard high definition aspect ratio currently 16:9 or 1364 by 768 for wide screen digital devices; and, wherein any display panel and its subset components are automatically provided in standard aspect ratio and can be scaled upwards using modular quadrant zoom technology to occupy the full main panel display in the same standard aspect ratio currently 4:3; and wherein, if required, such full main panel display may be digitally transferred to allow printing of the maximized content of the full main panel display in a landscape format on a standard proportioned paper size.

In the software application development system, the main panel can provide for dependent application navigation and display and the side panel provides for navigation and switching of the dependent application within the core application environment.

The software application development system additionally comprises production tools to create, render, and preview components, elements, and descriptors of the software application development system and plurality of software applications including dedicated non-generic Production Tools including proprietary system software to transform raw and semi-processed code or content as defined by the architectural blueprints.

The production tools comprise a plurality of software processing modules; at least one automated executable interface implemented within an architectural blueprint; and wherein the executable interface provides for batch processing to create the components and elements of the population system, using any number of the plurality of software processing modules.

The software application development system comprises display panels and functional control panels made up of composite hyper displays; and wherein the composite hyper displays comprise trans-snips to perform tasks or execute other instructions within the plurality of software applications.

In the software application development system, the architectural blueprints may use at least one modular, limitless hierarchical multi-dimensional matrix for the structuring, development and rendering of the plurality of software applications, such matrix to include at least one descriptor to define or reference components, elements, or combinations thereof, of the software application development system and plurality of software applications.

In the software application development system, the descriptors are alphanumeric reference codes as text as defined by the architectural blueprint to provide display, operational and functional references and instructions for all components and elements of the plurality of software applications; and wherein the references and instructions provide at least one of the identification of content, code instructions, code in code, the sequential, temporal, spatial and functional display or location of the components and elements of the population system, the reference file structure of stored content, the compression and reduction of hard code, the transfer of any and all components and elements of the plurality of software applications including the components and elements of composite hyper displays, trans-snips, and enhancements.

The production tools to create a plurality of composite hyper displays and their components and elements can use batch processing; wherein composite hyper displays comprise the components and elements of trans-snips, descriptors, enhancements, raw content, and functional code; and sequentially, temporally, spatially and functionally define and implement the display of trans-snips and associated code including code within code with the rendering or activation of such trans-snips; and wherein trans-snips may be overlaid with other trans-snips to create multi-layered composite hyper displays.

The software application development system allows for production tools to create a plurality of trans-snips and their components and elements using batch processing; and wherein trans-snips comprise at least one of the following elements: an unpopulated transparent image, an image with defined size and shape, such image positioned inside an unpopulated transparency with defined location, and any such images having further characteristics of location, sequence, priority, timing gap, associated enhancements, and associated code within code implemented with the rendering or activation of such trans-snip.

The software application development system components may also comprise enhancements defined as any co-existing display, any code, or any media effect that can be rendered on a digital device such as text, audio, video, smell, animation, special sound and visual effects, charting, timing, sequencing, triggering, overlaying, forming insets, linking to external applications or any other functional operation as determined by the developer.

In the software application development system, the creation of components and elements of at least one architectural blueprint, the components and elements of the population system, and the components and elements at least one of the plurality of software applications can be created in a selective, automated batch process which is specified and defined by descriptors and the plurality of the software processing modules of the production tools to develop a plurality of components and elements simultaneously.

The software application development system creates composite hyper displays minimize that replace elements of lengthy conventional alphanumeric hard code.

Composite hyper displays are rendered using a universal language code and the hybrid connections available to such code; and composite hyper displays in the rendering of their code are linked to one of at least external hybrid native code, code within code, interchangeable descriptors, and external applications, web pages and URL's that activate components and elements of the composite hyper displays.

Composite hyper displays are rendered using a universal language code and the hybrid connections available to such code; and composite hyper displays in the rendering of their code are linked to one of at least external hybrid native code, code within code, interchangeable descriptors, and external applications, web pages and URL's that activate components and elements of the composite hyper displays without exiting a defined core application environment.

In one embodiment, one or more of the components, elements, content and descriptors are encrypted.

The composite hyper displays can utilize an interchangeable modular hierarchical matrix file structure for the storage of content, functional code and descriptors including descriptors providing the file folder reference for storage of the plurality of all components and elements separately on at least one storage device.

The software application development system may use at least one storage device, being a server on the computer system.

The software application development system may use at least one storage device which is a resident server on a digital device remote from the computer system.

Composite hyper displays may implement the association of functional code and content for the operation and function of the plurality of trans-snips within the plurality of software applications, including the implementation of variable functional code within functional code.

Composite hyper displays may implement functional code as enhancements for the operation and functional display of the plurality of trans-snips within the plurality of software applications, including the implementation of variable functional code as enhancements.

The architectural blueprints may define in one or more component parts user access, user interface, user experience, and user content comprising the content, sequence, characteristics, positioning, navigation, and functioning of the display, the rendition of the display operationally, with display consistency and compatibility on all digital device platforms, and the transferability of content, operation and function of content and of the plurality of software applications using only the transfer of the descriptors from one digital device to one or more other digital devices.

In the software application development system, the components, elements and descriptors of the architectural blueprints and composite hyper displays of the operational and functional content of the plurality of software applications are one of at least generic, endlessly adaptable, accretive, adjustable, interchangeable and transferable.

In the software application development system, the components and elements of the composite hyper displays are compatible, scalable, and consistently displayable and functional on any screen size, format and operating system of any digital device.

In the software application development system, it may comprise hierarchical topic navigation mapping, using descriptors to create index type referenced and stored content to alleviate the absence of database capability in current universal language code.

Architectural blueprints content searching may additionally be performed using an alphanumeric keyboard within the hierarchical topic navigation map and where unavailable locally triggers to extend search parameters to external search engines and present search results within a main panel display of a core application environment.

In the software application development system, the plurality of software applications may be created using reduced functional code, content resolution selection, trans-snip masking, message coding, and reusable raw content within the components and elements of the composite hyper displays, descriptors, minimizing the space required within a storage device of a resident server on a digital device, reducing access time for operational function and the display of content and reducing transfer time of modular data packets to a remote digital device.

In the software application development system, lack of internet access has no effect on the operational functionality of the plurality of software applications and access to the internet as required may be delayed, to be performed when an internet connection is available.

In the software application development system, elements of at least one of the plurality of trans-snips may be a mask having portions of transparency and opaqueness, enabling underlying layers to be in a more compressed graphic format than that afforded by transparency formats.

In the software application development system, a navigation architectural blueprint may define operational controls as composite hyper displays of arrows, buttons, or other command interfaces within the plurality of software applications and the navigation architectural blueprint provides alerts for any defined operational control determined to be inoperable or indistinguishable within a screen display of any screen size of any digital device.

In the software application development system, a navigation architectural blueprint may define the maximum real estate within a display to maximize the components and elements of content and command interfaces with all components and elements being visibly distinguishable and distinct to be operational so that a user may touch and operate a single control.

In the software application development system, the master architectural blueprint may specify and generate component architectural blueprints to develop a plurality of software applications including to search, shop, send, message, socialize, call, bet, spend, rate and access and store personal data, and access external applications, web pages, and URL's; and all of the plurality of software applications are accessible within the core application environment using the access navigation system and without exiting a defined core application environment.

In the software application development system, the master architectural blueprint may specify and generate component blueprints that define content comprising generic, interchangeable, trigger able, and variable advertisements for the plurality of software applications including those to search, shop, send, message, socialize, call, bet, spend, rate and access and store personal data, and that access external applications, web pages, and URL's without exiting a defined core application environment.

As defined by the architectural blueprints, one of at least the content, operation, and function of the plurality of software applications including those to search, shop, send, message, socialize, call, bet, spend, rate and access and store personal data, access external applications, web pages, and URL's may be replaceable and that the replacement of the content, operation and function is based on a rating system.

The rating system comprises a mood meter that accepts a scaled feedback rating and components and elements of content, operation and function are replaced based on a statistical sampling of the scaled feedback.

The rating system as defined by the architectural blueprints may control the content, operation and function of the plurality of software applications available within a core application environment. The rating system may use a statistical sampling of the entire population of users and an accepted rule of popular appeal; and the plurality of software applications may be immediately interchangeable based on the rating system determination.

The rating system as defined by the architectural blueprints, optionally reports the scaled feedback to a user.

In the software application development system, one of at least the components, elements and descriptors of the content, operation, and function of the plurality of software applications are interchangeable based on an infinite number of end nodes and descriptors as defined by the architectural blueprint to perform content switching without the rewriting of code.

In the software application development system, one of at least the components, elements and descriptors content, operation, and function of the plurality of software applications are interchangeable as defined by the architectural blueprint to perform content switching without the rewriting of code; and the interchangeable content, operation, and function, of the plurality of software applications is selected randomly using a random generator.

In the software application development system, the at least one master architectural blueprint defines an architectural blueprint to develop one of the plurality of software applications as a software application to pay for virtual money that is associated with real money; and the software application provides variable exchange rates for promotion or other purposes offered to be used for purchases in the plurality of software applications including those to search, shop, send, message, socialize, call, bet, spend, rate and access and store personal data, and access external applications, web pages, and URL's without exiting a defined core application environment.

In the software application development system, the at least one master architectural blueprint defines an architectural blueprint to develop one of the plurality of software applications as a software application to transact virtual money associated with real money to be used for purchases in the plurality of software applications including those to search, shop, send, message, socialize, call, bet, spend, rate and access and store personal data, and access external applications, web pages, and URL's without exiting a defined core application environment.

The software application development system may use a monetization trigger if defined within at least one architectural blueprint, to be implemented within one or more of the plurality of software applications including those to search, shop, send, message, socialize, call, bet, spend, rate and access and store personal data, and access external applications, web pages, and URL's without exiting a defined core application environment.

In the software application development system, a pictoidentity for the validation of a financial transaction may be defined as a composite hyper display by at least one architectural blueprint to be implemented within one or more of the plurality of software applications including those to search, shop, send, message, socialize, call, bet, spend, rate and access and store personal data, and access external applications, web pages, and URL's without exiting a defined core application environment.

A pictoidentity as a composite hyper display may be accompanied by a cell phone number input as defined by at least one architectural blueprint to be implemented within and provide access to one or more of the plurality of software applications, external applications, web pages, and URL's without exiting a defined core application environment.

In the software application development system, the infinite variability of structure, components and elements of a pictoidentity composite hyper display provides levels of security comparable or exceeding fingerprint identification.

In the software application development system, if text is defined by at least one architectural blueprint, the text associated with a component or element of the population system and the text optionally may be provided in a plurality of languages to be implemented within one or more of the plurality of software applications.

In the software application development system, if auto-voice is defined by at least one architectural blueprint, associating a sound with a component or element of the population system and the audible sound where applicable may be provided in a plurality of languages to be implemented within one or more of the plurality of software applications

The software application development system may comprise automated production tools to form composite hyper displays as defined by the architectural blueprints with variable content and digital information embedded within the variable graphics content; and storing the composite hyper displays in a .chd file format using descriptors to reference storage location, associate composite hyper display content having attributes and functional code, the attributes being one of at least text content, size, shape, location, enhancements, sequence, priority, timing, transparency; and wherein the image content, attributes and functional code are stored separately.

In the software application development system, the variable content in any component, element or descriptor may be varied by renaming alternative content with one of the image content, other content, attribute content, the digital information embedded within the variable graphics content, the descriptors, and the composite hyper displays from within at least one architectural blueprint.

In the software application development system, at least one architectural blueprint may define the transmission of descriptors as only referenced alphanumeric text from a first digital device having visual and functional content of at least one of the plurality of software applications stored within a resident server stored on the first digital device to a resident server with mirrored content on a second digital device to define visual and functional content of the at least one of the plurality of software applications on the second digital device.

The software application development system may include a plurality of unpopulated component architectural blueprint layouts as specified and generated by the master architectural blueprint for the development of the plurality of software applications and a generator to specify and create one or more different unpopulated blueprints.

In the software application development system, the architectural blueprint may define printing content from within the main panel display with the proper alignment and sequence of the content on the printed page to be folded based on the correct sequence and alignment of the content or at least one of a plurality of folds of the printed page.

In the software application development system, the architectural blueprint may define messages as codes to provide transmission as descriptors using minimal bandwidth, storage space, and transmission time, with subsequent conversion by server such that the message is decoded and received within one of at least the plurality of software applications, as an email, as a text message, and as a voicemail.

In the software application development system, the architectural blueprint may define modular data packets having triggers to control timing and access to content, operation, and function, of at least one of the plurality of software applications; and wherein the content, operation, and function, of at least one of the plurality of software applications is replaceable by switching the modular data packet for another modular data packet.

The software application development system may comprise a software application development system implemented on a digital device having at least one microprocessor, at least one memory device and at least one storage device, the software application having code and content for the transformation of data using these devices, the software application development system comprising; at least one architectural blueprint defining the structure, design layout, and descriptors required to create a software application; and a plurality of composite hyper displays as defined by the at least one architectural blueprint to implement and functionally display the software application.

The software application development system with a plurality of composite hyper displays is universally displayable, consistent and compatible with any size hardware or operating system of a digital device.

In the software application development system, the components, elements and descriptors of the architectural blueprints and composite hyper displays of the operational and functional content of the software application are one of at least generic, endlessly adaptable, accretive, adjustable, interchangeable and transferable. Additionally, in the BluePrint Matrix descriptor system, in one embodiment, in order to achieve variations in display content or function, descriptor names and filenames are set by the blueprint and not changed, but the “inside” content of such descriptors and filenames are replaced and the descriptor-filename overwritten to change the display content or function.

The software application development system includes a method for the development of software applications, comprising: installing application software as a software application development system on a digital device having at least one microprocessor, at least one memory device and at least one storage device, the application software having code and content for the transformation of data using these devices; generating at least one architectural blueprint defining the structure, design layout, and descriptors required to create a software application; and, implementing and functionally displaying the software application using a plurality of composite hyper displays as defined by the at least one architectural blueprint.

The method for the development of software applications in the system results in applications which are universally displayable, consistent and compatible with any size hardware or operating system of a digital device.

An object of the invention is that the software development system as specified and defined by a Master or Application Architectural Blueprint provides an interchangeable Access Navigation System to create any number of software applications that may include Must Have Applications and impulse driven systems to monetize software applications through advertisement and monetization triggers within one or more software Applications.

An object of the invention is that the software development system as specified and defined by a Master or Application Architectural Blueprint provides navigation and display capabilities of the user interface itself and provides assets and content for all other applications, including the geometry, to allow full functionality within the available Navigational and Display capabilities without requiring the additional writing or the modification of functional code.

An object of the invention is that the software development system as specified and defined by a Master or Application Architectural Blueprint optimizes operational and display consistency on any size hardware or operating system including a small screen footprint of a mobile device.

An object of the invention is a software development system as specified and defined by a Master or Application Architectural Blueprint that maximizes display consistency and functionality of User Access (UA), User Interface (UI), User Experience (UX), and User Content (UC).

An object of the invention is a software development system as specified and defined by a Master or Application Architectural Blueprint that uses a Matrix and Descriptors to define the timing, sequence and spatial display of content and the operational and functional features of a software application.

An object of the invention is a software development system as specified and defined by a Master or Application Architectural Blueprint that uses at least one limitless modular Matrix of points for the spatial location, timing and sequence of content.

An object of the invention is a software development system as specified and defined by a Master or Application Architectural Blueprint that has components to define content, location, sequence, timing, operation and function of a software application.

An object of the invention is a software development system as specified and defined by a Master or Application Architectural Blueprint that defines a file structure and file format for storage of Composite Hyper Displays that are comprised of components and elements of Trans-Snips, Enhancements, functional code and Descriptors.

Another object of the invention is a software development system as specified and defined by a Master or Application Architectural Blueprint that uses a .chd file format for storage of Composite Hyper Displays with content, attributes, and functional code stored separately.

Another object of the invention is a software development system as specified and defined by a Master or Application Architectural Blueprint using Picto-Overlay Technology to form Composite Images as components and elements of the Composite Hyper Displays.

Another object of the invention is a software development system as specified and defined by Architectural Blueprints that define a Main Panel, Quadrant, Segment and Side Panel geometry that is scalable based on the screen footprint of a digital device by determining the maximum height of the screen and scaling content to a standard aspect ratio such as currently accepted as 4:3 and in high definition 16:9.

Another object of the invention is that the Architectural Blueprint defines in one or more component parts, the content, sequence, attributes, positioning, navigation, and functioning of the display, the rendition of the display on all digital device platforms, and the transferability using only descriptors of software applications and/or content from one digital device to another.

Another object of the invention is that the Architectural Blueprint defines software applications that have content, features and operational controls that are generic, endlessly adaptable, accretive adjustable, interchangeable and/or transferable.

Another object of the invention is that the Architectural Blueprint defines software applications that have content, features and operational control that are compatible, operational, scalable and consistent across all digital devices.

Another object of the invention is the storage of content as Modular System Libraries on a digital device using minimal space within the components of the device for storage and thereby reducing access time to display content and perform operations within software applications.

Another object of the invention is the configuration of Modular System Libraries that maximize available content from minimal amount of native content through the transformation of native content into Composite Hyper Displays using production tools as defined by an Architectural Blueprint.

Another object of the invention is the automatic transformation of numerous files in the form of raw content into Trans-Snips using production tools as defined by an Architectural Blueprint.

Another object of the invention is the sending of application and Modular System Library composition changes using one or more descriptors, or accretive native content or both.

Another object of the invention is the development of Composite Hyper Displays with Trans-Snips, Descriptors, Enhancements and functional code removing the necessity to hard code an end item in order to display that item as content within a web page or software application.

Another object of the invention is the transformation of raw content by sizing, shaping, coloring and processing the raw content with other attributes, forming a transparency of the raw content and associating the raw content with operational and functional Enhancements to form a Trans-Snip as a component of a Composite Hyper Display.

Another object of the invention is the separation of content, code, navigation, spatial location, timing and sequence of a Composite Hyper Display and storing this information associated with the Composite Hyper Displays in separate locations such as separate file folders or Modular System Libraries.

Another object of the invention is the configuration of Modular System Libraries and processes as defined by Architectural Blueprint to maximize content options and minimize native code content.

Another object of the invention is a variable display overlay generator that produces random Composite Hyper Displays that overlay to “maximize” the use of unique content images and assets, the overlays may be used as a means of PictoIdentification to secure and prevent unauthorized access to a Master Application, software application, financial transaction or other secure environment.

Another object of the invention is a PictoIdentity as defined by the Architectural Blueprint providing security levels comparable to fingerprints.

Another object of the invention is external access to software applications that are developed without using the Architectural Blueprint software development platform and through the use of the currently accepted aspect display, under the guidance of the existing Access Navigation System external content and operational functionality of an external software application may be displayed and accessible within and from either the Main Panel or Side Panel without exiting a Core and/or Dependent Application.

Another object of the invention is production tools of the Architectural Blueprint to transform content spatially, temporally, sequentially, and operationally.

Another object of the invention is the optimization as defined by one or more Architectural Blueprints that provide content within a display as full screen landscape with MQZT page driven maximization at a standard aspect ratio or high definition aspect ratio.

Another object of the invention is the display of vibrant, clear, legible content and operational controls full screen without scrolling or zooming.

Another object of the invention is the exponential display of end nodes using the PictoOverlay Technology creating pyramid expansionism used as a quasi-alternative to sort, search and display related content as defined by the Architectural Blueprint.

Another object of the invention is Composite Hyper Display defined as equivalent to code within code.

A further object of the invention is the maximization of display real estate between alternative navigational access and maximized application display content in the ‘accepted’ aspect ratio, the maximization provides for maximizing distinct distinguishable component content in the main panel, where maximum selectivity is applicable, and maintain seamless access to applications to such as to shop, send, search, socialize, call, message, bet, spend, rate, or the display of related advertisements or information, from the side panel or both panels. This seamless integrated switching also allows the ability to access predetermined basic needs: date, time, calendar, weather, calculator, converter, translator etc. as well as to store personal data and perform other operations. Additionally, the Core Application and/or Dependent Applications may perform searches, play interactive games, make secure purchases and access other software applications.

A further object of the invention is the controlled access to content and operational controls based on a specific time to provide for users to compete in real time such as through a PictoTV Application and/or PictoGame and or through a trigger within a software application to provide access.

A further object of the invention is the randomization of content to provide for user to receive different Composite Hyper Displays in a Data Packet or through randomizing Descriptors as defined by the Architectural Blueprint to provide for different people, different backgrounds, and different Enhancements and other attributes to be randomized to produce lottery tickets, erotic content, gambling games and other Composite Hyper Displays to be used in a Core and one or more Dependent Applications.

A further object of the invention is the development and optimization of an impulse driven system through the variation of images, for applications, advertisements, purchases, and other information within a display by replacing Composite Hyper Displays and/or any of their components and elements with alternative Composite Hyper Displays and/or any of their alternative components and elements through the selection or randomization of content.

A further object of the invention is monetization triggering within any software application that provides secure access to virtual currency that is directly associated with actual currency through the generation of a secure code and transactional verification using a PictoIdentification for purchases and other financial transactions.

A further object of the invention is the development and optimization of an impulse driven system through monetization, access and interchangeability of software application content.

A further object of the invention is the variation of images, for applications, advertisements, purchases, and other information within a display through the replacement of Composite Hyper Displays and/or any of their components and elements with alternative Composite Hyper Displays and/or any of their components or elements within an Access Navigation System based on a ratings system referred to herein as a PictoMeter that may be determined from popularity, feedback, usage and other factors where un-liked and un-used content may be immediately replaced through the external control and analysis of ratings without user input or control of content.

A further object of the invention is the encrypted file structure with index type and hierarchical topic mapping that provides for rapid searching through one or more Modular System Libraries and the display of related content in a montage display in response to search requests.

A still further object of the invention is a software application development system providing an application architecture that is configured for delayed access to the internet without affecting the operational functionality of the Core Application and/or any Dependent Application.

A still further object of the invention is a Core and/or Application Architectural Blueprint that defines the maximization of a display and the functional operations in a standard aspect ratio currently 4:3 within a Main Display Panel that with a Side Panel is in a high definition aspect ratio currently 16:9 and that any content within the display is scalable up to the standard aspect ratio for viewing and printing.

Other objects and advantages of the present invention will become obvious to the reader and it is intended that these objects and advantages are within the scope of the present invention. Headings and capitalization of terms appear only for the convenience of reference and are not be used for the interpretation of terms within this application. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a diagrammatic representation of an embodiment of an Architectural Blueprint and its components in an embodiment of the software application development system of the present invention;

FIG. 2 is a diagrammatic representation of an embodiment of the components and elements of a Composite Hyper Display in an embodiment of the software application development system of the present invention;

FIG. 3A is a diagrammatic representation of an embodiment of a menu display and related HTML CSS Code as known in the prior art;

FIG. 3B is a diagrammatic representation of an embodiment of a menu as a Composite Hyper Display created using the software application development system of the present invention;

FIGS. 4A-4I are diagrammatic representations of embodiments of the components and elements of the Composite Hyper Display file format showing Trans-Snip overlays to form a Composite Hyper Display as created in an embodiment of the software application development system of the present invention;

FIG. 5A is a diagrammatic representation of an embodiment of the components and elements of a software application as defined by an Architectural Blueprint in an embodiment of the software application development system of the present invention;

FIG. 5B is a diagrammatic representation of an embodiment of production tools and components and elements of Composite Hyper Displays as defined by an Architectural Blueprint in an embodiment of the Software application development system;

FIG. 5C is a diagrammatic representation of an embodiment of Architectural Blueprint Production Tools.

FIG. 6 is a diagrammatic representation of a Content Blueprint showing hierarchical topic mapping to structure, store and access content in an embodiment of the software application development system of the present invention;

FIG. 7 is a diagrammatic representation of a Content Blueprint index type alphabetical file naming as part of the file structure to store and access content with a content viewer in an embodiment of the software application development system of the present invention;

FIG. 8 is a diagrammatic representation of a Modular System Library file structure to store and access content in an embodiment of the software application development system of the present invention;

FIG. 9A is a diagrammatic representation of a Content Blueprint to develop, structure, store and access content in an embodiment of the software application development system of the present invention;

FIG. 9B is a close up view of group 119 in FIG. 9A;

FIG. 9C is a close up view of the content label 151 of FIG. 9A;

FIG. 10 is a diagrammatic representation of a Hyper Display Blueprint to locate and spatially, temporally, and sequentially display content in an embodiment of the software application development system of the present invention;

FIG. 11 is a diagrammatic representation of an embodiment of the Access Navigation System of a Core Application showing the Main Panel and the Side Panel;

FIG. 12A is a diagrammatic representation of an embodiment of the prior art showing twelve end nodes as available content within a display;

FIG. 12B is a diagrammatic representation of exponential end nodes available using the PictoOverlay Technology and software application development system of the present invention;

FIG. 12C is a diagrammatic representation of sixty-four end nodes using the PictoOverlay Technology and software application development system of the present invention;

FIG. 12D is a diagrammatic representation of the display of Trans-Snips as end nodes using the PictoOverlay Technology and software application development system of the present invention;

FIG. 13 is a diagrammatic representation of an embodiment showing the construction of a Composite Hyper Displays by overlaying Trans-Snips and the creation of Descriptors within a Data Packet as defined by the Architectural Blueprint of the present invention;

FIG. 14 is a diagrammatic representation of an embodiment of the transmission of Descriptors from a resident server of one digital device to a resident server of another digital device;

FIG. 15 is a diagrammatic representation of an embodiment of frame locations having multiple Composite Hyper Displays showing clearly viewable content even on small screen format digital devices with the ability to interchange Composite Hyper Displays within all or any portion of the display;

FIGS. 16A-16C is a diagrammatic representation of an embodiment of a negative, inverse, and/reverse Trans-Snips that may cover all or a portion of other Trans-Snip layers as defined by the Architectural Blueprint of the present invention;

FIGS. 17A-17C is a diagrammatic representation of an embodiment of layering of negative inverse, and/reverse Trans-Snips as masks that may cover all or a portion of other Trans-Snip layers as defined by the Architectural Blueprint of the present invention;

FIGS. 18A-18C is a diagrammatic representation of an embodiment of the automated creation and display of Composite Hyper Displays from raw content as defined by the Architectural Blueprint of the present invention;

FIG. 19 is a diagrammatic representation of a further embodiment of the automated creation and display of Composite Hyper Displays from raw content in the form of a PictoPuzzle as defined by the Architectural Blueprint of the present invention;

FIG. 20 is a diagrammatic representation of an embodiment of frame locations within the display of the Main Panel with an alphabet keypad and a number pad as defined by the Architectural Blueprint in an embodiment of the present invention;

FIG. 21 is a diagrammatic representation of the Access Navigation System of the Core Application shown as a ‘Lobby’ that provides access to the Dependent Applications as ‘Theatre Stages’ in an embodiment of the present invention;

FIG. 22 is a diagrammatic representation of an embodiment of a PictoKids Application in an embodiment of a software application developed using the software application development system of the present invention;

FIG. 23 is a diagrammatic representation of an embodiment of a PictoNews Application in an embodiment of a software application developed using the software application development system of the present invention;

FIG. 24 is a diagrammatic representation of an embodiment of a PictoMeter Application in an embodiment of a software application developed using the software application development system of the present invention;

FIG. 25 is a diagrammatic representation of an embodiment of a PictoBank Application in an embodiment of a software application developed using the software application development system of the present invention;

FIG. 26 is a diagrammatic representation of an embodiment of a PictoCall Application in an embodiment of a software application developed using the software application development system of the present invention;

FIG. 27 is a diagrammatic representation of an embodiment of a PictoText display and features in an embodiment of the PictoCall Application in an embodiment of a software application developed using the software application development system of the present invention;

FIG. 28 is a diagrammatic representation of an embodiment of a PictoText message display and features in an embodiment of the PictoCall Application in an embodiment of a software application developed using the software application development system of the present invention;

FIG. 29 is a diagrammatic representation of an embodiment of a PictoChat message display and features in an embodiment of the PictoCall Application in an embodiment of a software application developed using the software application development system of the present invention;

FIG. 30 is a diagrammatic representation of an embodiment of a PictoCard created within a PictoCard Application in an embodiment of a software application developed using the software application development system of the present invention;

FIG. 31 is diagrammatic representation of an embodiment of the Core Application and Dependent Application within a Resident Server on a digital device and a computer system as a remote server storing and implementing the software application development system of the present invention; and

FIG. 32 is diagrammatic representation of an embodiment of the Core Application and Dependent Application within the Resident Server on a digital device.

### DETAILED DESCRIPTION OF THE EMBODIMENTS

As used herein, the term “Picto” refers to a picture as viewed on a computer digital display. As used herein, to avoid confusion between a Composite Image and a Composite Hyper Display, note that a Composite Image can only become a Composite Hyper Display if it is accompanied by the appropriate descriptors. As used herein, the term “Software Application Development System” refers to one or more digital devices comprising the hardware and software of the various embodiments of the present disclosure.

The Picto-Blueprint Software Application development system is implemented for the development of software applications on digital devices such as computer systems, any mobile device, iPod, iPad, tablet computer or smartphone, digital display device and any other digital device that can be used as a processing unit, a display unit, or a unit to give processing instructions, through a network or internet connection using an external remote server or resident server on the digital device. The Core and Dependent Applications developed using the software application development system of the present invention dynamically present and provide for the creation of and access to numerous personal and commercial applications, including but not limited to adventure stories, games, puzzles, films, shopping and other interactive applications that are displayable at any resolution and in any format of any digital screen without utilizing software code that is specific to a particular device or format, meaning that the same code and content is utilized to interface with and display the Applications on any digital device of any screen size and/or Server (including Web Server). The Core Application with one or more Dependent Applications may be downloaded to a resident server as a single data packet and be installable and updated through a single process. Data packets with the Modular System Libraries provide for all code and content for these Applications to be modular and interchangeable and therefore updates to any functional operation, content, or display features and any functional code may be performed within the Core Application only; or within the Dependent Application only or within both. The capability to perform content and/or functional changes to either the Core Application or Dependent Applications is dictated through the Picto-Blueprint Architectural Interface also referred to as the Architectural Blueprint that may be in the form of a Master Blueprint for the Core Application and specific Application Blueprints for the Dependent Applications.

Specifically, the software methodology as described in U.S. patent application Ser. No. 13/904,025 and other patent applications to the present inventor, applies the scalable small file PictoOverlay Technology that is more rapidly downloaded to a digital device than current software application and mobile app technologies. The Core Application, the Dependent Applications and/or accessible external applications may be resident either locally on a computer system, on a mobile device or on multiple computer systems and/or mobile devices or be resident remotely on a server, web server, or remote server network or within a combination of both locally resident and remote storage and access of the digital devices. In this way one or more Applications may be accessible through an internet connection to a website on the remote web server, or be accessed using the resident Core Application and Applications server on the digital device without an internet connection. This system methodology therefore produces application code and content that is not dependent on internet access to display all of an application's image content and functionality and the system while providing full functionality may further delay access to the internet or network refresh capability until a connection is available without affecting the performance of any software Application. The system is also capable of toggling between the remote and resident servers as required by the Application, and does so automatically if internet connection is lost and current further access is denied through a server. Access to content or operational functions of an Application may further be controlled as defined by the Architectural Blueprint through the use of a trigger, a timer that prevents access until a specific event or time or may be controlled by requiring a user to enter a specific code or validate a code such as a PictoIdentification to provide access to a specific user account or to securely validate any financial transaction within the Core Application and any Application. The delay and controlled access to an Application or content may provide for real-time trivia games or other competitions with other user where the user must access the Application simultaneously. A trigger such as a monetization triggers may provide access to an Application or content may be through the initiation by a user when a selection of an advertisement is made and the monetization trigger provides for a user to immediately make a secure purchase of for example an advertised product by securely using PictoCash without exiting the Core Application. The software application itself may generate triggers to control, delay and direct the user to features and outcomes within an application.

All content and operational controls within the Core Application and Dependent Applications is defined by the Master and Application specific Architectural Blueprints and is presented using Composite Hyper Displays stored in a .chd file format. The Composite Hyper Display structure and .chd file format is designed not only to cater to Web Based HTML code but is also intended to apply to the modification of resident native application code and content where the modular code/content concept and characteristics are also applied, and where linkage to HTML code is desirable or effective as separate resident stationary native Data Packets. The Composite Hyper Display structure and .chd file format therefore provides code within code transforming native code applications and modularizing resident code to allow for additional or replaceable content data packets to be delivered to modify and/or change the existing Core and/or Dependent Applications' functionality, operation, code and content.

The Core Application and Dependent Applications may include or require a dedicated resident Web browser and may additionally include the exchangeable, adaptable Data Packets that provide the Composite Hyper Displays to present the content and operational controls of the Core Application and Dependent Applications. The Composite Hyper Display files stored in a compressed .chd file format within the Modular System Libraries may be specific to a Core Application, to one or more Dependent Applications and/or to both. The Data Packets may modify a Modular System Library in its entirety or in any portion with capability to modify and provide updates to any Modular System Library separately or in conjunction with any other Modular System Library. In this manner, an update to the mobile or other digital device internal resident server may prioritize, replace, expand, contract, alter and/or modify the functionality, operation, information and/or content to be presented within the Core Application and/or within any one or more Dependent Applications. The Modular System Library may further include raw, unexpurgated images and or other data in standard formats that is transformed into the Composite Hyper Displays modular file format that may comprise one or more Trans-Snips, Descriptors and functional code.

Trans-Snips may be overlaid to create Composite Hyper Displays that may also be stored as Composite Hyper Display .chd files, with the Composite Hyper Displays and functional code providing content and operational controls within the Core Application and within the Dependent Applications. Therefore by transforming unexpurgated data into numerous Composite Hyper Display files having functional code, Trans-Snips, and Descriptors, minimum native content in raw file format is needed to produce numerous Composite Hyper Displays using the Picto-Overlay Technology. Use of native content is therefore maximized and functional code is minimized whereas described herein the modular file format of the Composite Hyper Displays provide code within code. The Modular System Libraries therefore maximize the options for image content within any application while minimizing the storage space and bandwidth required for download.

The software development system of the present invention provides for the creation of a wide range of software applications, websites, shopping carts, transactional management systems and display techniques using the completely innovative development methodology of the Picto-Blueprint Architectural Interface. The Picto-Blueprint Architectural Interface provides a navigational structure for all content used within an application, including application specific Architectural Blueprints that define Panels, Quadrants and Segments that are scalable and displayable on any digital device the presentation of content. The Architectural Blueprint is not simply a coordinate map for locations within a two dimensional display as commonly used in the development of web pages and other software application programs of the prior art, but is instead a Matrix that encompasses geographic points within a spatial, temporal and sequential construct to define the interaction of multiple Composite Hyper Displays providing the content and operational controls within a software application. Using the Architectural Blueprint development platform and PictoOverlay Technology, the UA, UI, UX and UC is maximized where the display of content and functionality is consistent, legible and easily accessible on any size screen or operating system format of any digital device.

The Composite Hyper Displays are embodied in a completely unique file format that integrates code within code and associates code and Descriptors with stored content images or other content and/or other code. The Descriptors may be encrypted to provide secure access to any content. The Composite Hyper Displays in the .chd file format referred to herein as the chad file format may have functional code in HTML, CSS, JavaScript, any of their versions or other code languages in other formats. The Composite Hyper Displays are displayable in a web browser or through the Hierarchical Menu viewer with the displayable content as one or more Composite Hyper Displays being zoomable to the defined Panels, Quadrants and Segments that are scalable to conform to the universally accepted display aspect ratios or print sizes of any digital device. The Architectural Blueprint defines the Panels, Quadrants, and Segments for display and the sequential, temporal and spatial attributes of the Composite Hyper Displays to maximize navigation, flexibility, viewability, display, function and efficiency at any time on any device, ensuring clarity and accessible functionality on mobile small footprint devices before scaling upward for larger screen devices.

The hierarchical structure of the Architectural Blueprint as the development platform provides for multiple tiers which each having levels made of up components and elements that form the structural content and provide the function of the Core and Dependent Applications where each component is defined as being made of elements that may also be made up of components and elements. In a top down approach the Picto-Blueprint Software Development System has components of a Master Architectural Blueprint, Production Tools, a Blueprint Generator, a Population System and other functional tools and operational generators to develop the software application components and elements. The Blueprint Generator specifies and defines the Application Architectural Blueprints with each blueprint having three components that may be in the form of layouts. These Architectural Blueprints are the Navigational Blueprint, the Hyper Display Blueprint, and the Content Blueprint.

The operation and functional layout of a software application is defined using the Navigation Blueprint that may be in the form of a pre-defined template that defines the structure of certain operational components. The Navigation Blueprint may define a Main Panel having a number of quadrants or segments with some of the quadrants being display quadrants and some being functional quadrants. The Navigational Blueprint may further define a Side Panel with a Hierarchical Menu and the number of buttons and/or other operational features of the menu within of the Side Panel. For example in the Main Panel, the Navigation Blueprint may define two functional and two display Quadrants with one being the Main Panel display quadrant having a montage structure with nine elements and define twelve access navigation buttons for the Hierarchical Menu in the Side Panel. The Main Panel is therefore made up of the components of display and functional Quadrants and the Montage page elements with the display quadrants defined by the Navigational Blueprint in a standard aspect ratio, currently as a 4:3 aspect ratio for scalable and zoomable display using the Modular Quadrant Zoom Technology (MQZT). The Side Panel has the component of the Hierarchical Menu and the elements of the twelve access navigational buttons as defined by the Navigation Blueprint. The developer may choose how many operational buttons or other elements are needed within a Core or Dependent Application and alerts within the software may identify and indicate to the developer that operational buttons may not be operable within small screen file formats as a caution that may be overridden if desired. The layout of the Navigational Blueprint is defined using Descriptors.

The Navigational Blueprint may further define global commands and operations to display the Core and Dependent Applications on the digital device. For example, the screen display may be defined in order to determine the maximum height of the screen of a digital device that is then used to scale the display quadrants and Main Panel to the generally accepted standard aspect ratio that is currently 4:3 or to a high definition aspect ratio or wide screen such as 16:9 depending upon the screen size and format on the digital device.

The Hyper Display Blueprint is used by a developer to define the location, sequence and timing in functionally displaying content of the software application within the structure defined by the Navigational Architectural Blueprint. Using a modular limitless matrix structure content is associated with points as locations within the matrix that correspond to attributes, enhancements and placement of the content within the layers of the matrix. Active content may be prioritized on an upper layer and optional content within a maximized number of end nodes may be defined below and within the layers. The location, sequence, timing of the Hyper Display Architectural Blueprint is defined using Descriptors.

The Content Architectural Blueprint defines the file structure and storage of content in an index type alphabetical format that may be mapped using an Application Content Blueprint to use the content within a software application. The content file structure is defined by the Content Blueprint using Descriptors. The content is in the form of raw unexpurgated data in the form of text and/or image content, and as Trans-Snips and as Composite Hyper Displays. In developing a software application, production tools may automate all or any part of a process to transform raw content, Trans-Snip, or even Composite Hyper Displays to create other Trans-Snips and Composite Hyper Displays using the descriptors defined within the Navigation, Hyper Display and Content Architectural Blueprints. In creating Trans-Snips, raw content may be sized, shaped, formed as a transparency, have a background added, be colored, have text added or have any number of other operations performed to associate attributes with the raw content. A Trans-Snip therefore has components and elements that may include a raw image, text, size, shape, and transparency with each attribute having Descriptors. The Trans-Snips may then be associated with the attributes of sequence, timing, location and enhancements using the Descriptors of the Hyper Display Architectural Blueprint to form Composite Hyper Displays. The Enhancements have components and elements of functional code and Descriptors to provide audio, animation, video, sound and visual effects and or other dynamic features for display or functional features to perform tasks.

Composite Hyper Displays therefore have components of Trans-Snips, Descriptors, Enhancements, functional code, and code within code and the elements of each of these components. Composite Hyper Displays are used to implement and functionally display the Trans-Snips and Enhancements as defined by the Descriptors of the Architectural Blueprints. Composite Hyper Displays therefore are essentially all of the content, the operational controls and functional components of the Core and Dependent Applications developed using the software development system of the present invention. The Composite Hyper Displays are stored using Descriptors in the .chd file format that ingeniously separates and stores each of the attributes, locators and Enhancements of the Trans-Snip in separate file folders. For example, the functional code for sizing and shaping the raw content image, the functional code for creating the transparency of the Trans-Snip, the functional code to locate the Trans-Snip, and the functional code in the form of Enhancements to dynamically display the Trans-Snip each may all be stored separately within the file structure of one or more Modular System Libraries. The association of the components and elements of the Composite Hyper Displays is also stored as functional code and/or as Descriptors the Composite Hyper Displays file. The rewriting of code and the total amount of functional code is therefore substantially minimized where the same functional code to perform a task such as to form a transparency may be implemented with any number of raw image content files and be implemented in an automated fashion through the functional code associated with the Composite Hyper Display file as defined by the Descriptors of the Architectural Blueprint. The automated processing of any and/or all attributes associated within the Composite Hyper Displays provides for incredibly large numbers of content files to be transformed to Composite Hyper Displays almost instantaneously providing for infinite content to be available for use in the Core and Dependent Applications.

The Picto-Blueprint software methodology with the completely distinct features of the Composite Hyper Displays provide for all of the preferred content display, layout and functionalities of an application to be changed by the addition or replacement of one or more Composite Hyper Displays or one or more Trans-Snips, by changing functional code, by changing attributes associated with the Trans-Snip, by changing the raw content of the Trans-Snip, and/or by changing Descriptors all by virtue of the Modular System Library file structure, embedded code and descriptors of the Composite Hyper Displays. By virtue of the embedded code, content replacement using Composite Hyper Displays is therefore completely different from conventional content replacement where source code must be rewritten to change the applications content or functionality. Using software development platform of the Architectural Blueprint, the defined Descriptors and the Composite Hyper Displays the look, location, function, the spatial and functional relationships, background, operational features and controls and content within the software application can all be changed without the rewriting of any functional code. The ability to change the content and functionality of any software applications is also a completely different approach to software development that is independent of the hardware platform of the computer system or digital device and is therefore unlike any hardcoded application development methodologies.

An analogy and explanation of this differentiation may be considered by equating software development of the prior art to the construction of a building on a piece of land with existing necessary utilities, where the land represents the specific type of hardware that includes the microprocessor, memory, hard drives, display screens and other electronic components of a computer system or other digital device. An operating system (OS) that can provide input and output communication is developed by writing source code at a machine language level to control these hardware components. Different operating systems may be installed on any particular set of hardware components with a single operating system normally required for a particular device. The operating system, in this analogy, therefore is a building on the piece of land (the hardware) that includes electrical wiring, piping to provide water and heat, and other utilities but otherwise is an empty building.

A desktop or other type of navigational user interface is then written in source code to provide for a user to interact specifically with the hardware components of the digital device. The desktop provides limited functionality to allow a user to install additional hardware, setup logins, passwords and access restrictions, set specific parameters for the system hardware, such as power management settings to shut down the system after a specific period of time of inactivity, and perform other hardware related tasks. The desktop provides for a user to install other application software programs and displays icons that serve within the building analogy as doors from a lobby that when selected run an executable file to open an application. In the current art, the source code for the desktop is further written to provide a specific look and feel with limited variation. For example, the background picture within the desktop may be changed, or the image used for an icon may be changed, however the functionality of displaying an icon within the desktop and having the icon open an executable file for an application cannot be changed. The desktop therefore provides a front entryway or lobby within the building that is constructed as a room with one or more doors representing access to the specific applications installed on the computer system. In opening a door, source code specific to that application is activated with this code having some communicational interfaces to work with the desktop and operating system. These interfaces are written in source code to specifically communicate with a particular desktop that is installed on a particular operating system that includes specific machine language source code to communicate with the specific hardware of the digital device. To have an application be functional and display on a different type of desktop, on a different type of operating system on different type of hardware currently requires writing additional source code if some features within the code are compatible, in the analogy adding an additional foundation and room to the building, or if there is not compatibility then a complete rewrite of source code equivalent to tearing down the building and building another one is required.

In complete divergence from the effort, time to complete, and man hours in completely rewriting code for compatibility from one digital device to another, the PictoOverlay technology using Composite Hyper Displays separates the navigational and application levels from the operational and hardware levels to provide compatibility across all platforms without rewriting any source code. Because all applications are developed using Architectural Blueprints, the content and functionality is within the images and embedded code of the Composite Hyper Displays and the display and interaction is designated and defined using Descriptors. A change in content or functionality is therefore completed by changing one or more components or elements of the Composite Hyper Displays or the Composite Hyper Displays themselves with the Architectural Blueprints maintaining the instructional and structural integrity of the Applications without relying on a specific operating system or hardware.

In keeping with the analogy, the Access Navigation System of the Core Application forms a flexible, adaptable interior design to the building that can be likened to a “Theatrical MultiPlex” whose carefully designed “Lobby”, the Navigator, allows access to numerous, “Theatrical Stages”, the Application Display Modules. These Theatrical Stages are supported in the same building by “Storage Areas”, the Modular System Libraries, that in this analogy, are in the form of Assets that include ‘Costumes’, ‘Scenery’, ‘Furniture’, ‘Props’, ‘Sound & Video Equipment’ and last but not least ‘Actors’. The production of scenes using the Assets is a dynamic presentation where the choreography of each Actor, as Enhancements and display of each Asset, as Trans-Snips, is carefully defined within the Matrix topography of the Architectural Blueprint with the display and activation of the embedded code of the Composite Hyper Displays providing visual and auditory effects and interactive functionality for the audience, the user of the Application. Importantly, the spatial, temporal and sequential display of the Composite Hyper Displays is encoded within this Matrix structure of the Architectural Blueprints using Descriptors that are in the form of text as reference code that represents the unique file structures and operational functionality specific to and required by the particular Core Application or the particular Dependent Application. These Descriptors in turn access the Storage Areas (Modular System Libraries with Assets) and thereby present the application for the user in any user interface desired, and also present access to built-in Must Have software features and application and other applications providing for a user to easily navigate from one application to another.

As an example, the Access Navigation System of the Core Application may provide a beautifully laid out and carefully designed furnished appealing ‘Lobby’ which provides access to the numerous ‘Stages’, Applications, that may include Must Have functionality for necessary and normal operational expectations for a digital device such as ‘TelePhone Booth’, ‘Post Office’, ‘Search Library’, ‘Social Network Library’ and others. The ‘Lobby’ and these Must Have stages are furnished and populated from the “Modular System Libraries” as described herein. The ‘facilities’, of the Core Application as the ‘Lobby’ and the Applications as the ‘Stages’ are comparable to the higher levels of the desktop and applications of conventional software programs. However, using Composite Hyper Displays, unique strategies and communication protocols have been developed for use within the software development system of the present invention that perform tasks such as print, save, call, and search. In a first embodiment, involving a Built-In Call Application, a call may be made by selecting an image of a person and selecting from a set of messages, such as select ‘Mom’ and select message ‘I will be home late for dinner. Call me’. This recorded message is available from the Storage Assets on the local device, the user's resident server, and also within the resident server on the receiving digital device, Mom's mobile phone. The Application sends the telephone number associated with Mom and provides the server with the descriptors of the identification of the user making the call and the descriptor to play the verbal message, “Jimmy will be late for dinner, please call him.” Because the messages are available and selected by the user, the Descriptor may contain only one or two letters such as WH for “When will you be home?” as an example or be longer as required to give the server enough information to translate the message. In this way calls are sent in compressed descriptor format as text through an internet connection without the need for or use of a Voice over Internet Protocol (VoIP) on the sending mobile device, thus saving connection time, bandwidth, and data storage. The messages, Moms Image, and telephone numbers are stored as Composite Hyper Displays in the compressed .chd file format sent to the server. A large number of such messages may exist within the resident contact information within a Modular System Library on both the server of the sending and the server of the receiving mobile device with options for more messages to be added by receiving new Data Packets. A message may be selected verbally by the caller, with voice recognition displaying the verbally translated message in text for the caller to select. In this way the most common messages may be available within the Messaging Application display and a call may be made by simply selecting the message. The Built-In Must Have Call Messaging Application may not only send such messages in Descriptor text format but may also use server capabilities to actually place a call to a cellular telephone, or place a call through a VoIP such as Skype using an internet connection, send the message using an email server, send the message through a chat interface, or send the message as a voicemail as examples of the capabilities of the Dependent Applications to be integrated with and be usable with distinct features of the digital device.

The integrated Must Have Search capability within the preferred embodiment of the present invention also provides capability to search using a keyboard that provides a fill-in feature with rows of optional alphanumeric characters listed for a user to select. In the event that a selection is unavailable from the stored Modular System Libraries resident on the digital device or servers through an internet connection, the Access Navigation System of the Core Application may automatically default to a conventional search engine web browser page as defined by the Architectural Blueprint. In doing so, the Main Panel display presents and provides access to the web page of the search engine without exiting the Core Application. In the event that an internet connection is not available through cellular, Wi-Fi or other means, the request is deferred-delayed until a connection is available. Both internal storage and external web links that may be associated with a search request and/or an Application is available and provided where an access feature may be done through a defined layout in the Hierarchical Menu of the Side Panel offers seamless navigation links to both internal and/or external applications and websites and the internal and/or external applications and websites are displayed and operational within the Main Panel display.

In the current art, it is not typical to have resident databases in applications. Relational database requirements are almost always server dependent. Also simple databases also depend on hypertext preprocessor (PHP) or other server based code. The Core Modular System Library stored within the Data Packets uses a unique file storage structure as defined by the Content Architectural Blueprint that implores a hierarchical categorization methodology that similar to a book or catalog may identify content as being associated with categories referred to herein as chapters, subchapters, and pages. Using an alphanumeric file naming structure, a particular content file may be identified as being associated to any number of categories within one or many chapters, sub-chapters and pages for the content file to be used in a Composite Hyper Display for display within those categories within the Core Application and/or a particular Application. The file naming structure is defined by the Master Architectural Blueprint for the Core Application or particular Dependent Application Blueprints. The content stored in the .chd file format is utilized based on the instructions defined within the Architectural Blueprint for the application. These instructions may be in the form of text descriptors to map the identified alphanumeric file names of the content files to the categories. For example the Architectural Blueprint may define a chapter as continents, a sub-chapter as countries, and a page as cities. The raw content may be stored in the Modular System Library in alphabetically order with a map of the alphanumeric filenames and labels constructed within the Master Architectural Blueprint. Within a Search Application, the Content Application Blueprint may define Descriptors that map to any content having labels belonging to one or more of these pre-defined categories. In this way related content may be identified to be used more than once and in various Applications for example to be presented as content related search results in response to a search request, and/or in a PictoGame having a particular topic. The Composite Hyper Displays and content may therefore be stored in a general repository within the Modular System Library not redundantly stored in multiple locations that have files specific to a certain application or category. From the general repository the content file may be accessed and utilized by one or more applications based on the requirements defined within the Architectural Blueprint for that application. The use of general repositories reduces the bandwidth necessary to transfer Data Packets and minimizes storage space requirements within a resident server.

Through the alphanumeric identification file naming structure of the content files, the Architectural Blueprint provides for localized data searching that is equivalent to searching of a relational data base that is not dependent on accompanying hybrid code. The Applications may also access particular content files through a keyboard to find a specific item in the stored Modular System Library using the core navigational structure of the Master Architectural Blueprint and provide access to an external search engine without exiting the Core Application if no results are found in the library. In displaying any search results, the Architectural Blueprint provides maximized end point capability where a chosen end point may access a montage to arrange arrays of “topic’ information by a category in the form of predetermined and ‘most likely requests’ for categories requested from the stored packets available. This is unlike conventional listing of phrase links that include a typed in word where the phrase links may have completely unrelated content with the exception of having a similar word. The UA and UI provides a unique montage page display of related content in response to a user's search request because of the arranged Modular System Library file structure and defined mapping of content into multiple pyramids of chapters, sub-chapters and pages to create the same effect as a selected set of conditions in a typical relational database.

The Core Application and any Must Have or Independent Applications may normally be dependent on stored Modular System Libraries and other Assets that are available within the resident server or that are referred to from the remote server if they are not locally available. A single “stored” Data Packet may have native raw content that may be modified to form Trans-Snips as components of the Composite Hyper Displays that when overlaid may create millions of Composite Images. At least 648 images may all be accessible within the Access Navigation System constructed by the Master Architectural Blueprint using the Picto-Overlay Technology in the small file look-up format without delay in presenting the content, as opposed to downloading of content as is done currently with web pages. The Master and Application Blueprints provide for maximized display such that images are vibrantly displayed with crystal clear image content and legible text even on a small screen cellular phone. The Picto-Overlay Technology further provides for the display of exponential nodes of material content. This is in complete contrast to current web page development that provides only for the display of a single layer of images within a predefined frame. The software application development system provides for the creation of millions of Composite Hyper Displays as Composite Images by simply accessing different end nodes of content within a software application. The software application development system further provides a random generator to randomly access and display content or operational features that is unlike any current software application of the prior art with the randomization providing for PictoPuzzles and other applications and games that in this way maximize the available native content and the development of PictoIdentities that because of the randomness and variability are comparable to the level of security of fingerprints for the validation of financial transaction or access to secure locations.

The Master Blueprint and any Application Blueprints provide for infinite variability in the software applications accessible through the Hierarchical Menu of Side Panel or to any content, operational or functional controls within Application in the Main Panel. The content can therefore be easily varied and the Side Panel in any one application may provide redirectable access to other applications and/or web links that are directly related to the content displayed within the Main Panel. For example, for a child creating a PictoStory about a horse in a Picto-Kids Application, the Side Panel may display twelve image links to other animals with each image providing navigation to educational information for the child to learn, or alternatively such links could be advertisements linked to the content enabling a child or user to shop or because of the efficient use of real estate within the Hierarchical Menu a mobile small file format display may provide links to both. Access to informational content is maximized in a PictoNews Application, where twelve different images are provided in the Side Panel for each news story presented within the Main Panel. Each access image could provide additional information on subjects within the news story main display or advertisements that are easily accessible by a user. For example, a user is reading a movie review and image links are provided to movie theaters where the movie is playing, where the movie is available on DVD, where the movie can be downloaded for viewing, advertisements for toys and replicas from the movie, other movies with the same actors, or a review of the book that the movie is based on, and other optional content, with every news story providing new image links to both additional information and advertisements using Trans-Snips and the overlay technology. Importantly, the Hierarchical Menu provides for monetization triggering through the user's PictoCash Account. A user that clicks on an advertisement triggers a monetization option that the user may select to access their PictoCash Account and purchase the product in the advertisement. The financial transaction requires the user to validate a PictoIdentity that is unique to the users PictoCash Account so that any transaction is properly verified and secured. Even within the mobile small file format, each of the twelve images are easily accessible by simply selecting an image using a single fat, stubby finger which when selected immediately changes the Main Panel display and may also immediately change the Side Panel display.

The Core Application further provides an efficient and accurate PictoMeter rating system that controls what is displayed within the Main Panel and Side Panel of the Access Navigation System to create an impulse driven system for a user to satisfy the most commonly performed tasks on their mobile and computer equipment without leaving the Core Application. As is known in the prior art, the collection methods of analytics through tracking what web sites a user visits and what purchases a user makes is not new. From this data, great efforts have been put forth to develop algorithms that attempt to guess what type of advertisement should be displayed when a user is searching or shopping. From movie recommendations to statements of “users who bought this product also bought these products” these attempts meekly entice users to action without any or very limited specific knowledge of what the user actually wants. Users are left to “hunt and peck” by scrolling through item after item until the item of interest is found. While showing top selling items is fairly common, the ability to remove poor selling items and quickly replace them or simply present them more attractively is difficult, costly and time consuming. The time in design layouts, compiling content and the recoding necessary to present new information in a website or present information with a different look and feel prevents content to be rapidly changed within a web page.

The easily variable content and PictoMeter rating system of the present invention provides for content within the Access Navigation System of the Core Application or in any other Application to be immediately changed to best suit the favorite choices of a majority of users. Data on usage of applications or clicks on advertisements may be collected at intervals and users may be prompted for comments on likes or dislike of an application, advertisement or overall display. Using for example an 80%-20% rule and the variable content structure defined by the Architectural Blueprint and implemented using Composite Hyper Displays, content poorly received may be changed by changing Descriptors within the Core Application and/or Application Blueprint, by downloaded an updated Data Packet and/or by replacing the components and elements of the Composite Hyper Displays. The interchanging of content is instantaneous so that the content and/or the look, feel, and presentation of content within the Main Panel and Side Panel displays can be completed at any time without the rewriting of any code. No analytics or user preference algorithm can provide the immediacy of feedback with user response to new content being immediately tracked and gathered. The PictoMeter rating system may continually acquire data and present changes based on the acquired data immediately or at any time as determined statistically by the data gathered. The PictoMeter rating system may further provide for a user to rate products, celebrities, friends, movies, vacation spots, software applications, companies, and almost anything else and provide for the user to provide feedback that may be ranked using a number scale, colorful images or words to describe the user's rating value. The rating value may be displayed and presented with feedback from other users to see how a user's rating value measures up against the majority. The user may further review how others are rating other people, places and things to what things are of interest to a majority of users and any bad rating may result in the changing of the display. For example in other software applications the PictoMeter rating system may be used for a celebrity gossip application that allows a user to rate a celebrity based on current news items, performance and/or exploits and then a colorful enhancement in the form of a sound or visual effect may show a very different image of the celebrity based on the rating from the PictoMeter.

The immediacy of changing content further provides advertisers with the ability to change advertisements to suit the impulse buy of users so that advertisements that don't work can be replaced with advertisements that do. With the additional monetization triggering feature using the Picto-Cash Application, the impulse reaction to an advertisement by a user can result in monetization where a user simply selects the advertisement and it is displayed within the Main Panel or through an external website and shopping cart accessible within the Main Panel without exiting the Core Application. The user may then securely spend Picto-Cash for what is advertised as described in U.S. patent application Ser. No. 13/830,210 to the same inventor. The Picto-Cash may be replenished using a secure Picto-Bank Application as defined by the Architectural Blueprint that provides for a credit card to be entered to use real money to purchase Picto-Cash, but the credit card information is never associated with the user's account, so the transactions and purchases will be anonymous and secure.

The Master Blueprint and each of the Application Blueprints are further designed to maximize ‘Space usage’ on the digital device through the clear, consistent, and compatible navigational and display functionality using the Main Panel and Side Panel layout. This geometry and design allows for the new assets and content to be created and added by replacing Composite Hyper Displays with other Composite Hyper Displays from alternative content stored within the Modular System Libraries and where the content in the form of Composite Hyper Displays may be updated with Data Packets. The replacement of one Composite Hyper Display with an alternative Composite Hyper Display displayed as Composite Images and Trans-Snips may change the ‘Stage’ completely or any feature or functionality within the display or application without the need to replace all existing content-assets and without rewriting any functional code. As such, the Applications developed using the software application development system of the present invention are both modular in design and accretive, providing flexibility and considerable saving of time, efficiency and cost.

The Core Application further provides communication protocols to print, save and send (email) any Composite Hyper Display such as a PictoStory, PictoCard as a greeting card, and/or other creations from the Dependent Applications. The PictoStory or PictoCard may be displayable within an email in a non-functional image format that includes an attached link to open the Composite Hyper Displays of the PictoStory or PictoCard within the Core Application if a user does not have the Core Application opened at the time of receiving the PictoStory or PictoCard email. The PictoStory or PictoCard may further be received within the Core Application and or any other Dependent Application through a notification that when activated opens the Composite Hyper Displays within the Main Panel and activates any Enhancements to provide a Multi-Dimensional presentation of the PictoStory or PictoCard.

By using the Architectural Blueprint file structure, the Descriptors in the form of text as reference codes and the stored Modular System Libraries, the Core Application and the Dependent Applications are designed to be completely exactly duplicable in another ‘Multiplex” in a different location meaning on a different device which may have a different physical size, different hardware and that may use different utilities, meaning a different operating system or a different web browser or accepted display environment (e.g. HTML Viewer). In current technology, HTML code downloads content from a web page into the internet browser cache each time a web page is opened and reloads content from the cache if the web page is accessed again and the web page has not been modified. Depending on the complexity of the content, downloading of a single web page may take a number of seconds to download and this time to download is repeated as a user navigates through a series of web pages. In complete contrast, there is none or significantly less delay in downloading or transmitting an Application developed using the Architectural Blueprint platform.

Continuing with the analogy, in constructing a new ‘Multiplex’, assets from the old Multiplex are not transported, but instead only the instruction set in the form of Descriptors are transmitted to the new device location. The design, access features, layouts, furniture, props, costumes, actors, and other display and functional features are already available at identical storage facilities, in duplicate Modular System Libraries, at the new location on the new digital device. Accordingly, to duplicate a “Display Module” or the functionality of an “Application”, in another location on another device, simply relies on a ‘Content-Asset Descriptor List’ to be sent through an internet connection to the device, and the same exact display and functionality can be generated elsewhere including an exact replica of the Access Navigation System ‘Lobby’, the Hierarchical Menu and all the ‘Display Modules’ within the Dependent Applications.

There may be one or more Master Blueprints, and numerous Application Blueprints with that may have a common modular panel and quadrant based structure, and that maximize flexibility, efficiency, and compactness, and more importantly maximizes the variability and clarity-visibility of all content and operational controls. Additional features of the software application development system specifically address the method and process to create, develop, distribute and display the Access Navigation System as the user interface within a Core Application to access numerous other Applications without ever exiting the Core Application. In the preferred embodiment, the process and method provides for generating a specific Access Navigation System that creates a proprietary ‘Lobby’ and design for access to multiple ‘Display Modules’ (Stages or Applications) whose Composite Hyper Displays are interchangeable using Descriptors, Data Packets and the unique file structure that separates functional code from content and stores each attribute as functional code in separate file folders minimizing required functional code and maximizing the use of content to produce millions of Composite Hyper Displays.

The Picto-Blueprint Architectural software development system provides the Architectural Blueprint and production tools to construct any number of Applications, and the components and elements of the Composite Hyper Displays. Additionally, the Architectural Blueprint can maximize and/or vary the number of available end-points accessible within the Main Panel and Side Panel. The method and process of such construction is based on the Matrix Technology, illustrated in an embodiment as a masked access Matrix. In this embodiment the Matrix is a three dimensional 8×8×8 Matrix that is constructed to allow 512 endpoints. In a simple analogy, if the Main Panel could only identifiably display 24 clickable buttons on a mobile mini display, such display has 24 endpoints. If however, such display is constructed using overlay technology and Trans-Snips, a Matrix of three panels of eight clickable buttons and where the 2nd and 3rd displays are swapped and dependent on the clicking of an item in the first and second display panels, there would necessarily be 512 endpoints (8×8×8). In this way a greater amount of available content is accessible for superior UA within the UI.

In a preferred embodiment, the Architectural Blueprint defines the number of clickable viewable Matrix options to maximize end-points. If this is maximized at 3 quadrants of 8 buttons that were laid out aesthetically, different looks of such navigation panels may be provided by replacing the Composite Hyper Displays that make up the display with alternative Composite Hyper Displays with different images sizes and locations without rewriting any functional code. Furthermore, importantly, using Trans-Snip mask technology and the Trans-Snip overlay priority feature a mask within the 8×8×8 display may reveal a lesser and variable number of endpoints, with differing shapes and layouts revealing a differing number of endpoints. The Trans-Snip overlay priority feature provides for a Trans-Snip layered on top to be accessible for activation and lower layers not to be accessible, however Enhancement activation may result in the layered order to be changed to allow a Trans-Snip from a lower layer to be moved to a higher layer, to the top or to a lower layer, reordering the layers using Trans-Snip Enhancements. It is important to note that in the mobile world, current art using tabs and drop downs are not suitable in small footprint format for clarity and click ability reasons. Accordingly identifiable clickable PictoOverlay Technology and masking is central to the invention's methodology and process to allow variability as defined by Navigation Blueprint. Also importantly, because the Access Navigation System is constructed with reference to Descriptors, further random variation may be achieved either through randomizing access to the content defined by the Descriptor and stored in the Modular System Library, or, by editing the Descriptors within the Architectural Blueprint to randomly access other Composite Hyper Displays such that the resulting navigational display may provide varied looks based on different Composite Hyper Displays and or different components and elements of the Composite Hyper Displays and/or different Descriptors.

The software development application system implemented on the Architectural Blueprint platform may be used to develop real-time downloads of Data Packets with controlled timed access to the Core or Dependent Applications. For example, a PictoTV Application may be a game show type application that provides for competition among one or more users through an intranet, internet, wireless or other communication interface implemented on a digital device. In an embodiment, a series of quiz questions in the form of Composite Hyper Displays are downloaded as a Data Packet to the resident server of the digital device. Access to the content within the Hierarchical Menu of the Side Panel and or within the Main Panel display is denied until a specific time when all competitors can access the content and operational controls within the PictoTV Application at the same time. Users that attempt to access or manipulate the Composite Hyper Displays to gain access to the content are removed from the competition. In this way competitions in real-time based on equal access to the PictoTV Application content and operational controls is available to all users to provide a fair and more exciting competition. The time delay may in further embodiments be a trigger requiring the user to perform a specific operation, enter a Pictoidentity or other code to access their user account and/or make a purchase using Picto-Cash to enter the competition. In some embodiments, the user may access their PictoAccount by validating a PictoIdentity and entering their cell phone number for example. The randomization of the Composite Hyper Displays provides for applications where each user may receive completely different content related to news items or for example erotic photos that may randomly present different people to each user such as a hot looking guy for a female user and a shapely women to a male user, with each user receiving content displaying completely different attractive people. The randomization of Composite Hyper Displays may further provide for Dependent Applications related to social gambling among users, or lotteries where the monetization triggering may provide for a user to purchase lottery tickets using PictoCash and then receive winnings that increase the amount in their PictoCash Account. A PictoBank Application may provide for a user to securely enter a credit card and then validating a PictoIdentity purchase additional PictoCash corresponding to really money to be used for purchases through advertisements or other Applications.

The present invention relates to a software application development system and method for producing, delivering and displaying universally adaptable, scalable content and code that is compatibly displayable in “Core Application” and “Dependent Applications” within a “Resident Server” on any mobile digital device and/or digital device including computer systems, cellular phones, iPhones, smartphones, iPads, tablet computers, digital display devices and any other type of digital device with any type of operating system. The software application development system may be used as a software development platform to create computer and mobile applications, web sites, shopping carts and transactional management systems and other software applications. The software application development system may also be used to create enhanced featured, displayable, narrated, musicked, Multi-Dimensional Presentations to dynamically present an informative, educational, factual, story, game, puzzle or other artistic creation in an evocative and emotive format. The software application development system of the present invention may further be used to develop and maintain a payment and account entity management system to perform secure transactions without entering any personal identification information, login information or passwords. The software development system may further be used to develop an Access Navigation System that includes Must Have software applications for a user to perform the actions most commonly performed within a number of different software applications and websites providing for the user to perform the steps of shopping, sending, searching, spending, calling, messaging, and storing user created content without exiting a Core Application. The Access Navigation System further provides for interchangeable content related advertising to be presented with monetization triggering and other types of triggering Enhancements to provide for a user to purchase items of interest without leaving the Access Navigation System of the Core Application and/or any Dependent Application the user is accessing.

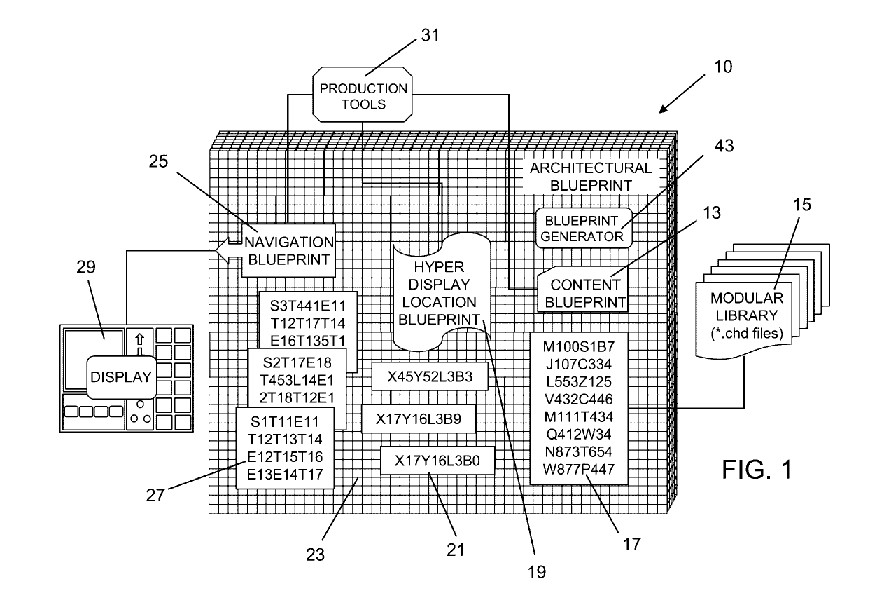

The key structure of the software development platform of the present invention is the Architectural Blueprint 10, as shown in FIG. 1 that is formed as a modular limitless Matrix 23 divided into location points to control the content, function and operation of any Core Application or Dependent Application. In its most basic form, the Architectural Blueprint 10 has the four key components; 1) the Navigation Architectural Blueprint for a software developer to define the operational control and functionality of a software application; 2) the Hyper Display Architectural Blueprint to define spatial, temporal and sequential locators as points, backgrounds, layers, and overlays for a developer to define the functional display of content within a software application; 3) the Content Architectural Blueprint to identify, store, and access content to be used in a software application; and 4) dedicated non-generic Production Tools including proprietary system software that transform raw content to Composite Hyper Displays that are then stored within the unique files structure of the Modular System Libraries of the present invention. The Navigational Blueprint defines the layout of the global navigational and specific operational controls of a particular software application to provide operational access within an application, access to hardware functions, such as printing, emailing, texting, or calling a mobile phone or other digital device, and access through the Access Navigation System to a Core Application and other Dependent Applications providing for the user to step from one software application to another within the Core Application environment and without any appreciable time delay caused by the downloading of additional content or operational controls for any software application.

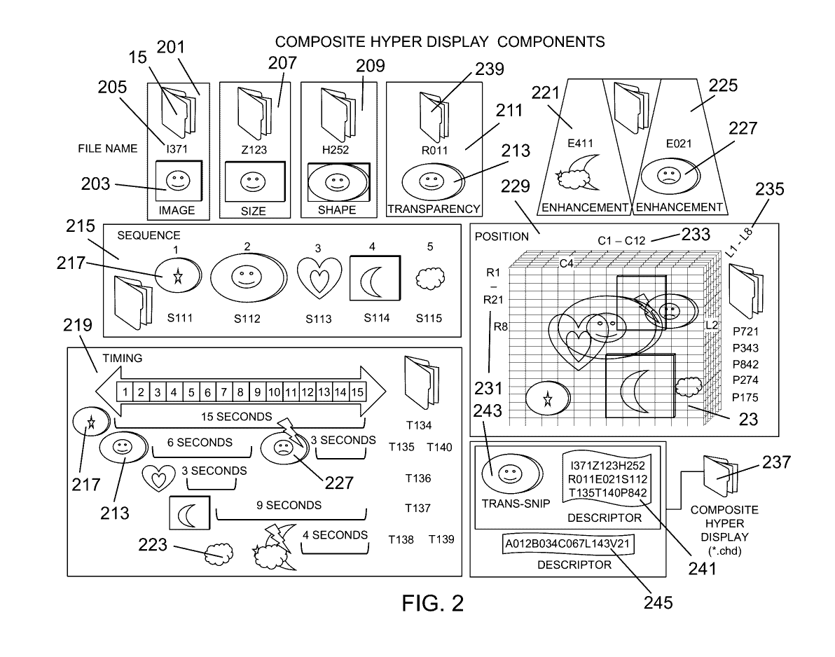

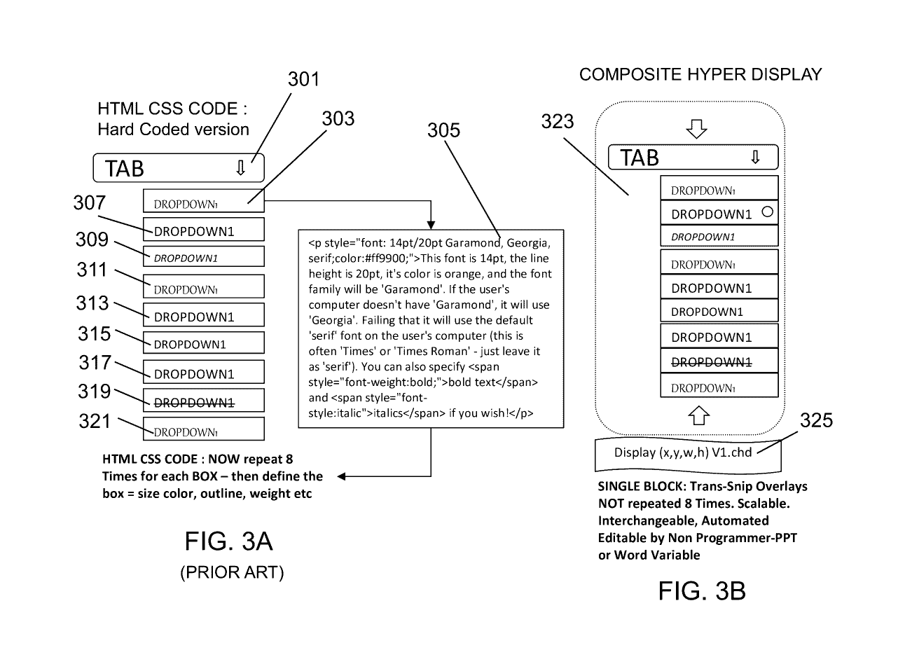

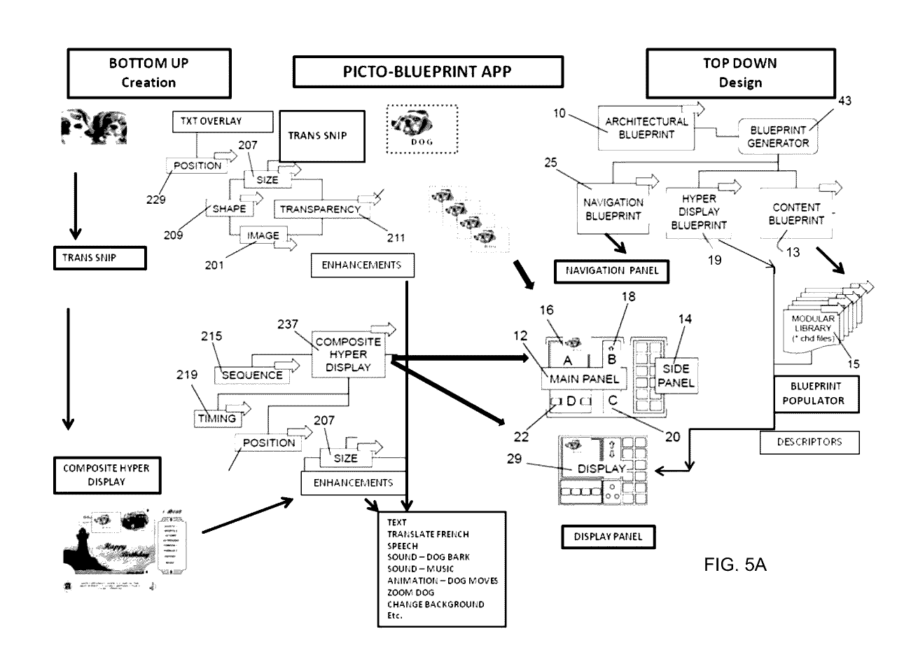

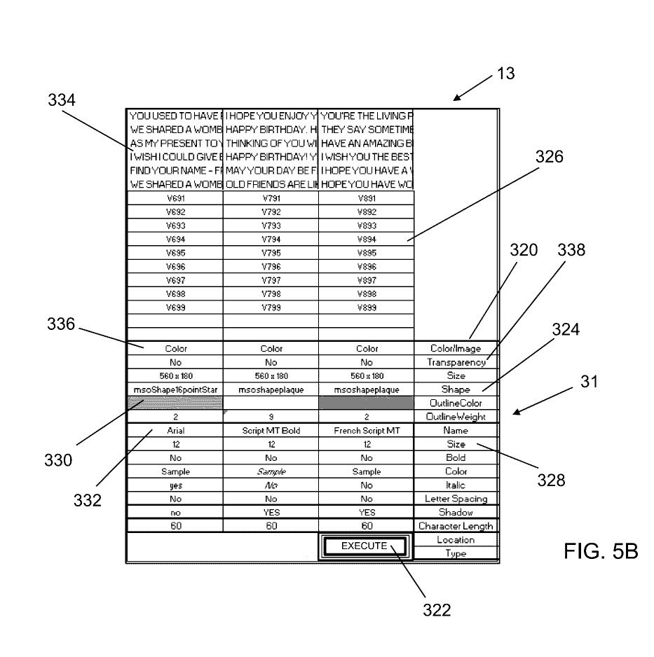

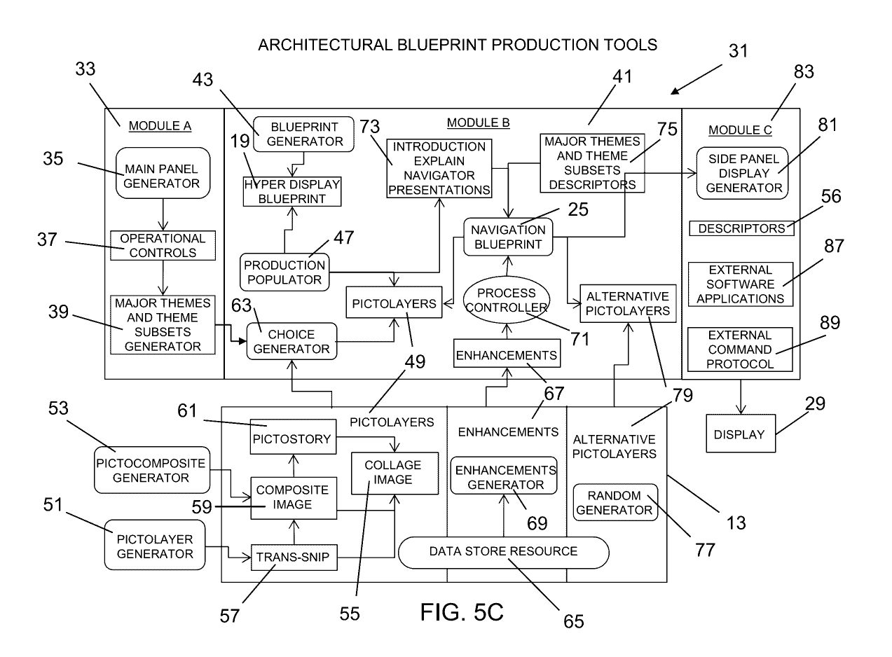

As shown in FIGS. 1-3, the Architectural Blueprint 10, in a format very different from conventional web page development, does not include content in the form of text or images that is displayed using functional code such HTML and CSS, but instead, includes Descriptors within each of the component Architectural Blueprints to define and create many types of software applications. The Architectural Blueprints are specified and generated by a Blueprint Generator 43 (FIG. 1) within the software application development system. The operational control, function and display of the Composite Hyper Displays 237 (FIG. 2) are defined by the Navigational Blueprint 25 (FIG. 1). The Navigational Blueprint 25 using Navigational Descriptors 27 provides for the creation by the developer of the general geometry and structure and the layout of the operational controls of a software application. The layout may provide for the Access Navigation System of a Core Application and one or more Dependent Applications to be defined to provide access to all Dependent Applications from within the layout and for components within the Display 29 to be defined as display or functional quadrants or segments within the Display 29. The general geometry and layout may be created using pre-defined templates that provide for some modification by the developer as desired. The Hyper Display Blueprint 19 using Hyper Display Descriptors 21 defines a locational relationship of the Composite Hyper Displays 237 (FIG. 2) content within the Matrix 23 of limitless points within the Architectural Blueprint 10. Importantly, unlike the two-dimensional display environment used in the development of conventional web pages, Picto-Overlay Technology of the software application development system of the present embodiment provides for location points and other features of the Composite Hyper Displays 237 to be in multiple dimensions so that the Composite Hyper Displays 237 may be placed at a two dimensional point along a row or column and at a numeric layer that may be for example; visually above or below other content, spatially hidden or hiding other content, and/or temporally before or after other content within the Matrix 23. The Hyper Display Descriptors 21 therefore define the temporal, spatial, and sequential display of the Trans-Snips 57 (FIG. 3) and Composite Hyper Displays 59 (FIG. 5C) and their elements as components of the Composite Hyper Displays 237. The Content Blueprint 13 sets the file structure of the Modular System Libraries 15, with Content Descriptors 17 providing access reference codes to identify the file location within the Libraries 15. The file structure may be in the form of a Master Content Blueprint 13 defining content in an index type alphabetical order with one or more Dependent Application Blueprints as created by a developer providing hierarchical topic content mapping to provide for content related searching and content based application development. The Content Descriptors 17 and file names for content may be encrypted.

The development and transformation of raw content in the form of images or text to Trans-Snips 57 is performed as defined by the Architectural Blueprint 10 using the Production Tools 31 (FIG. 1). The Production Tools 31 may be in the form of functional code in Visual Basic, C++, Python, HTML, CSS, and JavaScript, and in any of their versions or other code languages in other formats to exponentially extend the content as desired and/or required. The transformation of content to Trans-Snips 57 and to Composite Hyper Displays 237 creates code within code reducing the amount of code that must be written and removing requirements to rewrite code to change content and or functionality of content within a software application. As shown in FIG. 2, the transformation begins with raw content 201 that may be in the form of an image 203, text, and/or one or more Trans-Snips 213 that have been overlaid to form a Composite Hyper Displays 59. The raw content 201 is stored in the Modular System Library 15 with a unique file name 205. Using the Production Tools 31, functional code to associate attributes with the raw content 201 is provided that in this example may size 207, shape 209, and form a transparency 211 from the raw content 201 to form a partial Trans-Snip 213. The Trans-Snip 213 may then be sequenced 215 within a display of other Trans-Snips 217 with the sequence of the Trans-Snip 213 given a unique alphanumeric file name to be stored within the Modular System Library 15. The Trans-Snip 213 may then be associated with timing 219 to provide how long the Trans-Snip 213 may be visible within the display. As shown in this example, the Trans-Snip 217 may be within the display and then by using an Enhancement 221 be overlaid with another Trans-Snip 223 fully or partially covering the Trans-Snip 217 which may trigger another Enhancement 225 to change the Trans-Snip 213 using functional code to another Trans-Snip 227 within the display. The Matrix 23 using the Hyper Display Descriptors 21 provides for the Trans-Snip 213 to be positioned 229 for display which may be defined as coordinates within rows 231 and columns 233 and also with layers 235, and size, and width to spatially, sequentially and temporally define the position and function of the Trans-Snip 213 within the Matrix. All of the attributes, the Enhancements and the location, sequence and timing are associated to the Trans-Snip 213 to form a Composite Hyper Display 237. Any desired attribute such as adding of text, color, background, and/or adding any Enhancement 225 such as audio, animation, sound and/or visual effects and other attributes may be associated with the Trans-Snip 213 to form the Composite Hyper Displays 237. Using the .chd file format 237, the raw content 201 and every attribute and Enhancement 225 is given an alphanumeric file name 205 and is then stored in the Modular System Library 15 if desired in completely separate folders and locations. For example, functional code to form a transparency 211 from the raw content 201 may be stored in a location defined by the Content Descriptors 17 so that any amount of raw content 201 may be formed as transparencies by simply identifying the location of the transparency functional code within the transparency folder 239 using a Content Descriptor 17 and storing a Descriptor 241 with the Trans-Snip 243 and or raw content 201 in the .chd file format. Any number of attributes may be defined within the Descriptor 241 and be associated with the Trans-Snip 243. The Composite Hyper Displays 237 further provide for higher level Descriptors 245 to be associated with the Trans-Snip 243 to define a particular software application the Trans-Snip may be used or to define other global parameters such as printing, and file storage location and any other instructions as defined by the Architectural Blueprint 10. The Composite Hyper Display 237 therefore associates all of the components and elements of the Trans-Snip 213 using Descriptors 241 to associate and define the content, function and placement of Trans-Snips within the Core Application and/or other Dependent Applications. By separating content from functional code, the Composite Hyper Display 237 further provides for randomization and interchangeability of content and function without the rewriting of code. Raw content may simply be replaced with other raw content, and/or a Descriptor 241 may use the same functional code to size and form a transparency, but identify other functional code to change the shape of the Trans-Snip, and/or a different Enhancement 67 (FIG. 5C) may be identified to change the function or operational controls within an Application. Optionally, different Hyper Display Descriptors 21 may spatially, sequentially and temporally present the Trans-Snips 57 in completely different ways within the Application to change the operation, function and look and feel of the software application all without rewriting any code.

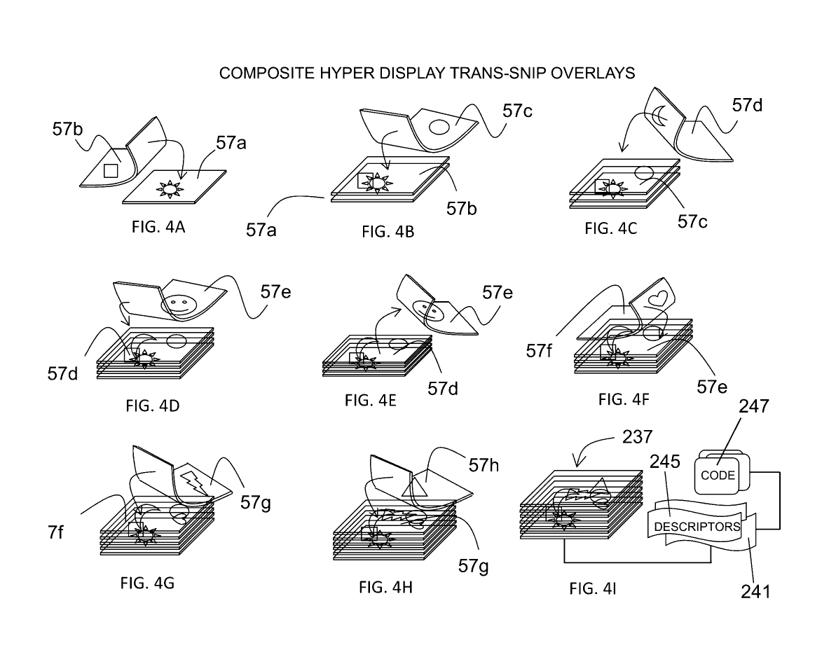

Using the software application development system methodology and Architectural Blueprint 10, the creation of software applications and web pages is unlike the development of conventional web pages that require a developer to create code for each object as an image or as text and define the attributes and functions of that object and the placement of that object within a two-dimensional display environment. The developer must then rewrite code to move or change that image or text or extensively rewrite code to have the object properly and legibly display on digital devices having different display formats and/or operating systems. Without unique scalable code written to display that object on a particular device or operating system, extensive scrolling and zooming by a user is required for the user to attempt to view and use operational controls such as a menu item. HTML text code is generally not scalable. As an example, as shown in FIG. 3A, the creation of a menu item requires extensive code and the rewriting of code to properly form and place the item within the two dimensional environment. The developer may construct a tab 301 and a series of boxes 303 with each box requiring functional code 305 to define the size, shape, color, font, function and other attributes of the box within the display, and to properly place the box in relationship to the other boxes within the display. The functional code for one box 303 must then be repeated for each other box 307-321 which in this example is eight times more code required than the same menu created within the software application development system of the present invention. As shown in FIG. 3B, using the Architectural Blueprint 10 a Composite Hyper Display 323 may associate functional code with layered scalable Trans-Snips to display the menu with all the functional controls and display attributes written once in functional code and called up by each Trans-Snip that is overlaid to form the menu. The menu Composite Hyper Display 323 may be called up using a Descriptor 325 simply as a file name V1, that may define coordinates for display within a particular Application. A diagrammatic representation of the overlaying of Trans-Snips 57 to form a Composite Hyper Displays 59 or other PictoLayers 49 is shown in FIGS. 4A to 4I with the resulting Composite Hyper Displays 59 associated with Descriptors 241 and 245 that identify the code 247 to be associated with each Trans-Snip when stored as a Composite Hyper Display 237.

In order to transform raw content to a Trans-Snip any number of Production Tools 31 may be used in various software code and languages to suitably adapt the content for one or more than one software applications. As shown in FIG. 5A, all of the components and elements of the Architectural Blueprint 10, the Navigation Blueprint 25, Hyper Display Blueprint 19 and Content Architectural Blueprint 13, the file structure of the Modular System Libraries 15, and the components and elements of the Composite Hyper Display 237 all use Descriptors 56 for instructions, for navigation, to identify file locations, and to develop the components and elements of the Composite Hyper Displays that make up all of the functional content within a Core and Dependent Application. The Descriptors 56 are further used by the Composite Hyper Displays 237 to functionally display the Trans-Snips 57 and for all other operations within a software application.

As shown in FIG. 5C, the Architectural Blueprint 10 and Descriptors 56 are also used by the Production Tools 31 to develop the components and elements of the Composite Hyper Displays 237 that may be in the form of Trans-Snips 57, Composite Hyper Displays 59 other PictoLayers 49 and Enhancements 67. In an embodiment as shown in FIG. 5B, the Production Tools 31 are implemented within each of the component blueprints to develop the components and elements of the software applications as defined within each Architectural Blueprint 10. The Production Tools 31 may comprise Software Processing Modules 320 and an Automated Executable Interface 322. As shown within the Content Blueprint 13, the Software Processing Modules 320 are functional code that may develop and associate attributes 324 such as size, shape, color, and others with raw content 326 identified using the alphanumeric file naming structure defined by the Content Blueprint 13. Each attribute 324 may have specifications 328 to define the parameters of the attribute such as a color square 330 to define an outline color to be used or font 332 to be used for text 334 that may be associated with the raw content 326. Other colors 336 of the raw content 326 may be specified as well as and importantly the forming of the raw content 326 as a transparency 338 to form at least the content portion of a Trans-Snip 57. As shown, the executable interface 322 provides rows identifying the specification and parameters 328 of each attribute 324 with the software processing modules 320 providing the functional code to perform the transformation of the raw content as specified by the desired attributes 324 and specifications 328 defined within the Production Tools 31 of the Content Blueprint 31. Once the specifications of the attributes are entered into the rows and the file names of the raw content is entered, the processing of all of the listed content is completely automated in a batch type format with each column having a separate batch of Software Processing Modules 320 on different sets of raw content as implemented within the Automated Executable Interface 322. Thousands and thousands of files of raw content 326 may be automatically processed with each batch and the specification attribute available to perform very specific transformation as required for the software application and as defined by the Architectural Blueprint 10. At the completion of the processing of each of these batches, the resulting Trans-Snips 57 may be batch processed within the Hyper Display Architectural Blueprint 19 to automatically associate each with specifications for location, sequence, timing and position to create Composite Hyper Displays 237. Further Production Tools 31 within the Navigation Blueprint 25 may process all or some of the operational and functional controls of the Composite Hyper Displays 237 to define access and navigation within a software application.

The development environment and Software Production Modules 320 of the Production Tools 31 of the present invention may be comprised of three Modules, A, B and C as shown in FIG. 5C, with various components that within the Architectural Blueprint 10 design, populate, render and present the Core Application and/or Applications. In an embodiment Module A indicated as 33, a Main Panel Generator 35, operational controls 37 and content related montage pages as defined by the Architectural Blueprint 10 for a developer to create a series of Major Themes and Theme Subsets 39 may be provided as production tools. The file structure defined by the Content Blueprint 10 and the compressed file format of the .chd file provides for thousands of topics, subjects, lessons or other content to be categorized, mapped and be accessed through montage pages or other presentation layouts within the Core Application and/or Dependent Applications.

Within Module B 41, a Blueprint Generator 43 develops the format and structure of the Matrix 23 within the Hyper Display Blueprint 19 for a specific Core Application and one or more Dependent Applications. Using a Production Populator 47, the Descriptors 56 that define the Trans-Snip content in the form of PictoLayers 49 are developed. These PictoLayers 49 have been created using the PictoLayer Generator 51 and the PictoComposite Generator 53. The PictoLayers 49 are created from Collage Images 55 that may be formed as described herein by layering multiple Trans-Snips 57 to form Composite Hyper Displays 59 that are grouped in particular themes and formats to create PictoStorys 61 or in any combination of Trans-Snips 57, Composite Hyper Displays 59 and/or PictoStorys 61. The Choice Generator 63 uses an encrypted renaming format to store selected PictoLayers 49 in the .chd file format 237 and into Modular System Libraries 15 in a Data Store Resource 65 for use within a Core and/or Dependent Application. The storage of PictoLayers 49 is defined by the Content Descriptors 17 within the Content Blueprint 13.

The PictoLayers 49 stored as Composite Hyper Displays within the defined file structure in the Modular System Libraries 15 are defined with locations, and are defined spatially, temporally, and sequentially using the Hyper Display Blueprint 19. The operation and function of any PictoLayer 49 may be activated using Enhancements 67 created by an Enhancements Generator 69. An Enhancement 67 may be associated with a PictoLayer 49 within the Content Blueprint 13 and be stored in the Modular System Library 15 with the PictoLayer 49 or alternatively, an Enhancement 67 may be associated with the PictoLayer 49 as defined by the Navigational Descriptors 27 within the Navigational Blueprint 25 when the PictoLayer 49 is activated using a Process Controller 71 within the Core Application and/or Dependent Application. In this way a PictoLayer 49 may provide a trigger that is only activated through the selection of the PictoLayer 49 by the user, for example when a user selects an advertisement the PictoLayer 49 may be activated and provide a monetization trigger for the use to access their Picto-Cash Account.

The Navigational Generator 25 and Production Tools 31 may for a particular Application Blueprint create Introduction, Explanation and Navigation Multi-Dimensional Presentations 73 to show a user how to use or navigate through the Core Application and/or Dependent Application. Specific Major Themes and Theme Subset Descriptors 75 related to the topics, operation and function of the software application are defined within the Module B 41 of the Architectural Blueprint 10. The Major Themes and Theme Subsets Descriptors 75 are used by the Choice Generator 63 to access Trans-Snips 57, Composite Hyper Displays 59 and PictoStorys 61 that will be displayed as PictoLayers 49 within the software application. The PictoLayers 49 that may be associated with Enhancements 67 using the Enhancements Generator 69 and Process Controller 71 of the Production Tools 31 create dynamic features that may be interactive that the developer may create to use and navigate through a software application. An Application may use a Random Generator 77 that selects Alternative PictoLayers 79 to randomly replace PictoLayers 49 within the software application without writing and/or rewriting any code. The randomization may simply change the image content 201, or because of the separation of content and functional code for the attributes and Enhancements 67, any attribute or Enhancement 67 may be changed, such as a different background may be associated with the same image content 201. Any style of PictoLayer 49 may have alternatives for replacement, for example any Trans-Snip 57, Composite Hyper Displays 59 or PictoStory 61 may be replaced with an Alternative PictoLayer 79 of a similar type using the Random Generator 77.

A Core Application and/or Dependent Application is developed and constructed through the creation of Descriptors 56 within the Architectural Blueprint 10. The software application is then presented within the Display 29 within the Main Panel 12 and on larger format higher resolution screens with the Side Panel 14 that is developed using Descriptors 56 created by the Side Panel Generator 81 in Module C 83. Production Tools 31 may also provide access through the Side Panel 14 to other Applications as defined by the Navigational Blueprint 25. The Side Panel 14 (FIG. 5A) may also provide navigational access to External Software Applications 87 (FIG. 5C) to open software applications and/or web sites that have been constructed by conventional web development techniques, not using the Architectural Blueprint 10. The External Software Applications 87 are viewable and accessible within the Main Panel 12 without exiting the Core Application and/or a Dependent Application and the Hierarchical Menu controls of the Side Panel 14 are still available to the user to access features in the Core Application and/or a Dependent Application. The Side Panel 14 may further provide access to External Command Protocols 89 in order to print, email, place a telephone call, or perform other actions based on the functional capabilities of the digital device.

The Composite Hyper Displays 237 and file structure using alphanumeric identification file naming within the Content Blueprint 13 provides for localized data searching that is equivalent to the searching of a relational data base that is not dependent on accompanying hybrid code. Each content file is arranged within a database structure in the form of multiple pyramids of chapters, sub-chapters and pages to create the same effect as a selected set of conditions in a typical relational database. The montage pages of the Main Panel 12 therefore provide maximized end point capability where each selection of a chosen end point may access a montage in an array of “topic’ information by categories in the form of predetermined and ‘most likely requests’ for categories requested from the stored Composite Hyper Displays 237 within the Modular System Library 15.

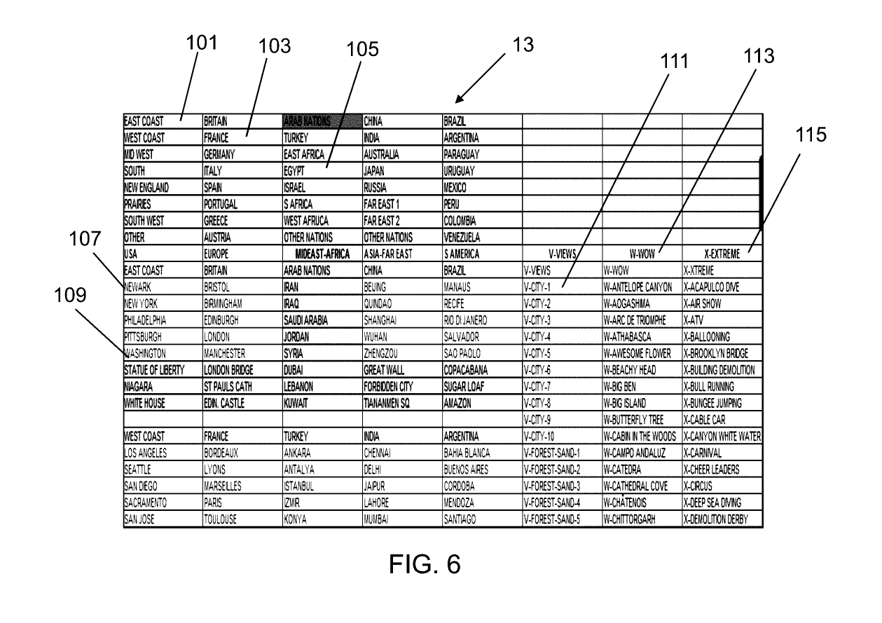

As shown in FIG. 6, in a feature of the Content Blueprint 13, a series of general to more specific categories of related topics is defined. As an example using a general category of geography, regions within continents 101 may be defined, or countries within continents 103 may be defined, or other attributes of countries that are similar 105 may be defined as Chapters within a book of the general category. Topics within those Chapters may be defined as Sub-Chapters where as an example Cities 107 within an identified region may be defined. Within the defined Sub-Chapter, Pages that may include an iconic symbol 109 may be defined such as the Statue of Liberty in New York to pictorially represent the city. Any number of Chapters, Sub-Chapters and Pages may be defined within the Content Blueprint 13 with each definition creating logical relationships that may extend to other Chapters, Sub-Chapters and Pages. A Content Blueprint 13 map may then be constructed to take content that may be stored alphabetically and map the desired content to the alphanumeric file names and descriptors defined in the Content Blueprint 13 to align content within one or more Chapters, Sub-Chapters, and/or Pages. Chapters, Sub-Chapters and Pages may be defined by the application, such as a PictoNews Application that continually requires pictorial content related to the news of the day. Other Applications may provide PictoGames and PictoPuzzles that require content to present challenges and competitions. Once a series of Chapters, Sub-Chapters and Pages are defined and mapped, content may be designated with a defined code within the Content Blueprint 13. A content label 111 within the Content Blueprint 13 may provide a developer with information to group and define related content to assist in mapping the content to a particular Master Architectural Blueprint and/or Application Blueprint Modular System Libraries. The label 111 such as City-1 may not be included within the alphanumeric text of a Descriptor 56 and may not be presented in the display of a Trans-Snip 57 or other PictoLayer 49 as Composite Hyper Displays, but may be used as a reference in the Content Blueprint 13. The Descriptor 56 in the form of text to define content may be transmitted and received without the actual transmission of content and without any of the functional code that is defined in the Descriptor 56. Because the Modular System Library 15 may be stored within a resident server on the digital device thousands and thousands of high resolution images and Trans-Snips 57 and other PictoLayer 49 are stored locally making download time instantaneous. The PictoLayers 49 within a Modular System Library 15 may be grouped and stored in any way with the Content Blueprint 13 providing the definitions of where content is located and accessible. There is therefore no requirement to store content redundantly within the file structure of the Modular System Library 15. The Content Blueprint 13 provides the map of topics in the form of Chapters, Sub-chapters, and Pages with the capability to easily identify and group content by providing labels 111 or structure within the Blueprint such as mapping interesting content jointly using a W-Code 113 to define Wow content or mapping more thrilling topics with an X-Code 115 to define Extreme content with freedom for the developer to map content in groups and sub-groups in any manner to suit a particular software application.

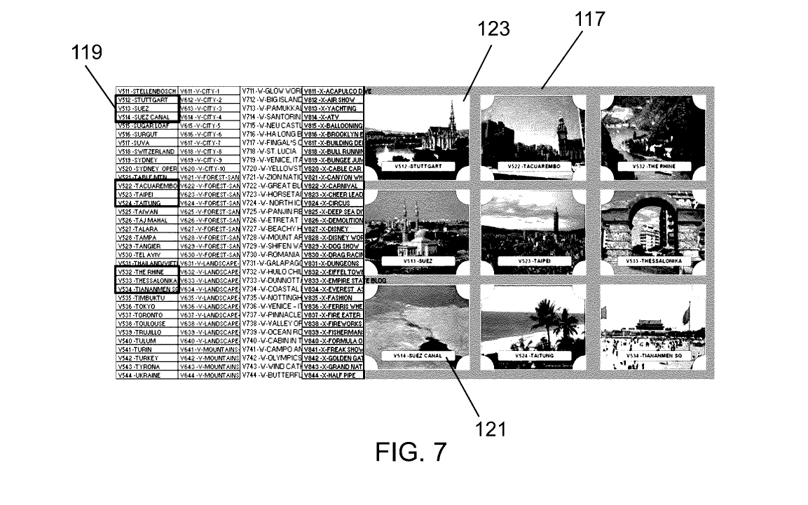

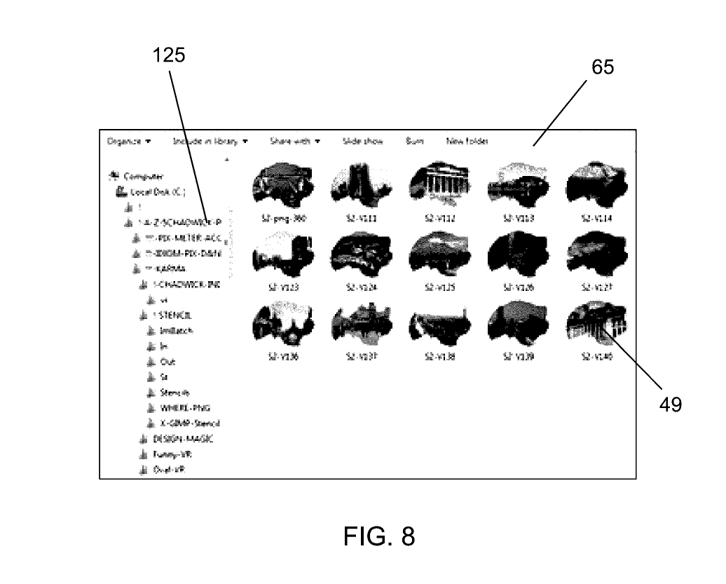

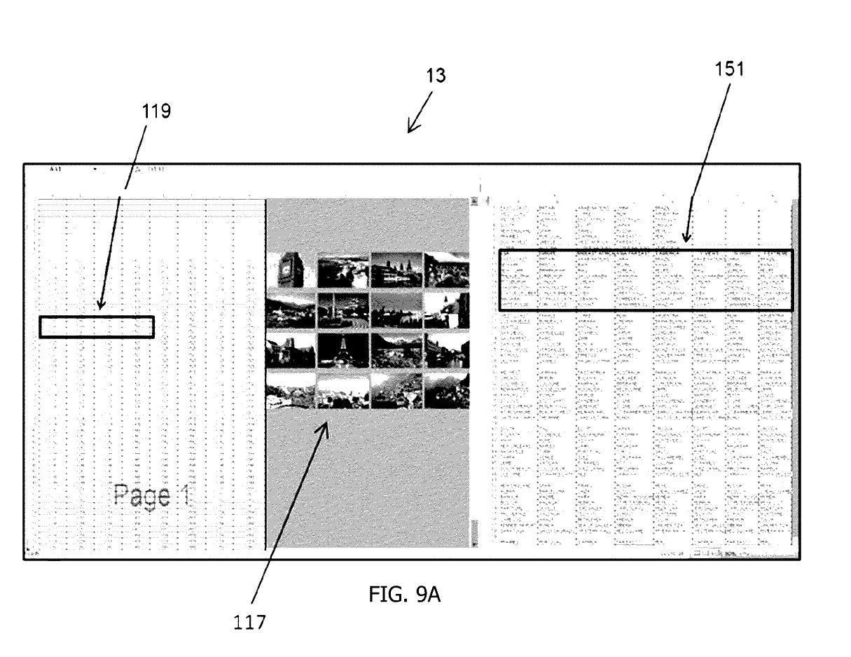

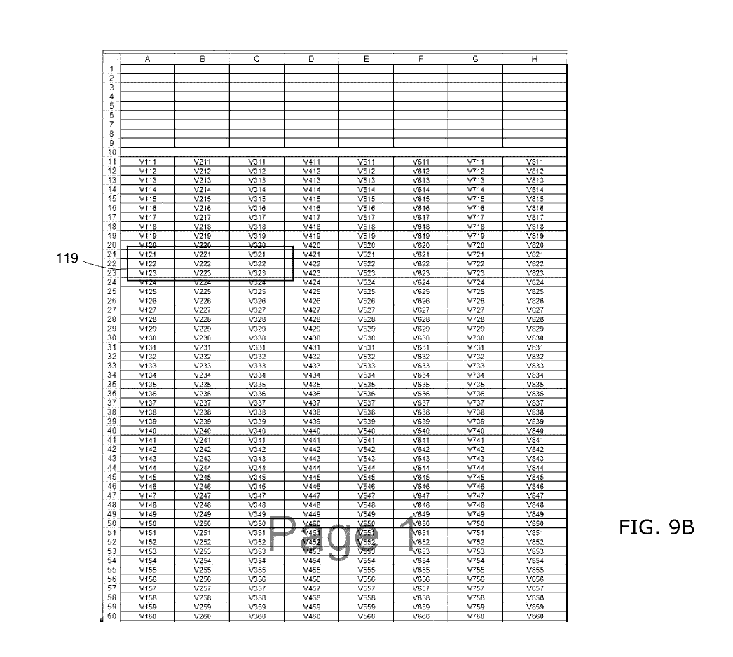

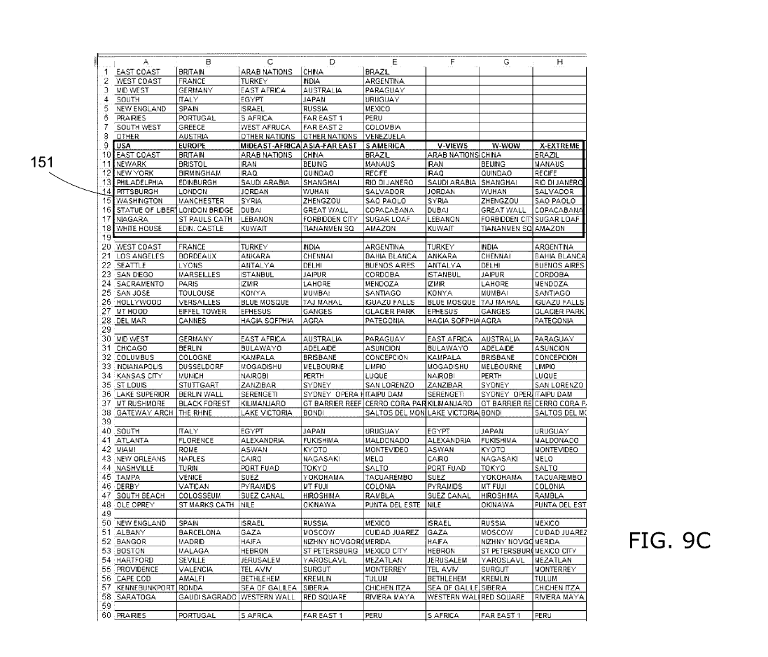

The Content Viewer 117 as shown in FIG. 7 provides for a developer to review content to choose the content for a software application using the Choice Generator 63 and/or transform the content using the PictoLayer Generator 51 and PictoComposite Generator 53 or to add Enhancements 67 to the content using the Enhancement Generator 69. A group 119 (FIGS. 9A and 9B) of PictoLayers 49 may be selected for display within the Content Viewer 117 with labels 121 to assist the developer. The content labels 111 may further identify content that may in some way be related or that has similar attributes where the content in the form of PictoLayers 49 may be similarly shaped, sized, labeled, or enhanced so that Alternative PictoLayers 79 may be selected to replace similar PictoLayers 49 within the Core and/or Dependent Application without the rewriting of code. As shown in the Content Viewer 117 the PictoLayers 49 may be framed similarly with cutouts 123. PictoLayers 49 may be shaped in any way desired by the developer using the Production Tools 31 and as shown in FIG. 8, similarly shaped PictoLayers 49 may be defined with similar content labels 111 to be stored as Composite Hyper Displays using the .chd file format 237 within the file structure 125 within the Modular System Library 15. The Descriptors 56 that identify and associate content and functional code may be encrypted to prevent identification of what content is being accessed from the Data Store Resource 65.

The Content Blueprint 13 provides for content in the form of PictoLayers 49 to be defined in any way that will assist the developer in identifying content to be used in the Core Application and/or Dependent Applications where categories may be much broader than specific chapters within a book or specific to a criteria to develop PictoStorys or other related content. As an example in FIGS. 9A and 9C, any content related to sports within the Content Blueprint 13 may be identified at a topic level as sports and be grouped with simply the label sport 151, and be accessed using that definition. If desired the content within the Content Blueprint 13 may be further labeled by the team, the athlete, the game or other identifying information. In this way the sports content label 151 may be accessed to be used in PictoGames or other software applications related to any sport, or related to specific sports or athletes. Once the structure and grouping of topics, Chapters, Sub-chapters, Pages for an Application are defined in the Content Blueprint 13, content mapping provides for the Content Descriptors 17 to be created to be used by the Composite Hyper Displays 237 to access and functionally display content.

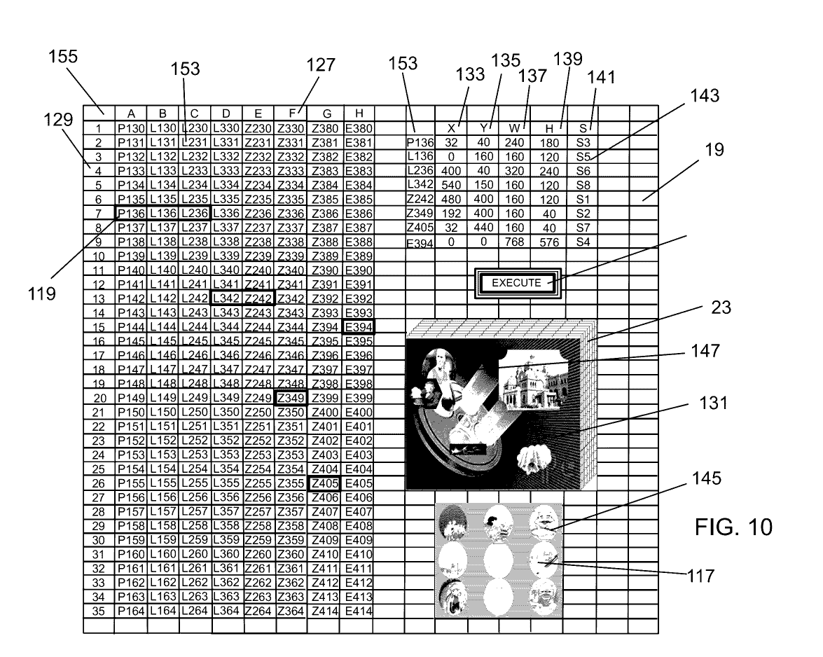

The Hyper Display Blueprint 19 as shown in FIG. 10, provides for a developer to define the location points, layers, background and overlay and to set the spatial, temporal, and sequential attributes of the Composite Hyper Displays 237 within a Core and/or Dependent Application. The location points 153 are used to review and locate content where selected PictoLayers 49 may be viewed within the Content Viewer 117 to assist the developer in the selection and placement of the Composite Hyper Displays 237 presented as PictoLayers 49. The location points 153 may be arranged in a grid type format with columns 127 indicated with letters and rows 129 indicated with numbers where different columns and/or rows may be indicated as layers for priority, spatial, temporal and/or sequential location points. The selected Composite Hyper Displays 237 may be presented within a Matrix 23 viewer 131 to assist the software developer in aligning and arranging these location points 153. Alerts may be provided for any operational button that would be too small to be functional on a small screen size digital device. From the Hyper Display Blueprint 19, the Hyper Display Descriptors 21 are created and associated with the PictoLayers 49 that are then stored using the .chd file format. The developer may simply adjust the location points 153 within the grid 155 to change the X 133, Y 135, the width W 137, the height H 139, and the layer S141 that defines of the Composite Hyper Display 237 within the display. Because the components of the Composite Hyper Displays 237 are the PictoLayers 49 and Trans-Snips 57 and are therefore transparent, sized and shaped a PictoLayer 49 from a lower layer may still be seen. Alternatively, a lower level Trans-Snip 57 may be hidden until activated or relocated within the Matrix 23 of the Architectural Blueprint 10. The Content Viewer 117 may also provide for the review of Alternative PictoLayers 79 that may be interchanged with a PictoLayer 49 within the Matrix 23, for example a Composite Hyper Display 237 as an Alternative PictoLayer 145 may be replaced with a similarly shaped and sized PictoLayer 147 within the Hyper Display Blueprint 19 in order to fit and align properly with other selected PictoLayers 49.

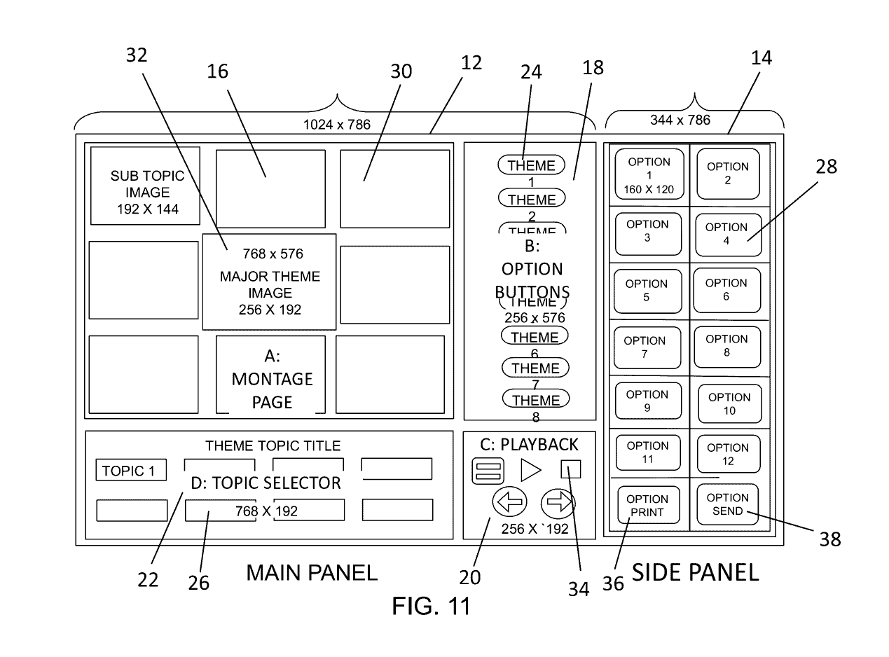

In an embodiment, a Core Application may be displayed as Access Navigation System having a Main Panel 12 that shows the current application that is being accessed by a user and a Side Panel 14 that provides for a user to access other Applications, or external web sites. This unique feature of the construct provided by the Architectural Blueprint 10 and resident server of the software applications of the present invention provides continual access to all of the Must Have applications creating an impulse driven system with the most often used or the using the rating system the most popular applications. The Main Panel 12, as shown in FIG. 11, has a standard aspect ratio that currently is 4:3 and the Side Panel 14 that when combined provides a high definition aspect ratio currently 16:9. Within the Main Panel 12 there are ‘quadrants’ or a variable number of segments designated in FIG. 11 as A 16, B 18, C 20, and D 22. As quadrants there are four in number and not equally sized in dimension. Segments may be of equal dimension or similarly of non-equal dimensions. In the Architectural Blueprint 10 with a Main Panel 12 and a Side Panel 14, the Side Panel 14 activates Applications using Global Navigational Buttons 28 and other applications to display any selected application within the display of the Main Panel 12. The display of each application conforms to a predetermined maximum screen display of the digital device and in a predefined aspect ratio. The Architectural Blueprint 10 of the present invention further defines Modular Quadrant Zoom Technology (MQZT) that provides for any quadrant within the Main Panel 12 to be either a Display Quadrant or a Navigation-Functional Quadrant. Display quadrants and their component Composite Hyper Displays 237 are constructed to be expandable in size to either a predefined maximum Main Panel screen display size or any subset having the same aspect ratio as defined by the Architectural Blueprint 10. This consistency of a predefined aspect ratio and Quadrant Zoomability removes any requirement to scroll up or down through a Panel to view or amplify the contents or to zoom in to access any control buttons or other functional features within the display. As shown in FIG. 11, the Main Panel 12 in a first embodiment is defined by the four quadrants with each quadrant predefined as a functional or navigational quadrant where Quadrant A 16 is a display quadrant; Quadrant B 18 is a navigational quadrant that changes the content of the display in Quadrant A 16; Quadrant D 22 provides functional choices to effect the content of the display in Quadrant A 16; and Quadrant C 20 provides universal functionality such as copying or printing the content of the display in Quadrant A 16. Quadrant A 16 (a zoomable display quadrant) prints if desired as a full single page based on the aspect ratio of the Main Panel 12 and preferably in a landscape format.

The Architectural Blueprint 10, may provide predefined frames for navigation buttons 24 as shown within Quadrant B 18 and/or for functional buttons 26 as shown in Quadrant D 22. The navigational and functional buttons and position within the Quadrant may be of any shape and layout based on the Composite Hyper Displays 237 and their components of overlaid Trans-Snips 57 to form the PictoLayers 49 that form the buttons. In further embodiments, the shape and layout of the Navigational Buttons 24 and Functional Buttons 26 may be defined by a Trans-Snip mask overlay as a layer formed from one or more Trans-Snips that as described herein, provide a consistent layout for a user within the Core Application or a Dependent Application to use and navigate through. Any content within the display may be changed even the function and navigational access points of the buttons, without the rewriting of any code, by simply selecting a differently shaped Trans-Snip mask and layering it within the software application. The MQZT function of sizing a display to be full screen within the Main Panel 12, does not however change, even if any content, operation, or function such as the look and feel of the display changes. Importantly, as Trans-Snips 57 are layered to form the Main Panel 12 and Side Panel 14, the buttons and content of the display, an upper layer as defined by the Navigational Blueprint 25 using the Navigational Descriptors 27 has the priority in activation over Trans-Snips 57 that are layered underneath, therefore if an Application or other application is selected or activated from the Global Navigational Buttons 28 selected from within Side Panel 14, the priority of the upper Trans-Snip layer in the Main Panel 12 is changed to a lower priority and the actions performed by the Navigational Buttons 24 and Functional Buttons 26 are changed for the new application. The Navigational Buttons 24 and Functional Buttons 26 for the new Application are accessible within the B, C, and D Quadrants to use the new application that may have a similar layout or a completely different layout as defined by the Application Architectural Blueprint.

As shown in FIG. 11, the Main Panel 12 has a preset default resolution setting of 1024×768 pixels, the current web standard, and the Side Control Panel 14 has a resolution of 344×768 pixels and the two panels when combined have a High Definition Resolution of 1368×768 pixels. The Main Panel 12 may therefore be displayed as Full Screen on a High Definition monitor. The PictoOverlay Interface 40 may also be displayed Full Screen on a standard Resolution Monitor at 1024×768 by removing the Side Panel 14 from the display and only displaying the Main Panel 12.

The Quadrants that make up the Access Navigation System are each sized so that when all of the Quadrants are aligned together the display is at the preset web standard resolution and default aspect ratio or at the resolution and aspect ratio of the “Lead Page” of the digital device. At the default web standard resolution, Quadrant A 16 is at a resolution of 768×576 pixels, Quadrant B 18 is at a resolution of 256×576 pixels, Quadrant C 20 is at a resolution of 256×192 pixels, and Quadrant D 22 is at a resolution of 768×192 pixels. However, each Quadrant as a Composite Hyper Displays 237 made up of Trans-Snips is modular and scalable to the resolution and aspect ratio of the default device. In this way images are never distorted or cut off and because there is no scrolling or zooming within the display, the display is always shown as Full Screen. Quadrant A 16 is the Montage Page that displays Composite Hyper Displays 237 in a 3×3×3 format with eight surrounding theme images 30 and the current image display 32 in a larger format in the center. Quadrant B 18 provides navigational image option buttons 24 that change the content in the Montage Page of Quadrant A 16. Quadrant C 20 provides playback and recording controls 34 or other operational controls and Quadrant D 22 may provide functional interactive controls to use in a software application. The Side Panel 12 may have any number of Global Navigational Buttons 28 and/or other controls as needed for the Core Application features such as Print Option Controls 36 and Email Option Controls 38. Selecting the Print Option 38 would print the entire display within the Main Panel 12 as full screen in landscape mode.

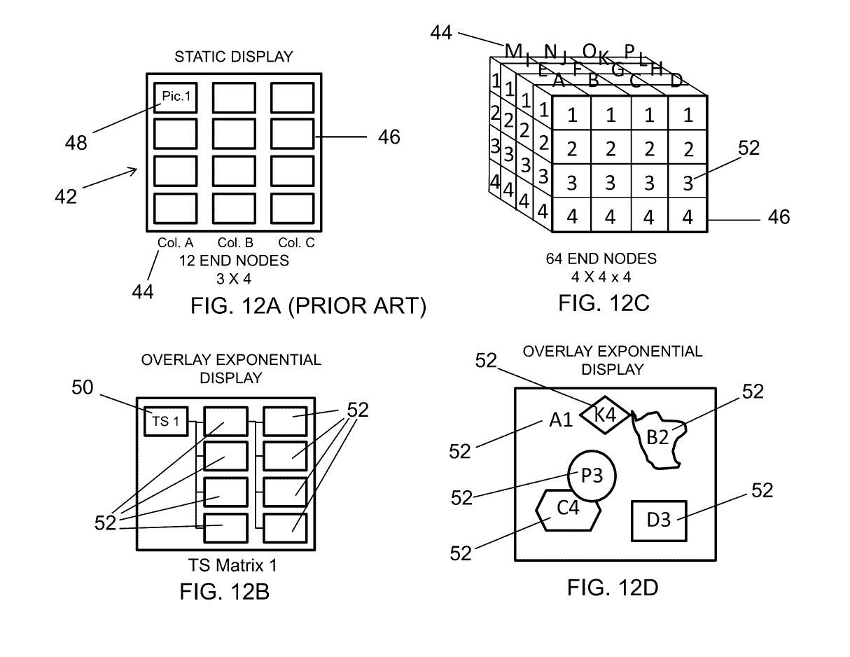

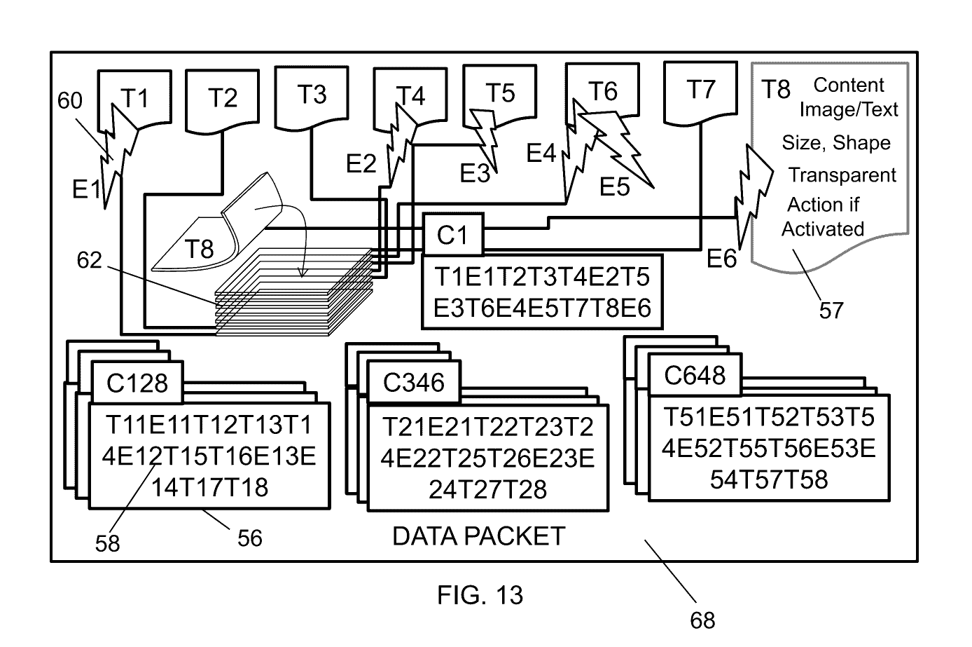

As shown in FIG. 12A, in the development of current conventional web pages, the display of image content is limited to a preset position within a static display 42. In this example, by constructing the static display 42 with three columns 44, A, B and C and 4 rows 46 there would be a total of twelve end nodes of content indicated as 48 that may be displayed. Using overlay technology, the display of material content is exponentially higher where a Trans-Snip TS1 indicated as 50 in FIG. 12B is located within the Matrix 23 of the Architectural Blueprint 10 that provides for any number of end nodes to be displayed within a single location. In this example, eight optional end nodes indicated as 52 have been structured within the Architectural Blueprint 10. Any location in the Architectural Blueprint 10 may display any number of end nodes 52 where within any one location multiple images are layered and accessible using the Descriptors 21 defined by the Hyper Display Blueprint 19. In a first embodiment, the Main Panel 12 as defined by the Matrix 23 may have 4 columns 44 and 4 rows 46. Each location may have 4 available images 52, text or other content that may be available to be overlaid creating a Matrix 23 of 4×4×4 that results in 64 end nodes 52 available for display, as shown in FIG. 12C. The end nodes may be structured within the Hyper Display Blueprint 19 as a series of sixteen columns labelled as A-P with each column 44 having four rows 46 of Trans-Snips numbered 1 4. The number of end nodes 52 may be set by the available real estate within a small format screen display with the maximum real estate as defined by the architectural Blueprint maximizes the components and elements of content and command interfaces with all components and elements being visibly distinguishable and distinct to be operational so that a user may touch and operate a single control. Using Content Descriptors 17 to identify the Composite Hyper Displays 237 stored within the Modular System Library 15 that include Descriptors 21 defined by the Hyper Display Blueprint 19 any amount of Composite Hyper Displays 237 within the limitless Matrix 23 may be defined. The Composite Hyper Displays 237 are displayed and functional through the association of the PictoLayers 49 with functional code using the Descriptors 56 with the PictoLayers 49 only being activated when defined by Architectural Blueprint 10 of a particular Application as shown diagrammatically in FIG. 12D. As shown in FIG. 12D, Overlay Exponential Display is explained as follows: infinite exponential overlay variations with variable descriptors derived from the matrices of trans-snip information. In its simplest form, an end node may be an unprocessed raw image in the multiple matrices assigned to the blueprint. The matrices may consist solely of image libraries to define a composite hyper display as a specific image from a specific matrix library. However, the layers of matrices, 12C, aside from image libraries, may include cross references for all the variable of a trans-snip: shape, size, location, sequence, priority. Consequently, a composite hyper display consisting of 5 images from 5 libraries, FIG. 12D, has infinite display variations if variable descriptors change the shape, size and location of each trans-snip, even if the images themselves remained the same. In an extreme, image D3 52 may be assigned a size (0, 0) in which case it would disappear. As a further example, in a picture identity system, a multiple of shaped trans-snips with infinitely variable descriptors could replace the swirls of a fingerprint. As such, a composite hyper display, FIG. 12D, becomes a new infinitely variable “ID”. Additionally, in the BluePrint Matrix descriptor system, in one embodiment, in order to achieve variations in display content or function, descriptor names and filenames are set by the blueprint and not changed, but the “inside” content of such descriptors and filenames are replaced and the descriptor-filename overwritten to change the display content or function. Within each Data Packet 68 as shown in FIG. 13, there may be at a minimum 648 available native content files for display and activation as Composite Hyper Displays 237 with the components and elements of Trans-Snips 57 and PictoLayers 49 within the Core and/or Dependent Applications. Thereby providing vibrant multi-functional enhanced displays within the Access Navigation System that uses minimal bandwidth to transfer and download on a mobile device or other digital device and that provides a dramatic change to the equation of bandwidth and use of real estate within the mobile small file format display.

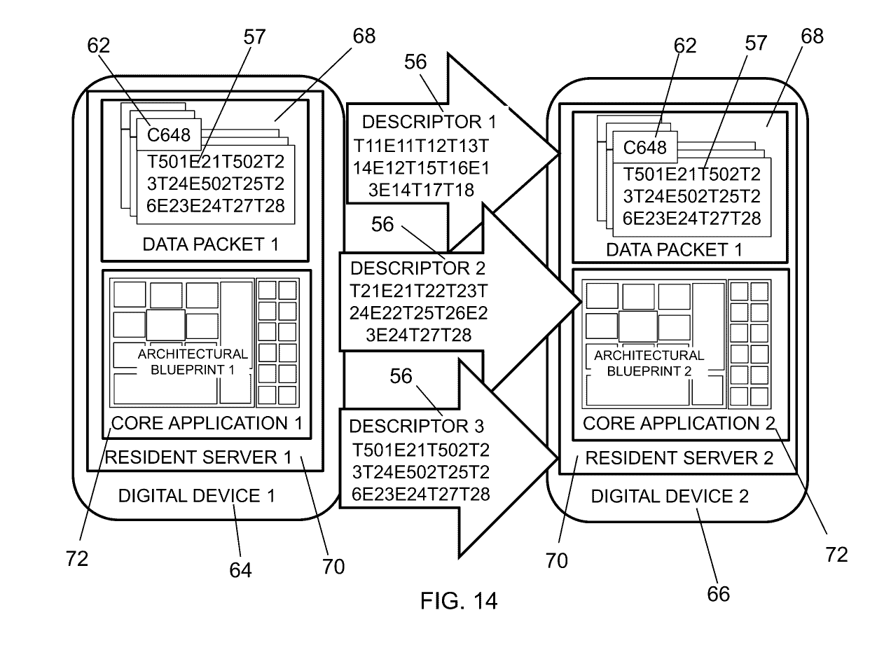

The Composite Hyper Displays 237 in the form of Trans-Snips 57 represented as T1-T8 as shown in FIG. 13 and/or combinations thereof in the .chd (chad) file format include the content, location and functional Descriptors 56, and thereby an infinite variety, defined in the Content Blueprint 13, in the Hyper Display Blueprint 19 and in the Navigational Blueprint 25 that provide the capability to store code within code using a series of text instructions 58 that associate geographic location, text, size, shape, transparency, image content, audio content, video content, dynamic movement, sequence and other Enhancements E1-E6 indicated as 60 with native raw content. A Composite Image C1 indicated as 62 is constructed from layering the Trans-Snips 57. The Descriptor 56 is written using alphanumeric references that as described herein are developed and activated within the display as defined by the Architectural Blueprints 10 and that identify the trans-snip composition including descriptor features such as transparency, size, shape, location etc., which may be randomly determined, and the location of a specific Composite Hyper Displays 237 or multiple Composite Hyper Displays 237 within the Modular System Library 15 file structure. The Descriptor 56 as an alphanumeric instructional set of reference codes is easily transferred from a first digital device 64 to a second digital device 66 with minimal delay where native content files within a Content Data Packet 68 are already available within a downloaded mirrored pre-loaded local resident or web based server 70 that has a similarly structured Modular System Library 15 and file structure 125, as shown in FIG. 14. The mirrored Content Data Packet 68 on the second digital device 66 may have identical native content files or include alternative files that may be used to update content within one or more software applications. All parts of the display within any Quadrant of the Main Panel 12 and Side Panel 14 for the Core and/or Dependent Applications are comprised of Composite Hyper Displays 237 that present the content and that may be activated to be functional within the application as dynamic enhanced Multi-Dimensional Presentations, PictoGames, and Must have software applications and other software applications implemented on the second digital device 66. Importantly, because of the small file format and the transmission of only text, an entire Core Application and one or many Dependent Application Descriptors 56 can be transmitted in a single Data Packet 68 providing for multiple Applications to be downloaded and installed all at once and be operational with minimal delay.

The Architectural Blueprint 10 of the second digital device 66 provides the structure of the Matrix 23 format that is specific to a particular Core Application and/or Dependent Application with the sets of Content Descriptors 17, Hyper Display Descriptors 21 and Navigational Descriptors 27 defining how the Core Application and Dependent Applications are presented. The Composite Hyper Displays 237 within the resident server of the second digital device include all of the components and elements as defined by the Descriptors 56 to associate the content, functional code and Enhancements 67 to activate and functionally display the Composite Hyper Displays 237 as Trans-Snips 57 within a software application. The Descriptors 56 as alphanumeric reference codes are transmitted as text within .chd files to relay geometry and instructions for an Architectural Blueprint 10 on the second digital device 66 to translate and present a Core Application and/or one or more Dependent Applications. The Descriptors 56 are sent without the native content itself. In this manner, a Data Packet 68 that includes all the native content for an application or for multiple software applications is downloaded to a resident server 70, and displayed within an application without the delay of downloading each piece of data in limited amounts as is commonly done. The Descriptors 56 as text files provide the extraction, activation and rendering of any Trans-Snip 57 from a chad file within the display, with control and location of the Descriptors 56 being set through the Architectural Blueprint 10. The Architectural Blueprint 10 is therefore dependent on the presence of native content from a Data Packet 68 that may be loaded as locally resident and/or as mirror resident on a server of another device. The Architectural Blueprint 10 activates the extraction of the native content from the resident server 70 as Composite Hyper Displays 237 and functionally displays the PictoLayers 49 and activates the Enhancements 67 that may be triggered to play audio, narration, animation, video, video effects, sound effects, slide shows, image components, or any variation of Enhancement within an application.

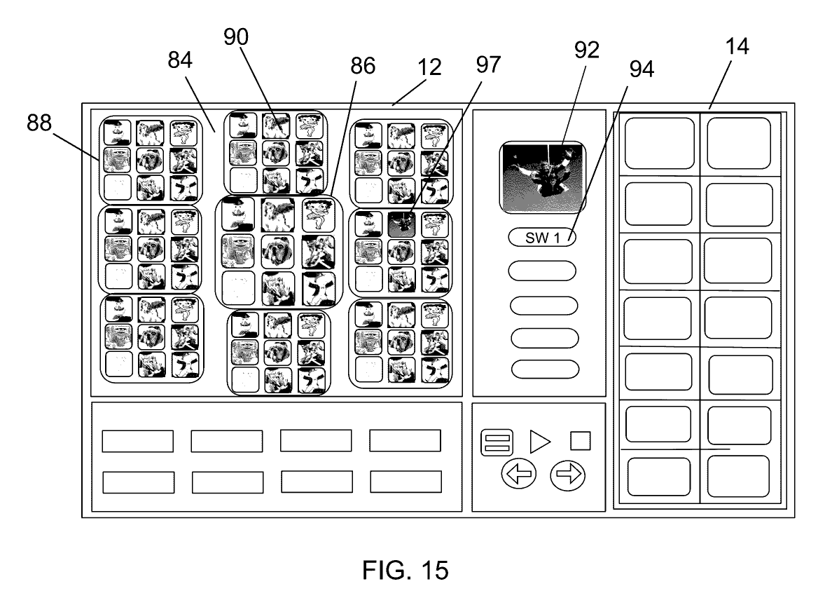

Because a Core Application and/or any Application may be transferred and activated through Descriptors 56 using only the alphanumeric reference codes, the native content stored as Composite Hyper Displays 237 may be locally resident, and therefore multiple high quality images may be clearly displayed within a single frame in a small portion of a Montage Page 84 within the Main Panel 12, as shown in FIG. 15 where nine Trans-Snips 57 are displayed in the center frame 86 and in eight outer 88 frames located around the center frame 86. Each Trans-Snip 57 is displayed based on the Descriptors 56 as defined in the Architectural Blueprint 10. Therefore any selected or activated Trans-Snip 57 within the display is defined by a Content Descriptor 17, a Hyper Display Descriptor 21 and a Navigational Descriptor 27 which provides for any Trans-Snip 57 or PictoLayer 49 within the display to be swapped or modified by changing any one or all of these Descriptors 17, 21 and 27 and or the content itself. A selected Trans-Snip indicated as 90 may be swapped with an Alternative Trans-Snip indicated as 92 in one or all of the frames by selecting for example a switch control 94 within Quadrant B 18. The switch control 94 provides an instruction as a Descriptor 56 to change, for example, the Content Descriptor 17 within the Matrix 23 of the Architectural Blueprint 10 causing the Alternative Trans-Snip 92 to be shown in one frame indicated as 97 or alternatively in all the frames dependent upon the instructions given to change the display in the Main Panel 12. The alternative image content may be available within an alternative Content Data Packet that is stored within the mirrored resident server so that similar Composite Hyper Displays 237 having Trans-Snips 57 and other PictoLayers 49 that have been shaped, sized, labeled and otherwise transformed and associated with functional code may be stored within an identical file structure to have the alternative content be suitable for display. Upon selection of an alternative image, the alternative content may be automatically moved into the resident server 70 from the mirrored alternative file structure to the active Architectural Blueprint 10 for display and/or activation using one or more Enhancements 67. In this example the underlying Descriptors 56 as alphanumeric instructions for the application are not changed, but the alternative content is associated with the proper alphanumeric instruction and is integrated with, displayed and activated within the Core Application and/or other Applications. The Main Panel 12 and the applications accessed from the Side Panel 14 may use alternative content that conforms to the structure of the Architectural Blueprint 10 as defined the predefined alphanumeric instructions of the Descriptors 56. The Descriptors 56 as .chd files may further provide activation of external internet connections to access web pages that may then be integrated within the Core Application and/or Dependent Applications.

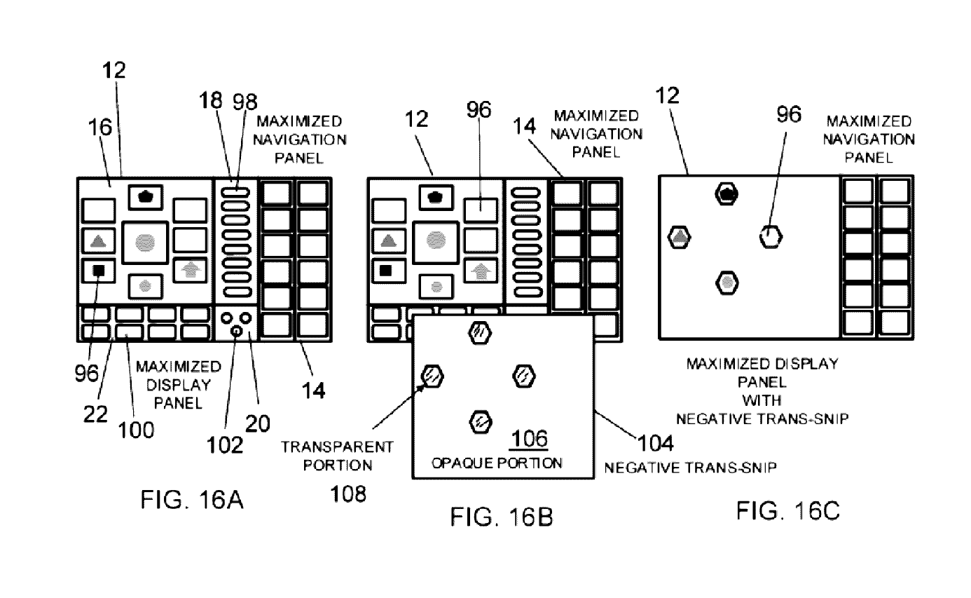

The Architectural Blueprint 10 may further define one or more Composite Hyper Displays 237 having Trans-Snips 57 as layers that include one or more transparent cutouts or stencil shapes. As shown in FIG. 16A, the Main Panel 12 in Quadrant A 16 may show a series of images 96 that may be accessed or changed using control buttons 98 within Quadrant B 18, functional controls 100 within Quadrant D 22 or make global changes using option buttons 102 within Quadrant C 20. The image content 96 may then be overlaid with a negative, inverse or reverse Trans-Snip 104 where the majority of the Trans-Snip has an opaque portion 106 that covers the lower layers of Trans-Snips and cutouts of transparent areas 108 are formed in any desired shape as shown in FIG. 16B. The negative, inverse or reverse Trans-Snip 104 is placed over the maximized display within all or a portion of the Main Panel 12 and only images 96 within the cutout areas show through, as shown in FIG. 16C. Any number of negative Trans-Snips 104 may be formed and layered one over the other to change the content, functionality and look and feel of a software application providing immediate changes within the Access Navigation System as required.

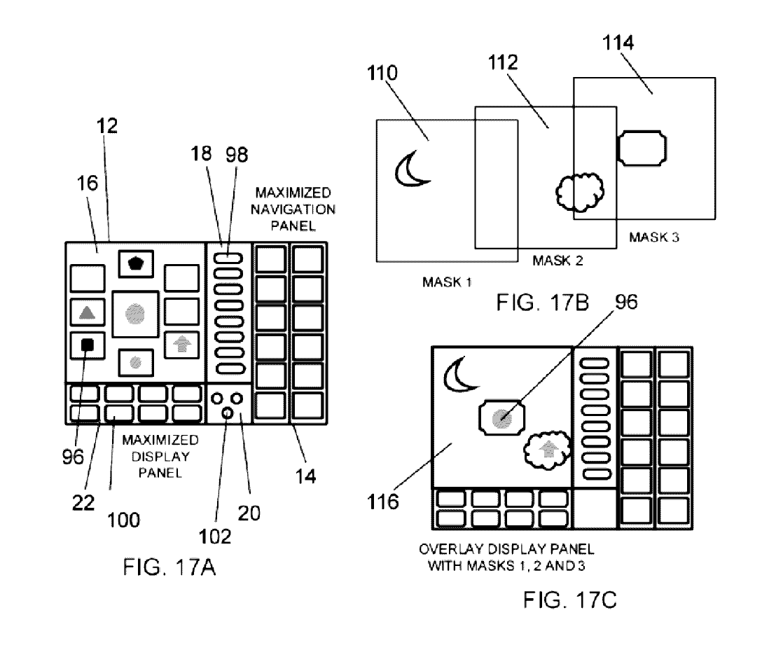

The maximized display within the Main Panel 12, as shown in FIG. 17A, is overlaid with the Mask 1 indicated as 110, Mask 2 indicated as 112 and Mask 3 indicated as 114 of Negative Trans-Snips 104 shown in FIG. 17B that are overlaid to display particular portions of image content 96 within the display 116 as shown in FIG. 17C. In this way, the display may be completely changed without modifying the image content 96 at all. A Negative Trans-Snip 104 may further be compressed to a smaller size and use less bandwidth for transmission than a modified image file such as a .png or .jpg that is cut to a particular shape to use within a display. The image content 96 is defined by a Hyper Display Descriptor 21 at a lower level to provide for viewing through the stencil of the Negative Trans-Snip 104 so that a square image as is the common format of stored image files as shown with four varied styles of stencil shapes indicated as 120, 122, 124 and 126 to provide any desired shape, as shown in FIG. 17C. Vibrant, detailed images are instantly displayed on any size of digital device screen from a small cellular phone screen to a large high definition screen and every available size and type of screen in between with complete clarity. All content may further be displayed as a full screen and be printed as a full screen removing any requirement to scroll in order to view the content in its entirety or to enlarge or shrink an image to have it properly print on a standard size sheet of paper in a landscape orientation. Any content selection is available to display full screen as desired because every frame or display quadrant conforms to the maximum screen aspect ratio of the digital device such that its zoom capability may fill the Main Panel 12, based on maximum real estate visibility within the Page Driven Main Panel display. The same zoom capability is true of any frame, control button or the entire Side Panel 14. Further minimization of content is defined by the Architectural Blueprint through the selection of content based on the screen size format of the digital device. Because content within the Modular System Library is interchangeable, a low resolution, smaller image file may be selected for display on a small screen size mobile device while a high resolution image file may be selected to display on a high definition device. Simply by providing alternative Modular System Libraries 15 with one having low resolution content and one having high resolution content the most appropriate library can be selected for download to be included within a data packet 68. All content and operational features are identical but the lower resolution images are defined through a resolution selection feature in the software application development system that provides the use of less bandwidth for transmission and minimizes the amount of space used by a resident server on a small screen format digital device by selecting the lower resolution content library.

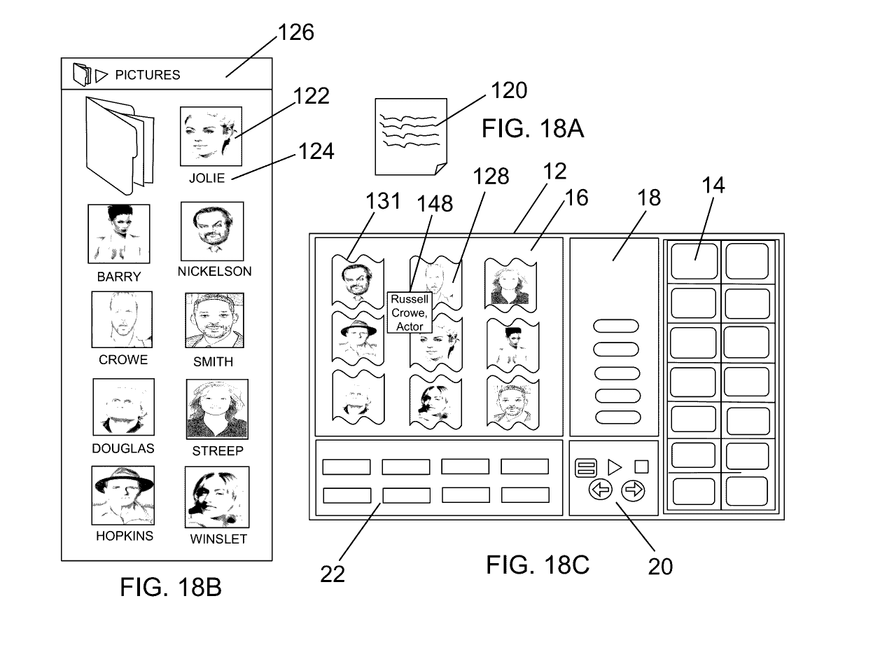

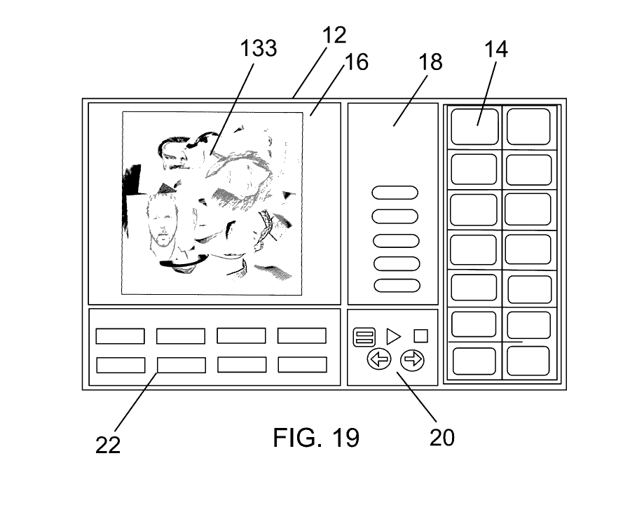

The production tools used to process and transform raw content into Trans-Snips 57, the tools used for the creation of Composite Hyper Displays 237, the production tools used to identify, rename and label content files as defined by the Content Blueprint 131 and many of development processes using the Picto-Blueprint software application development system may be automated and may be performed using batch processing as described herein providing for the transformation of raw content to useful functionally displayable content for a software application may be completed by processing thousands of data files at one time. Stored raw image content located within the Modular System Library 15 may be sized, shaped, formed as transparencies, located and enhanced for display based on the Descriptors 56 as defined by the Master or Application Architectural Blueprint 10. The batch processing may also be completely exclusive to the addition of a single attribute to a number of content files, or to multiple processes formed within one batch process, so that the steps of sizing, shaping, forming a transparency and adding text could all be competed in one batch process. As an example, a document 120 as shown in FIG. 18A may provide a list of names, addresses, job descriptions, and other information about a group of people. The list may have a preset order, such as be in alphabetical order listing each person by last name. With the document 120 a set of photos 122 of all of the people with the pictures as raw content saved with file names 124 of each person's name to sort them in alphabetical order when saved within the file folder 126, as shown in FIG. 18B. The pictures may alternative be saved with numbers or alphanumeric names that can be sorted. As an example, from the instructions in the form of Descriptors 56 from the Architectural Blueprint 10, the production tools automatically transform the raw content pictures 122 by sizing, shaping, and forming transparencies and associating enhancements to create Trans-Snips 128 that are located, sequenced, with timing gaps as defined by the Hyper Display Blueprint 19 to form Composite Hyper Displays 237. The shaping may place the pictures in any style frame 131 and the Hyper Display Descriptors 21 place the Composite Hyper Displays 237 within a Content Viewer 117 so that the Composite Hyper Displays 237 can be previewed before rendering the Composite Hyper Displays 237 within Quadrant A 30 of the Main Panel 12 display as shown in FIG. 18C. With the raw content 122 mapped to the matching list from the document and using automated batch processing as defined by the Architectural Blueprint 10, the raw content is automatically transformed and Composite Hyper Displays functionally display the Trans-Snips 57 of each person properly positioned within the display. By associating an enhancement with a Trans-Snip 57, a user can select any image and have a text box 148 such as the name and job description opened within the display. The automation provides for thousands of files of raw content to be transformed to Trans-Snips 57 and Composite Hyper Displays 237 all at once and be associated with Enhancements 67 as defined in the Descriptors 56. As shown in FIG. 19, different sets of Descriptors 56 from for example an Architectural Blueprint 10 for a PictoGame Application can define the overlaying of the Trans-Snips 57 to create Composite Hyper Displays 59 to be used as for example a PictoPuzzle 133 with the Random Generator 77 providing for content, operation and function to be randomly selected and displayed creating infinite numbers of Composite Hyper Displays 237 for a variety of software applications.

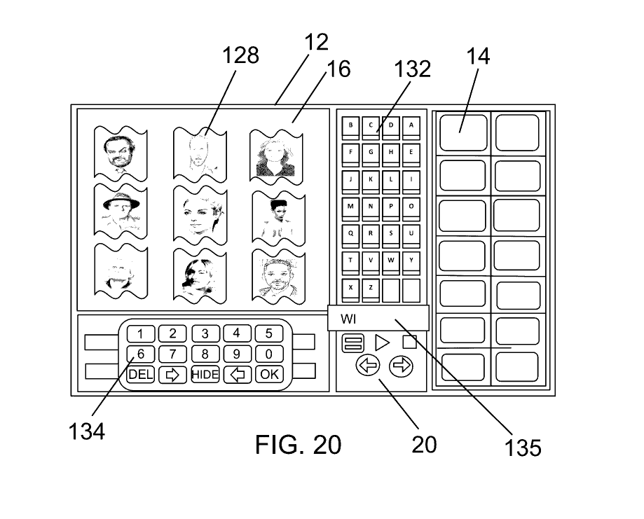

The Architectural Blueprint 10 may further provide a keyboard 130 that in one application may provide only letters, only numbers or both, as shown in FIG. 20. The alphabet keyboard 132 or numeric display 134 is constructed of Composite Hyper Displays 237 and therefore each letter or number is associated with image content, functional code, and Enhancements 67. The alphabet 132 or numeric 134 display may be displayed as defined by the Architectural Blueprint 10 for the specific application anywhere within the Main Panel 12. When a word is typed in to a dialog box 135, PictoLayers 49 may present a list of words beginning with the typed letters from the available content within the Modular System Library 15 to provide for words to be completed as required within the application by typing only a couple of letters and then having the label, instruction or command completed by the application software. The keyboard 132 within the display may further provide for a user to enter letters or numbers to make a call, perform a search, and choose commands to construct a Picto-Story, or perform other functional operations within any number of internal and/or external software application and/or websites.

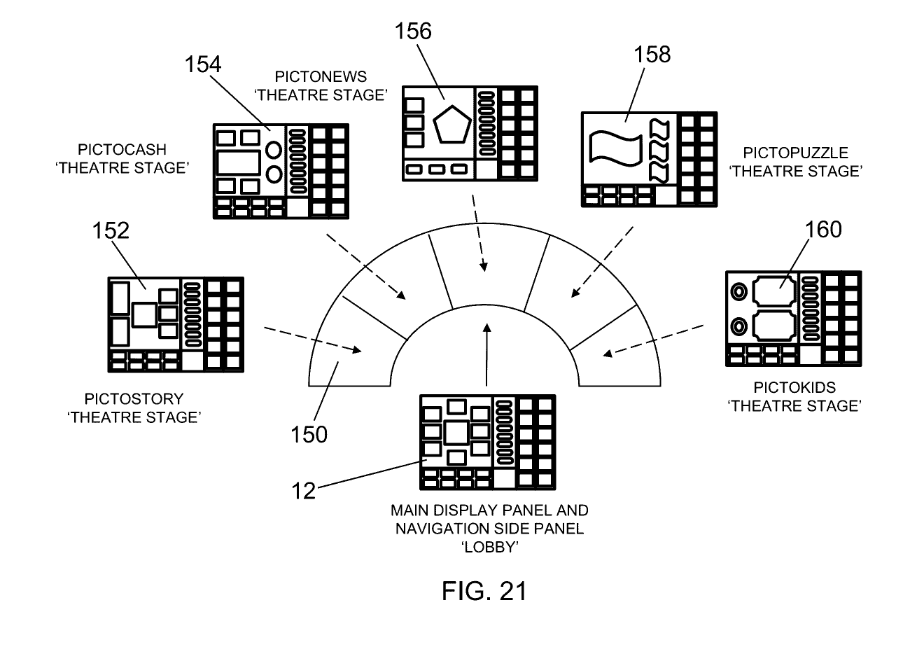

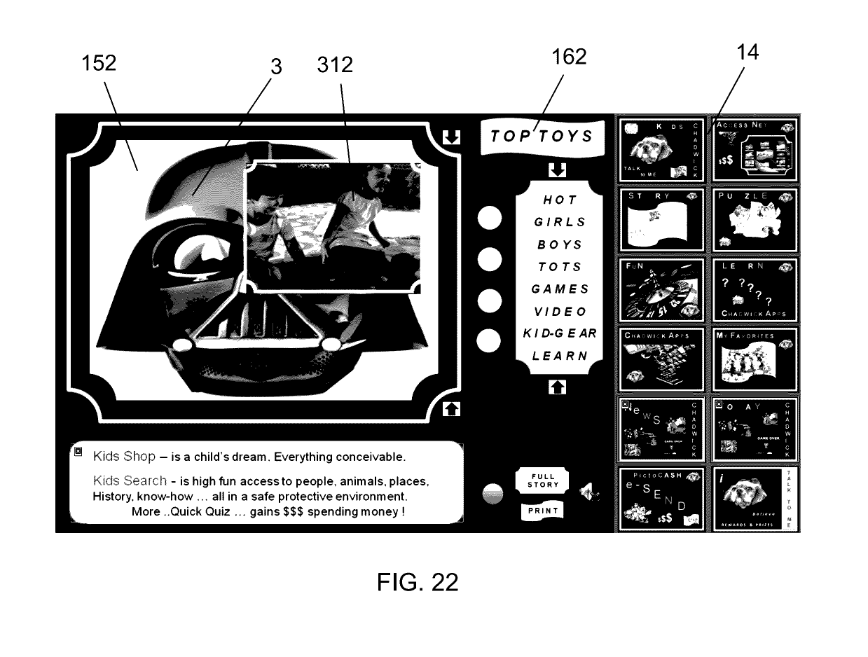

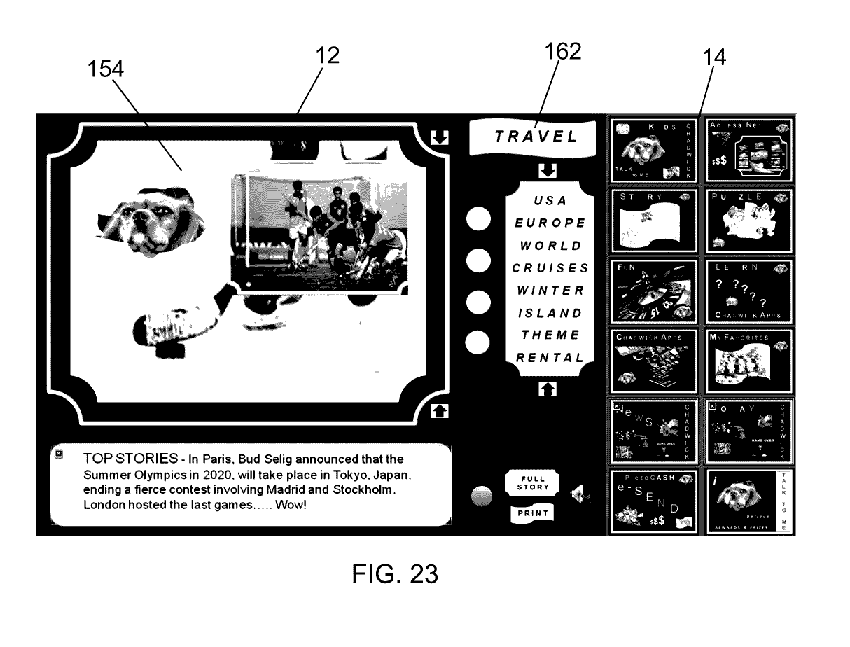

As shown in FIG. 21, the Main Display Panel 12 and the Navigation SidePanel 12 interact as the ‘lobby’ 150 within the building analogy and provide access to any one of a number of Applications as ‘Theatre Stages’, such as the MUST HAVE applications previously described and for PictoStory 152, PictoCash 154, PictoNews 156, PictoPuzzle 158, and PictoKids 160. As part of Picto News or Search MUST HAVE, access is available through the lobby to a Picto Need application which seamlessly integrates common requirements such as date, time, calendar, calculator, conversion tool, translator, weather or other core predetermined public needs. These applications, by definition have to be structured and formatted according to blueprint specifications to retain scalability etc. As such these integrated applications are not iterations of what is currently known in the art. Using one or more of these applications, the software integrates vibrant image content to display the PictoStory 152 in a Multi-Dimensional Picto-Kids Presentation as shown in FIG. 22 or as a news story as shown in FIG. 23 in a PictoNews 156, or in other formats such as a Picto-Film, PictoGame, PictoCard or other dynamic presentations. The PictoStory 152 may provide access to advertisements 162 or other information for a user to shop and learn. Any Composite Hyper Displays 237 may provide for Auto-Voice translation or identification of the image content, for example by selecting the girl 312 in the Trans-Snip 57, the software application has a voice say girl through the speakers on the digital device, or alternatively the voice says fille, chica, ragazza or Mädchen, or girl in any other language that is preferred by the user. The alphabet keyboard 132 may further provide for the activation of a connection to a cellular or wireless internet telephone network to place telephones calls using the Must Have Applications within the Access Navigation System. Importantly, any software applications may be picture oriented so even a small child that cannot read very well may use the application by selecting pictures or only a couple of letters and numbers and the software will provide options for the child to select commands completely through pictures. For example, for the child to send a PictoCard as a greeting card or PictoKids Presentation to Grandpa, a picture of Grandpa is selected and the system in a first embodiment automatically sends an email with a Descriptor 56 with a link to the PictoCard or PictoKids presentation. By selecting the descriptor link in the email, a Data Packet 68 is downloaded to the digital device receiving the email. The Data Packet 68 includes the Core and Dependent Applications and the Core and Application Modular System Libraries and by activating the Core and Dependent Application the PictoCard is displayed or the PictoKids Presentation is dynamically presented. The Applications may be activated by entering an alphanumeric code received in the email and setting up a PictoIdentification if the user does not already have a Picto-Account. An initial Picto-Identification may be setup through the selection of a unique picture, label, or Composite Hyper Display 59, as described as a “Fingerprint” supra and by then entering the user's cell phone number to confirm identification and establish a Picto-Account for the user. For financial transactions a user may purchase Picto-Cash through a Picto-Bank Application or another retail outlet and establish a unique Picto-Identification that through the use of the random generator and interchangeability of the content within and software application, a Picto-Identification is comparable and secure as a person's own fingerprint for identification and validation of a financial transaction.

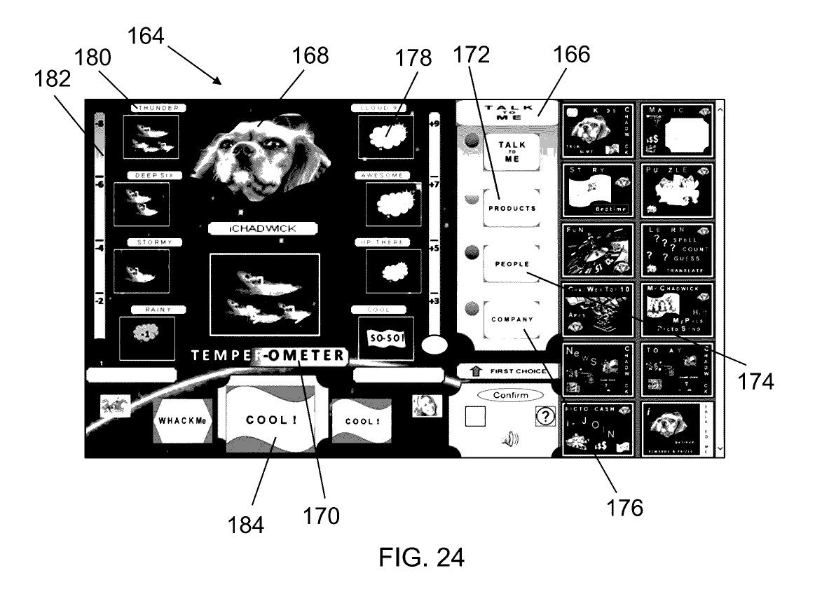

An embodiment of the PictoMeter Application 164 is shown in FIG. 24. A feature of the PictoMeter 164 is the Talk To Me 166 feature that provides for a user to speak with a character such as Chadwick the dog 168 who may respond with wisdom or humor to entertain and amuse the user. Another feature of the PictoMeter 164 is the TemperoMeter 170 that provides for the user to enter their mood, or enter their feelings about products, people, companies, movies, books, television shows and other things. The user can select a rating that may be selected from a picture 178 or select a word 180 that represents the user's current feeling. When selected, scales 182 may colorfully display the rating. By selecting on the Products option 172, the People option 174, or the Company option 176 the display may present a Composite Hyper Display 237 as a Composite Hyper Display 59 showing the product, the person, or the company and the user may select a control button 184 to enter their feelings about the product, person or company. The Temperometer immediately displays the user's likes or their negative attitudes about the item of interest. The user may further request information on the PictoMeter data collected from other users about the item of interest. The software application development system further provides for a statistical evaluation of user feedback on products, people, or companies and uses an 80%-20% rule or a similar statistical analysis that demonstrates popular appeal of the majority of users to change content, operation and function within the Access Navigation System if applications are not often used or well liked. The interchangeability of content, operation and function provides a unique and completely different approach to analytics of user data where negative a/or positive feedback can immediately result in a change within the Access Navigation System.

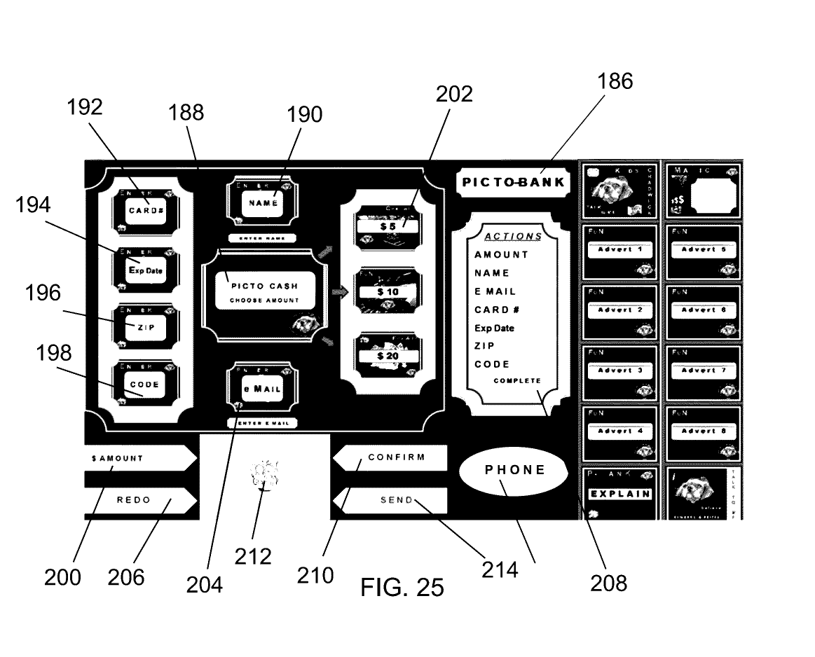

In a further embodiment of an application that may be developed using the software application development system as shown in FIG. 25, the PictoBank Application 186 provides for a user to securely enter their credit card and obtain virtual PictoCash 188 that corresponds to actual money to be used to purchase PictoGames, products and other items that may be displayed within advertisements in the Main Panel 12 and Side Panel 14 display. The PictoBank Application 186 provides for a variable exchange rate to be offered that may provide a higher number of PictoCoins to a user than the amount of money they invest. The exchange rate may be based on advertising promotions, winning scores in PictoGames, amount of purchase made by the user as examples. The user may enter their name by selecting a name option 190 and may select a credit card option 192 to enter a credit card number. The user then selects an expiration date option 194, select a zip code option 196 to enter a zip code, and select a code option 198 to enter a card verification value. The user may then select an amount option 200. Amounts may be entered selecting one of the PictoCoin options 202. The user may also enter an email address by selecting the enter email option 204. The information entered may be cleared by selecting a redo option 206. An action panel 208 may present the steps required to complete a transaction. Once the credit card and other required information is entered, a confirm option 210 may be selected which verifies the entered information. The user must then correctly validate a PictoIdentity 212 that is specific to the user as described in the U.S. patent application Ser. No. 13/830,210. Once the PictoIdentity 212 is correctly verified, the credit card is then charged the selected amount. The user selects the send option 214 that creates and sends a transaction code to the user's email address. Once the email is sent, the user accesses their email account to get the transaction code and then enters their Picto-Account and/or the PictoCash Application. The user verifies their identification by validating a PictoIdentity again and then enters the transaction code in the software which transfers the amount charged to the credit card into the user's PictoCash Account to give the user funds to purchase PictoGames, products and other items that may be displayed within advertisements. Importantly, the PictoIdentity and PictoCash accounts do not receive any of the identifying information that is entered into the PictoBank Application 186. Purchases are secure because no identifying information such as the user's name, credit card number or address is needed to complete a purchase, just a verification of the PictoIdentity that is a unique secure code known only to the user. The PictoCash Account further provides for monetization triggering which lets a user immediately spend their PictoCash from their account to purchase a product from an advertisement, or PictoGame when for example an advertisement is selected, or the user runs out of time in playing the PictoGame.

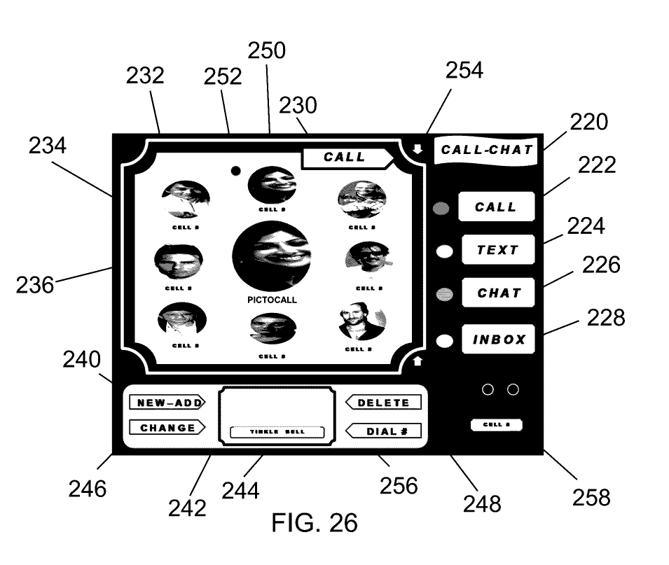

Another Must Have Application is the PictoCall Application 220 as shown in an embodiment in FIG. 26. The PictoCall Application may be used to call, text or chat with a person using server capabilities to connect to a cellular telephone, or connect through a VoIP such as Skype using an internet connection to contact the intended recipient using their digital device, by means of a descriptor linked hybrid code. Alternatively, for a user within their Picto-Account calls and messages may be received through the transmission and translation of Descriptors 56 by an external server. In an embodiment, the user may select a call option 222, or text by selecting a text option 224, or have a real-time chat with another person by selecting the chat option 226. Call information, previously sent texts and chats may be reviewed by selecting the inbox option 228. Contact information for person's known to the user may be automatically transferred from a mobile device, or as described above, from a document with names and telephone numbers and group of pictures of the persons. When the call option 222 is selected the call display 230 presents contact information for persons known to the user in a pictorial montage page, with a picture 232 and cell phone number 234 for each contact within the Main Panel PictoCall display 236. Additional persons may be added by selecting a new-add button 240 and entering the person's name, telephone number and other information in a dialog box 242 or alternatively by selecting the name from a display of names 244 that appear as the user begins typing. The contact information can be changed by selecting the change button 246 or a person's contact information may be deleted by selecting the delete button 248.

When placing a call, a user's cellular telephone number is entered with optionally a verification of the user through the validation of a PictoIdentity. The PictoIdentity and user's cell phone number is entered into a cell # option 258 to open the user's PictoCall Account or Picto-Account to place the call, send a text and/or chat. The user may then pick on the person's picture 250 and that person's picture may be displayed in the Main Panel 12 center display 252. The person may be alternatively selected by selecting their name in the names display 244. Control arrows 254 may be selected to completely change all of the persons within the PictoCall display 236 or to perform other functions. The display of persons within the PictoCall display 236 may be presented alphabetically within the montage page showing eight pictures at a time, or preferably most often called persons may be displayed, providing for even a small child to see the picture of who they want to call and make a selection.

Once the person is selected the dial # button 256 may be selected to immediately place a call. In placing the call, the call may be completed through a cellular telephone, or an internet connection through a VoIP such as Skype but if the receiver of the call has a PictoCall Account the user may receive the call directly in the Core and/or a Dependent Application within the Access Navigation System. The call is transmitted using Descriptors 56 that are translated by a remote server and that activate the auto-voice features of the software application development system of the present invention. In making the call to a PictoCall Account user, the user is prompted to select a message which may be presented verbally or as text within the display. The user selects a message that is transmitted using a Descriptor 56 as an alphanumeric code that corresponds to messages within the receiver's mirrored resident server that has the same content of messages within the Modular System Library 15. The receiver accepts the call and hears a voice verbally say the message from the sender. The voice is not the sender's voice but a translation of the message and a play back for the receiver in an acceptable voice. The receiver of the message may then respond in real-time with a response by selecting from the available messages. As noted below the messages are stored within hierarchical topic categories of related content, so a receiver may easily find an acceptable response and quickly reply to the sender.

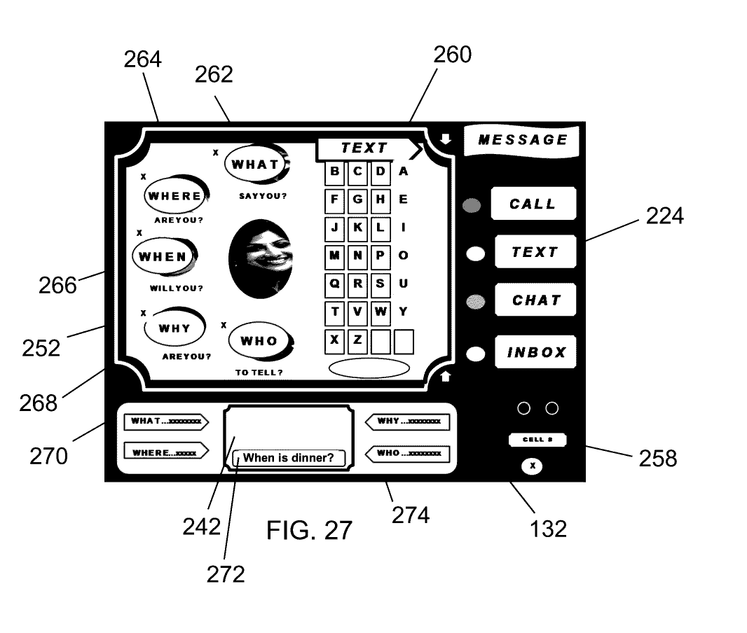

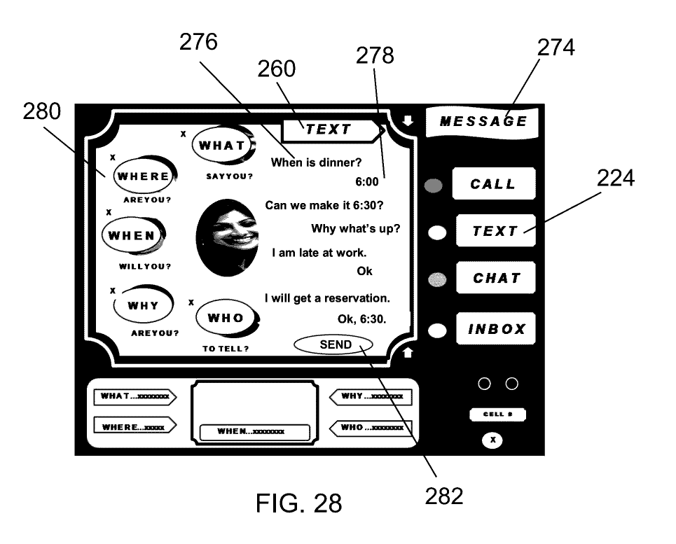

As shown in FIG. 27, in order to send a text, the text option 224 is selected and a person to send the text to is selected with a picture of the person shown in the PictoCall center display 252. The PictoCall text feature provides some unique options for a user to quickly prepare and send a text to another digital device. The text may be typed into the dialog box 242 using the keyboard 132, or alternatively and preferably, the clear crisp display even on a small screen format digital device provides for a user to select from optional phrases that are stored in categories that may be selected through option buttons. A what option 262 may have phrases related to content, “What's for dinner?” for example; a where option 264 may have phrases related to a location, “Where are we meeting?”, a when option 266 may have phrases related to time, “When is the show?”, a why option may have phrases related to consternation, “Why did he do that?”, and the who option may have phrases with people's names, “Is Tommy going with us to the show?” By selecting on an option, such as the when option 266, the dialog box 242 may display optional phrases related to time for the user to choose from such as the “When is dinner?” phrase 272. The text is transmitted by selecting the send button 274 where only an alphanumeric Descriptor 56 is sent to deliver the text, not the actual text message. For example, the message “What's for dinner?” may be sent simply as M114 as a text Descriptor. The receiving digital device using the Architectural Blueprint 10 uses the Descriptor 56 to look up the message and present the message within the Main Panel 12 in the Core Application or in another Dependent Application. The PictoCall text feature displays the text messages within a message option 274 as shown in FIG. 28 that displays the text messages sent 276 and the text messages received 278 within the PictoCall message display 280. The text messages may be completed through and displayed within a text messaging application on a cellular telephone, and/or as noted above a user receiving the text message that has a PictoCall Account will receive them within the Access Navigation System and PictoCall Application without exiting the Core Application.

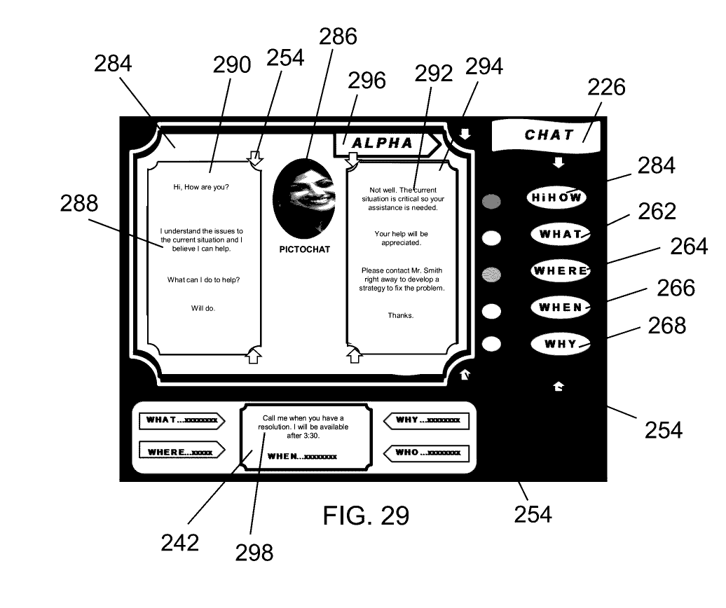

The PictoCall Application 220 may also provide a chat option 226 that similarly may provide for real-time communication with another digital device such as a computer system using a network or an internet connection or web site that is displayable within the Main Panel 12 display without exiting the Core Application or preferably through the sender and receiver's PictoCall Account. The PictoChat display 284 as shown in FIG. 29 may display a picture of the person in the PictoChat central display 286. The received message 288 is in the receiver dialog box 290. The sent messages 292 are displayed in a sender dialog box 294. Control arrows 254 may replace the messages in the dialog boxes with messages that have been previously sent or with messages that were sent later for a user to review the conversation. An alpha button 296 displays the keyboard 132. In addition to the option buttons, a hi how option 284 may provide introduction and common conversational phrases, “How are you?” for example. The user may enter messages through the keyboard or select responses 298 as shown in the dialog box 242 from the option categories, with every chat message transformed into a Descriptor 56 to be transmitted in a short code format that may only be a couple of letters or numbers to minimize bandwidth and storage requirements on the receiving digital device.

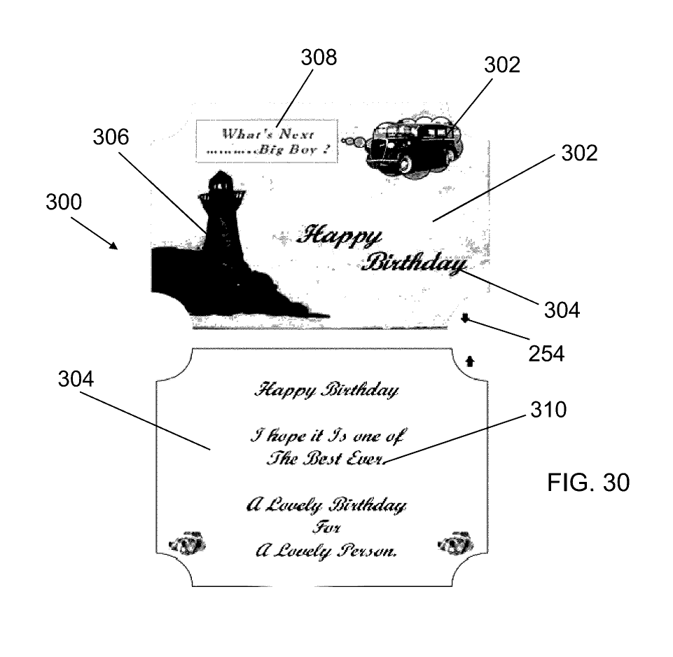

Another Must Have Application is the PictoCard Application 300 that provides for a user to create and send highly graphically stylized images and messages with animation, sound and visual effects. A PictoCard may be sent to an email server as a Descriptor 56 with a compressed format image such as a jpg, gif, bmp, or html that is displayed in the recipient's email. The image in this file format versions is not fully functional, but could be displayed as a Composite Hyper Display 59 where as shown in FIG. 30 one image 302 and/or text 304 is overlaid on another image 306. With the Descriptor 56 a transaction code is provided either within the email or as a file attachment. By opening the Picto-Account of the person receiving the email, the PictoCard is fully activated and displayed. If the user does not have a Picto-Account then the transaction code from the email can be entered, a Data Packet 68 is downloaded to the person digital device and the person may setup a Picto-Account and establish a PictoIdentity for access to the Picto-Account. The PictoCard Application 300 can then be entered and be functional to display the dynamic, fully functional features. If a user is in the Core Application, the PictoCard when received may be activated and displayed within the Main Panel 12. The PictoCard 300, uniquely for an electronic card has two pages, so that a first page is overlaid on the second page and may be opened using a control arrow 254 or may open automatically through the activation of Enhancements 67 associated with the Trans-Snips 57 that make up the Composite Hyper Displays 237 of the PictoCard 300. For example, when activated the car image 302 may drive across the front of the car and open the second page while playing music, or saying a phrase shown in a dialog bubble 308. The text 310 on the second page 304 may be activated to produce a symphonic choir singing the text 310 or any other creative display may be activated and shown to entice and entertain the receiver with endless possibilities of images, sound, action, effects, and other features because of using Trans-Snips 57 and Enhancements 67 within the Application Technology. The images on the PictoCard Application 300 may in a printing mode align and orient the text and images on the card so that the card may be printed on a single piece of paper but be printed as two pages to be folded just like a normal greeting card.

The software application development system and executable applications of the present invention use adaptable and adapting code through the use of Descriptors 56 and Composite Hyper Displays 237. The Core Application provides a changeable User Interface (UI) with rapid universal User Access (UA) that enhances the User Experience (UX) through superior presentation of User Content (UC). Must Have Applications and other Applications provide scalable compatibility and functional adaptability across any screen size format or operating of a digital device such as any computer system, cellular phone, iPhone, smartphone, iPad, tablet computer, digital display device, or other digital devices. A number of mobile applications, video games, web site development, and other applications may be developed using the unique file structural and Descriptors defined by one or more Architectural Blueprints. In some embodiments, some development features may be available only on a Remote Server through a network or internet connection. In further embodiments, comprehensive features are provided to develop many different types of software application and integrate those applications within an Access Navigation System having a Core Application and one or more Dependent Applications using the Picto-Blueprint Development Software Application downloaded using Data Packets to a digital device.

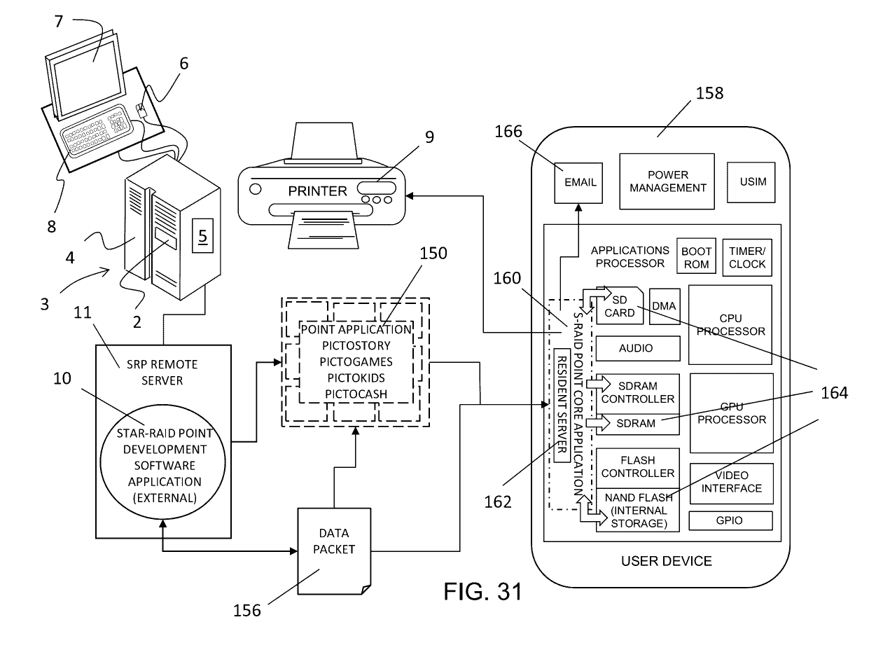

In an embodiment, the software application development system of the present invention is available through a network or internet connection on an external Remote Server 11 as shown in FIG. 31. The Remote Server 11 may be implemented in computer hardware, computerized equipment and/or other digital devices. For example, the method can be performed using a system including one or more digital communications devices and/or one or more personal computers and data servers. Although the computer system 3 is shown for the purpose of illustrating a preferred embodiment, the present invention is not limited to the computer system 3 shown, but may be in the form of and be used with any electronic data processing system or any digital device such as found in personal or other digital communications devices, cellular phones and other mobile devices, home computers, tablet computers, digital display devices, or any other system for the processing of digital data. The computer system 3 includes a server computer 4 that may be in the form of any electronic data processing system such as found in computer systems or other digital communications devices, cellular phones and other mobile devices, home computers, tablet computers, digital display devices, or any other system for the processing of digital data. The server computer 4 having a microprocessor-based unit 5 (also referred to herein as a processor) for receiving and processing software programs and for performing other processing functions. An output device 7 such as a visual display is electrically connected to the processor unit 5 for displaying user-related information associated with the software, e.g., by means of a graphical user interface. A keyboard 8 may also be connected to the processor unit 5 for permitting a user to input information to a software program. As an alternative to using the keyboard 8 for input, a mouse 6 may be used for moving a selector on the display 7 and graphical user interface, or alternatively a touch screen input device may be provided for selecting an item and providing input to the processor 5. It is to be appreciated that the input is not limited to the known input apparatus and methods but includes input methods and devices which may yet be developed.

Memory and data storage, in any form, can be included and is illustrated as a hard-disk device such as computer readable storage medium 2, which can include software programs, and is connected to the microprocessor based unit 5 for providing a means of inputting the software programs and other information to the microprocessor based unit 5. Multiple types of memory can also be provided and data can be written to any suitable type of memory. Memory can be external and accessible using a wired or wireless connection, either directly or via a local or large area network, such as the internet. Still further, the processor unit 5 may be programmed, as is well known in the art, for storing the software program internally. A printer 9 or other output device can also be connected to the processor unit 5 for printing a hardcopy of the display from the computer system. The processor unit 5 can have a network connection, such as a telephone line, network cable or wireless link, to an external Network, such as a local area network or the internet.

The output device 7 provides visually to the user transactional, interactive or variable data that has been subject to transformations. The output device 7 can be a monitor or other visual computer screen or graphical user interface (GUI), a printer 9 or other output device that provides a visual or other representation of a final output from the processor unit 5. The output device 7 can also be an output device that provides the transactional data as a digital file. The processor unit 5 provides means for processing the transactional, interactive or variable data to produce readily discernible, informational and organized images and data on the intended output device or media. The present invention can be used with a variety of output devices that can include, but are not limited to, a digital photographic printer 9 and soft copy display. Those skilled in the art will recognize that the present invention is not limited to just these mentioned data processing functions.

The server computer 4 may be in the form of any electronic data processing system such as a computer system found in personal or other digital communications devices, cellular phones and other mobile devices, home computers, tablet computers, digital display devices, or any other system for the processing of digital data may be in the form of a computer system that can store a computer program or software application product having a program stored in the computer readable storage medium 2, which may include, for example: magnetic storage media such as a magnetic disk or magnetic tape; optical storage media such as an optical disc, optical tape, or machine readable bar code; solid state electronic storage devices such as random access memory (RAM), read only memory (ROM) or flash memory data storage devices. The associated computer program and data server may be implemented through the software application development system on a SaaS (Software as a Service) or on demand computing service such as a cloud or shared resource database through a web browser. A secure login with password may be provided to remotely access the software application development system through an intranet or internet connection. One or more of the devices to access the software application development system may be connected wirelessly, such as by a cellular link, either directly or via a network. It is to be appreciated that such digital devices can be mobile devices (e.g., PDA, iPod, iPad, tablet computer, digital display device, or smartphone that can be used as a processing unit, a display unit, or a unit to give processing instructions), and as a service offered via the World Wide Web.

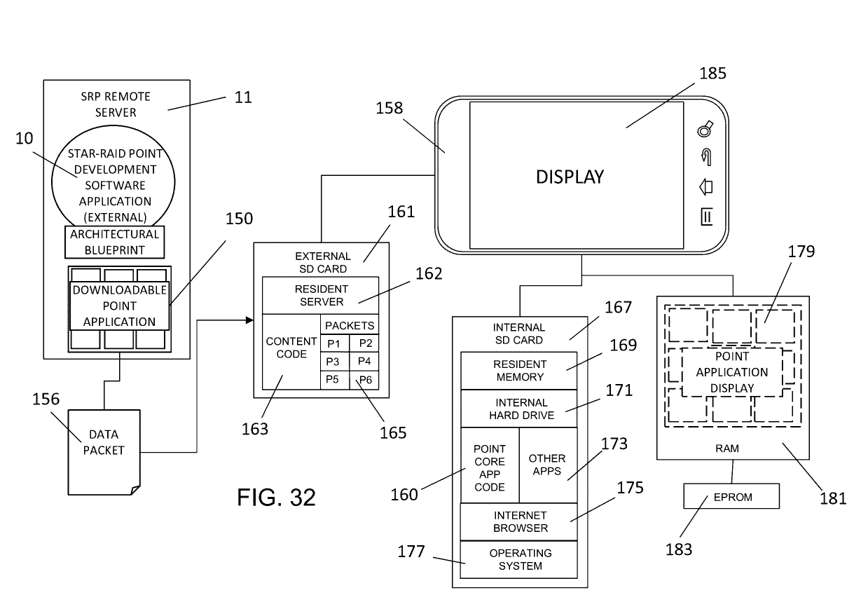

One or more software applications 150 developed using the software application development system of the present invention may be downloaded in a Data Packet 156 to a digital device. As shown in FIG. 31, in installing a STAR-RAID-POINT Application to a smartphone or other digital device 158, a Core Application 160 may be downloaded and may configure the Dependent Applications 150 and the Resident Server 162 for the variable content stored within the Modular System Libraries 15. The Dependent Applications 150 with the Resident Server 162 is structured with the layout, formatting and encrypted file structure within a Modular System Library 15 as defined by the Architectural Blueprint 10 for the particular Dependent Application 150 that is being downloaded. Multiple Must Have software applications and other applications 150 may be installed to the Resident Server 162 with a single Core Application 160 through a single data packet 156 installed on the digital device 158. The Core Application 160 further distributes storage and utilization through available types of system memory and processors 164 to reduce consumption of system resources. As shown in FIG. 32, the Resident Server 162 may be configured in the External SD Card 161 with the Dependent Applications Modular System Libraries 163 and downloaded Application Data Packets 165. The Core Application 160 is installed on the internal hard drive 171 and Resident Memory 169 of the Internal SD Card 167. The Core Application 160 and other applications 173 may access native code of the digital device 158 through the digital device Operating System 177 and Internet Browser 175. The downloaded Applications 150 may be activated from the Application Data Packets 165 in RAM 181 and programmable ROM 183 to display 185 on the digital device 158. This combined with the comparatively minimal resources needed to run the Core Application 160 and transfer data locally from the Dependent Application Modular System Libraries 163 within the Resident Server 162 to be displayed on the navigable Access Navigation System of the Core Application 160 makes each of the software applications 150 developed using the software application development system and Architectural Blueprint platform well suited as a mobile application that will not leave a user staring at the screen waiting for more information to download and display. The software application development system provides a completely different approach to software development resolving issues of display across all sizes and forms of digital devices, and removing the delay in downloading and accessing content thereby improving User Access (UA), User Interface (UI), User Experience (UX), and User Content (UC).

The invention has been described in detail with particular reference to certain preferred embodiments thereof, but it will be understood that variations and modifications can be effected within the spirit and scope of the invention. The claims should not be read as limited to the described order or elements unless stated to that effect. Therefore, all embodiments that come within the scope and spirit of the following claims and equivalents thereto are claimed as the invention.

While the foregoing description, illustrations and specifications represent the preferred embodiments of the present invention, it will be understood that various additions, modifications and alterations, combinations and/or substitutions may be made to the invention by one skilled in the art without departing from the spirit and scope of the invention. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, algorithms, materials, and components and otherwise, used in the practice of the invention, which are particularly adapted to specific environments and operative requirements without departing from the principles of the present invention. In addition, features described herein may be used singularly or in combination with other features. The presently disclosed embodiments are therefore to be considered in all respects as illustrative and not restrictive.

It should be noted that references herein to phrases such as “one embodiment” or “an embodiment” means that a particular feature, structure or characteristic described in connection with the embodiment is included in at least one embodiment of the invention. The phrases such as “in one embodiment” or “in certain embodiments” in various places in the specification are not necessarily, but can be, referring to the same embodiment. Use of the term “preferred” or “preferably” is intended to indicate a configuration, set-up, feature, process, or alternative that may be perceived by the inventor(s) hereof, as of the filing date, to constitute the best, or at least a better, alternative to other such configurations, set-ups, features, processes, or alternatives. In no way shall the use of the term “preferred” or “preferably” be deemed to limit the scope of the claims hereof to any particular configuration, set-up, feature, process, or alternative.

While there have been shown and described fundamental novel features of the invention as applied to the exemplary embodiments thereof, it will be understood that omissions and substitutions and changes in the form and details of the disclosed invention may be made by those skilled in the art without departing from the broad inventive concept thereof. It is understood, therefore, that this invention is not limited to the particular embodiments disclosed, but it is intended to cover modifications within the spirit and scope of the present invention as defined by the appended claims. Moreover, the scope of the present invention covers conventionally known, future developed variations and modifications to the components described herein as would be understood by those skilled in the art. It is the intention, therefore, to be limited only as indicated by the scope of the claims appended hereto. It is also to be understood that the following claims are intended to cover all of the generic and specific features of the invention herein disclosed and all statements of the scope of the invention that, is a matter of language, might be said to fall therebetween.

The various embodiments may also be implemented in an operating environment comprising computer-executable instructions (for example, computer program product) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages. It will also be appreciated by one of ordinary skill in the art that based upon the description of the functionality of program scripts and objects herein, the program scripts and objects may be written in any programming language heretofore or hereafter known, such as PERL, Visual Basic, AS3, JavaScript, Flex, ActionScript, HTML, C++, and the like.

1. A software application development system comprising:
a microprocessor;
a storage device;
a display; and,
a memory in communication with the microprocessor, the memory including a generator component comprising program code executable on the microprocessor to:
generate at least one master architectural blueprint which utilizes
descriptors to identify and generate the software architectural components, code and content required to create one or more separate software applications, wherein each separate application is comprised of code and content that is universally compatible and maintains a consistent scaled display, consistent functionality and consistent operability across net-capable or web-capable devices having a web browser installed and having a minimum display screen size which accommodates the legible display and navigation of net or web pages, regardless of the device hardware or operating system, which operability includes legibility and, for applicable devices, distinct touchability, irrespective of the physical size, aspect ratio or pixel resolution of said net-capable or web-capable devices having at least said minimum display screen size; and
wherein the blueprints generates the code for the applications and wherein the generated applications populate the display with the code and content.

2. The system of claim 1 wherein the descriptors relate to one or more of the structure, design layout, hyper display location or navigation aspects of the content.

3. The system of claim 1 wherein the display further includes a user interface that comprises:
a main panel having quadrants;
at least one side panel having navigation controls;
wherein the main panel, and at least one side panel are scaled to display the user interface in a full screen landscape orientation on the net-capable or web-capable devices, irrespective of the physical size, aspect ratio or pixel resolution of said net-capable or web-capable devices having at least said minimum display screen size.

4. The system of claim 1 wherein an application generated by the master blueprint provides seamless access via navigation controls to one or more of the plurality of software applications and to external applications or web pages, without exiting a defined core application environment.

5. The system of claim 3 wherein display of an application is enabled using the main panel and navigation and switching between the application and one or more dependent applications is enabled using the side panel.

6. The system of claim 1 wherein the display further comprises:
one or more display panels made up of composite hyper displays wherein the composite hyper displays comprise trans-snips that can be used to execute instructions within the plurality of software applications and the composite hyper displays and trans-snips comprise aspect ratio characteristics that permit scaling and or zooming to fill any of the quadrants and/or the main panel.

7. The system of claim 1 wherein the generator component further comprises production tools to create, render, and preview components, elements, and descriptors to transform raw and semi-processed code or content as defined by the at least one master blueprint.

8. The system of claim 1 wherein the display further comprises:
one or more display panels wherein the code and content populating said one or more display panels comprises composite hyper displays wherein the composite hyper displays comprise trans-snips that can be used to execute instructions within the plurality of software applications.

9. The system of claim 8 wherein descriptors are associated with each trans-snip and wherein each trans-snip and its associated descriptors comprises a composite hyper display wherein an image or composite image substitutes for conventionally written alphanumeric code that would have otherwise been required in order to generate the applications that populate the display.

10. The system of claim 8 wherein a composite hyper display can be varied by altering the characteristics of one or more trans-snip descriptors.

11. The system of claim 10 wherein the varying produces a unique code that can be used for identification of a user or validation of a financial transaction.

12. The system of claim 1 wherein the display further comprises:
one or more display panels that display multiple components and elements that are each distinctly selectable irrespective of the scale of the display.

13. The system of claim 1 wherein the display further comprises:
one or more display panels that display multiple components and elements which maintain consistent display, consistent functionality and consistent operability and are distinguishable and distinct from each other irrespective of the scale of the display.

14. The system of claim 1 wherein the descriptors are used to compress content or code and limit the size of the content or code to be transmitted.

15. The system of claim 1 wherein the display of the code and content identified by descriptors can be timed and sequenced.

16. The system of claim 1 wherein the descriptors act as a substitute for programming code.

17. The system of claim 1 wherein the descriptors define code and content such that the code and content can be displayed without the necessity to modify the programming code.

18. The system of claim 1 further comprising:
a second storage device wherein a replica copy of the code and content is stored on said second storage device.

19. The system of claim 1 wherein the generator component uses at least one modular hierarchical multi-dimensional matrix for structuring, developing and rendering the plurality of software applications wherein said matrix includes at least one descriptor to define or reference components, elements, or combinations of the software application development system and the plurality of software applications.

20. A computer implemented method of developing software applications comprising the steps of:
generating at least one master architectural blueprint on a microprocessor;
transforming data to generate a plurality of application architectural blueprints on the processor wherein the application architectural blueprints are associated with the at least one master blueprint and utilize descriptors to identify and generate the software architectural components, code and content required to create one or more software applications, each of which applications is universally compatible, maintaining a consistent scaled display, consistent functionality and consistent operability across net-capable or web-capable devices having a web browser installed and having a minimum display screen size which accommodates the legible display and navigation of net or web pages, regardless of the device hardware or operating system, which operability includes legibility and, for applicable devices, distinct touchability, irrespective of the physical size, aspect ratio or pixel resolution of said net-capable or web-capable devices having at least said minimum display screen size; and
generating from the application architectural blueprints the code for the applications, the generated applications populating with the code and content a display that is in communication with the processor.

21. The method of claim 20 wherein the descriptors relate to one or more of the structure, design layout, hyper display location or navigation aspects of the content.

22. The method of claim 20 further comprising the step of:
display a main panel having quadrants;
displaying at least one side panel having navigation controls;
wherein the main panel, and at least one side panel are scaled to display a user interface in a full screen landscape orientation on the net-capable or web-capable devices having at least said minimum display screen size, irrespective of the physical size, aspect ratio or pixel resolution of said net-capable or web-capable devices.

23. The method of claim 22 further comprising the step of:
providing access via the navigation controls to one or more software applications and to external applications or web pages, without exiting a defined core application environment.

24. The method of claim 23 further comprising the step of:
enabling switching among the software applications, where more than one software application has been generated, to be viewed in the main panel by utilizing the navigation controls of the side panel.

25. The method of claim 21 further comprising the step of:
utilizing production tools to create, render, and preview components, elements, and descriptors to transform raw and semi-processed code or content as defined by the at least one master blueprint.

26. The method of claim 21 further comprising the step of:
generating one or more display panels made up of composite hyper displays wherein the composite hyper displays comprise trans-snips that can be used to execute instructions within the plurality of software applications.

27. The method of claim 21 further comprising the step of:
generating at least one modular hierarchical multi-dimensional matrix for structuring, developing and rendering the software applications wherein said matrix includes at least one descriptor to define or reference components, elements, or combinations of a software application development system and the plurality of software applications.

28. A computer program product comprising:
computer code that generates at least one master architectural blueprint;
computer code that transforms data related to code and content by generating a plurality of application architectural blueprints wherein the application architectural blueprints are associated with the at least one master blueprint and utilize descriptors for the code and content required to create one or more separate software applications, wherein each separate application is comprised of code and content that is universally compatible, maintaining a consistent scaled display, consistent functionality and consistent operability across net-capable or web-capable devices having a web browser installed and having a minimum display screen size which accommodates the legible display and navigation of net or web pages, regardless of the device hardware or operating system, which operability includes legibility and, for applicable devices, distinct touchability, irrespective of the physical size, aspect ratio or pixel resolution of said net-capable or web-capable devices having at least said minimum display screen size;
computer code that generates instructions to populate a display with the code and content; and
a non-transitory computer readable storage medium that stores the computer codes.

29. The computer program product of claim 28 wherein the descriptors relate to one or more of the structure, design layout, hyper display location or navigation aspects of the content.

30. The computer program product of claim 28 further comprising:
computer code that generates a user interface wherein the user interface comprises a main panel having quadrants and at least one side panel having navigation controls;
computer code that transforms the main panel, and at least one side panel so that they are scaled to display the user interface in a full screen landscape orientation on the net-capable or web-capable devices having a minimum display screen size which accommodates the legible display and navigation of net or web pages, irrespective of the physical size, aspect ratio or pixel resolution of said net-capable or web-capable devices having at least said minimum display screen size.

31. The computer program product of claim 30 wherein the master blueprint provides seamless access via the navigation controls to one or more of the software applications and to external applications or web pages, without exiting a defined core application environment.

32. The computer program product of claim 30 wherein display of an application is enabled using the main panel and navigation and switching between the application and one or more dependent applications is enabled using the side panel.

33. The computer program product of claim 28 further comprising:
computer code that creates, renders, and previews components, elements, and descriptors to transform raw and semi-processed code or content as defined by the at least one master blueprint.

34. The computer program product of claim 28 further comprising:
computer code that generates one or more display panels made up of composite hyper displays wherein the composite hyper displays comprise trans-snips that can be used to execute instructions within the plurality of software applications.

35. The computer program product of claim 28 wherein the display panels are generated utilizing a batch processing in an automated manner.

36. The computer program product of claim 28 further comprising:
computer code that uses the plurality of architectural blueprints and at least one modular hierarchical multi-dimensional matrix for structuring, developing and rendering the plurality of software applications wherein said matrix includes at least one descriptor to define or reference components, elements, or combinations of a software application development system and the plurality of software applications.

37. A computer program product comprising:
computer code that transforms code and content into one or more trans-snips based on the characteristics of at least one master architectural blueprint;
computer code that transforms the one or more trans-snips into one or more components of a composite hyper display;
computer code that generates instructions to populate a display with the composite hyper display on a navigation panel or display panel;
wherein the computer product enables the code and content to be consistently displayed with consistent functionality and consistent operability across net-capable or web-capable devices having a web browser installed and having a minimum display screen size which accommodates the legible display and navigation of net or web pages, regardless of the device hardware or operating system irrespective of the physical size, aspect ratio or pixel resolution of said net-capable or web-capable devices having at least said minimum display screen size; and
a non-transitory computer readable storage medium that stores the computer codes.

38. The computer program product of claim 37 wherein the composite hyper display is multi-layered by overlaying at least one of the one or more trans-snips on top of certain other trans-snips from the one or more trans-snips.

39. The computer program product of claim 37 wherein at least of the one or more trans-snips comprises one or more of the following elements, an unpopulated transparent image, an image with a defined size and shape, that is positioned inside an unpopulated transparency with a defined location.

40. The computer program product of claim 38 wherein the image having a defined size and shape comprises characteristics related to location, sequence, priority, timing gap, associated enhancements, and associated code within code implemented with activation of the one trans-snip.

41. The system of claim 1, wherein a universally adopted display language is used to display said plurality of applications on any device capable of displaying said display language.
